(19) United States
(12) Patent Application Publication
(10) Pub. No.: US 2017/0139131 A1
(43) Pub. Date: May 18, 2017

(54) COHERENT FIBER ARRAY WITH DENSE FIBER OPTIC BUNDLES FOR LIGHT-FIELD AND HIGH RESOLUTION IMAGE ACQUISITION

(71) Applicant: Lytro, Inc., Mountain View, CA (US)

(72) Inventors: Jon Karafin, Morgan Hill, CA (US); Colvin Pitts, Snohomish, WA (US); Yuriy Romanenko, San Jose, CA (US)

(21) Appl. No.: 15/422,372

(22) Filed: Feb. 1, 2017

Related U.S. Application Data
(63) Continuation of application No. 15/098,674, filed on Apr. 14, 2016.
(60) Provisional application No. 62/148,055, filed on Apr. 15, 2015.
(60) Provisional application No. 62/200,804, filed on Aug. 4, 2015.
(60) Provisional application No. 62/305,917, filed on Mar. 9, 2016.

(51) Int. Cl. G02B 6/08; H04N 7/22; H04N 5/232; H04N 5/225; G02B 3/00; G02B 6/32

(52) U.S. Cl. CPC G02B 6/08; G02B 3/0056; G02B 6/32; H04N 5/23232; H04N 5/2254; H04N 5/2258; H04N 7/22

(57) ABSTRACT

A camera may have two or more image sensors, including a first image sensor and a second image sensor. The camera may have a main lens that directs incoming light along an optical path, and microlens array positioned within the optical path. The camera may also have two or more fiber optic bundles, including first and second fiber optic bundles with first and second leading ends, respectively. A first trailing end of the first fiber optic bundle may be positioned proximate the first image sensor, and a second trailing end of the second fiber optic bundle may be positioned proximate the second image sensor, displaced from the first trailing end by a gap. The leading ends may be positioned adjacent to each other within the optical path such that image data captured by the image sensors can be combined to define a single light-field image substantially unaffected by the gap.

### CROSS-REFERENCE TO RELATED APPLICATIONS

The present application is a continuation of U.S. Utility application Ser. No. 15/098,674 for “Light Guided Image Plane Tiled Arrays with Dense Fiber Optic Bundles for Light-Field and High Resolution Image Acquisition” (Atty. Docket No. LYT198), filed Apr. 14, 2016, the disclosure of which is incorporated herein by reference in its entirety.

U.S. Utility application Ser. No. 15/098,674 claims the benefit of U.S. Provisional Application Ser. No. 62/148,055 for “Light Guided Image Plane Tiled Arrays with Dense Fiber Optic Bundles for Light-Field and High Resolution Image Acquisition” (Atty. Docket No. LYT198-PROV), filed Apr. 15, 2015, the disclosure of which is incorporated herein by reference in its entirety.

U.S. Utility application Ser. No. 15/098,674 also claims the benefit of U.S. Provisional Application Ser. No. 62/200,804 for “Light Guided Image Plane Tiled Arrays with Dense Fiber Optic Bundles for Light-Field Display” (Atty. Docket No. LYT229-PROV), filed Aug. 4, 2015, the disclosure of which is incorporated herein by reference in its entirety.

U.S. Utility application Ser. No. 15/098,674 also claims the benefit of U.S. Provisional Application Ser. No. 62/305,917 for “Video Capture, Processing, Calibration, Computational Fiber Artifact Removal, and Light Field Pipeline” (Atty. Docket No. LYT233-PROV), filed Mar. 9, 2016, the disclosure of which is incorporated herein by reference in its entirety.

### TECHNICAL FIELD

The present document relates to improved light-field computational imaging as well as extremely high resolution 2D video using image plane tiled arrays with dense fiber optic technology.

### BACKGROUND

CMOS, CCD and other image acquisition technologies are traditionally manufactured based upon 2D, industrial and/or other traditionally (potentially) mass-produced consumer requirements. This results in the need for custom silicon, sensors, electronics, and the like for niche markets, including light-field and ultra-high-resolution image acquisition.

The digital imaging industry continues to push the boundaries of bleeding edge acquisition technologies, with particular focus on higher resolutions, higher dynamic range, and a wider gamut of still and video capture formats. Accordingly, it is becoming increasingly challenging to achieve the imaging requirements for sensor pixel density, sensitivity, pixel counts, electronics, pixel pitch, data throughput, bandwidth, and the like. Some of these requirements, when used with traditional optical pathways, would require extremely complex custom silicon advances and other electronic developments that are typically beyond the current capabilities of manufacturing. Such solutions, when they are attainable with current technology, are typically expensive and time-consuming to implement.

The limitation to sensor array density involves the package and electronics size of each imaging/sensor device. Generally, these packages represent more than half of the size of the active imaging area of the individual sensor. Thus, these sensors cannot be arrayed without causing large gaps between images produced by the sensors, or overly complex and problematic optical systems to compensate for the presence of these gaps. Further, this problem is exacerbated by the electronics requirements for the interface and processing boards required to capture or transmit the data to a storage device. These gaps present a challenge that has not been successfully addressed by prior art attempts to provide higher-resolution digital image capture.

### SUMMARY

According to various embodiments, the system and method described herein provide an image capture device with a plurality of image sensors and a plurality of fiber optic bundles. The fiber optic bundles may convey light to the image sensors in a manner that minimizes or negates the effects of gaps between the image sensors.

For example, the image capture device may have a first image sensor that captures first image data, and a second image sensor that capture second image data. A main lens may direct incoming light along an optical path, and a microlens array may be positioned within the optical path. A first fiber optic bundle may have a first leading end positioned within the optical path and a first trailing end positioned proximate the first image sensor. A second fiber optic bundle may have a second leading end positioned within the optical path and a second trailing end positioned proximate the second image sensor. The second trailing end may be displaced from the first trailing end such that a gap exists between the first and second trailing ends. The first and second leading ends may be positioned adjacent to each other such that the first and second image data are combinable into a single light-field image that is substantially unaffected by the gap. Thus, the single light-field image may be substantially continuous in spite of the existence of the gap.

This may be accomplished, in some embodiments, by using tapered fiber optic bundles in which the leading end is magnified relative to the trailing end. The fibers of the leading end may have a one-to-one correspondence with those of the trailing end so that the image sensors accurately capture the light received at an image plane defined by the leading ends. Each fiber may have a cross-sectional area, at the trailing end, that is smaller than a pixel of the active area of the image sensor proximate the trailing end. This may preserve the effective resolution of the image sensor.

If desired, the fiber optic bundles may have different lengths. This may permit the image sensors to be positioned in a staggered, space-conserving formation. The image sensors additionally need not be parallel to each other. A beam splitter or other optical component may be used to facilitate the use of other arrangements and spacing patterns for the image sensors. In some embodiments, a beam splitter may be used to divide the incoming light between a first array of image sensors arranged along a first plane, and a second array of image sensors arranged along a second plane generally perpendicular to the first plane.

A polished fiber faceplate may be secured to the fiber optic bundles, for example, at the leading ends. The polished fiber faceplate may optionally have a faceted or smooth cylindrical or spherical shape facing the optical center of the main lens. In the alternative, the fibers of the leading ends may be bonded together and polished to provide the desired faceted or smooth cylindrical or spherical shape. In the alternative, no faceplate or collective polishing may be needed; rather, the leading ends of the fiber optic bundles may simply be arranged in a pattern corresponding to the desired shape. One or more microlens arrays may be secured to or integrated into the fiber optic bundles.

A separate preview lens may be used to receive a portion of the incoming light and direct it to a preview image sensor. The preview image sensor may generate a preview of the light-field image, which may be available in real-time, without requiring the time and/or computing power that may be needed to assemble the light-field image.

In various configurations, a high-resolution image may be captured to model one or more objects. This may be done, for example, through the use of a pair of parabolic reflectors, which may be focused on the optical center of the main lens or on the object(s). A parabolic reflector may be shaped to have multiple distinct focus points, for example, distributed about the object(s).

Further, in various configurations, a high-resolution image may be captured to model an environment. This may be done, for example, using a reflector that directs light into the main lens from a 360° sweep. A stationary or rotating reflector may be used.

Yet further, in various embodiments, a non-planar imaging plane may be used. This may be accomplished by having the leading ends of the fiber optic bundles arranged in a non-planar shape. Light may be conveyed to a planar image sensor.

Various back-end processing systems may be used to process such large images. In some embodiments, data may be received in parallel from the image sensors. Image previews may provide real-time feedback regarding the image being captured while the full image is being received and/or generated. In some embodiments, computational focal length and data management methods may be used.

### BRIEF DESCRIPTION OF THE DRAWINGS

The accompanying drawings illustrate several embodiments. Together with the description, they serve to explain the principles of the embodiments. One skilled in the art will recognize that the particular embodiments illustrated in the drawings are merely exemplary, and are not intended to limit scope.

FIG. 1 is a perspective view depicting an example of an image sensor, according to one embodiment.

FIG. 2 is a perspective view depicting an example of a machine vision camera module, or module, that may be used in an array configuration, according to one embodiment.

FIG. 3 is a front view of the module of FIG. 2, according to one embodiment.

FIG. 4A is a front view of multiple modules stacked side-by-side, according to one embodiment.

FIG. 4B is a side view depicting an example configuration in which modules are arranged into a first array and a second array, including a beam splitter, according to one embodiment.

FIG. 5 is a front view depicting the arrangement of active areas and packaging that results from use of the beam splitter as shown in FIG. 4B, according to one embodiment.

FIG. 6 is a perspective view depicting an example of an individual image sensor, or module, with an active area and packaging, according to one embodiment.

FIG. 7 is a front view depicting a 3×1 array of modules and fiber optic bundles, according to one embodiment.

FIG. 8A includes a side view of the module and the fiber optic bundle 600 of FIG. 6, and front and rear views of the fiber optic bundle in isolation, according to one embodiment.

FIG. 8B is a table illustrating exemplary parameters and specifications that may be used in the construction of a camera with multiple image sensors and fiber optic bundles, according to certain embodiments.

FIG. 9 includes a side view and a front view, depicting exemplary arrangements of modules and fiber optic bundles, according to certain embodiments.

FIG. 10 is a side view depicting a single fiber within a tapered fiber optic bundle, such as the fiber optic bundle of FIG. 6.

FIG. 11 includes front, top, and side views depicting an array of image sensors, or modules, and tapered fiber optic bundles, or fiber optic bundles, according to one embodiment.

FIG. 12 includes a side view and a front view depicting a configuration that uses a beam splitter in conjunction with modules that receive light through tapered fiber optic bundles, or fiber optic bundles, according to one embodiment.

FIG. 13 is a perspective view depicting an example of a configuration for the modules and fiber optic bundles of the first plane of FIG. 12, according to one embodiment.

FIG. 14 is a perspective view depicting an example of a configuration for the modules and fiber optic bundles of the second plane of FIG. 12, according to one embodiment.

FIG. 15 is a perspective view depicting how the first plane and the second plane may be aligned with each other, according to one embodiment.

FIG. 16 is a side view depicting an example configuration of tapered fiber optic bundles, or fiber optic bundles, that may be used to direct light to image sensors (not shown), according to another embodiment.

FIG. 17 is a virtual view depicting a tiled imaging plane according to one embodiment.

FIG. 18 is a front view depicting an example of strips for mounting micro lens optics to the rows or columns of fiber optic bundles and sensors, according to one embodiment.

FIG. 19 is a top view depicting an example of a multi-length tapered fiber optic bundle solution, according to one embodiment.

FIG. 20 is a perspective, wireframe view from the rear of the tiered approach of FIG. 19.

FIG. 21 is a top view depicting a cylindrically faceted approach, wherein the image sensors and/or fiber optic bundles are arced about the optical center of the main lens, according to one embodiment.

FIG. 22A is a top view depicting a cylindrically faceted approach, according to another embodiment.

FIG. 22B is a side view illustrating an arrangement of fiber optic bundles that have been bonded together and polished to provide a polished fiber face plate surface, according to one embodiment.

FIG. 23 is a side view depicting a single column of the faceted cylindrical imaging surface, which may be a section of a spherical imaging surface, according to one embodiment.

FIG. 24 is a front view depicting an example of trapezoidal faceted fiber taper surfaces that result when generating a spherical faceted surface, according to one embodiment.

FIG. 25A is a front view depicting the use of a polished fiber faceplate to provide a generally spherical concave surface on the imaging side, according to one embodiment.

FIG. 25B is a side, section view depicting the use of the polished fiber faceplate of FIG. 25B.

FIG. 26 is a perspective, wireframe view depicting exemplary asymmetrical stacking of modules and fiber optic bundles, according to one embodiment.

FIG. 27 is a side view depicting an example of a fiber optic bundle bonding configuration with a faceplate between the microlens array, or MLA, fiber optic bundle, and image sensor, or module, according to one embodiment.

FIG. 28 is a front view depicting an example of bondline tolerances between the leading ends of two exemplary fiber optic bundles separated by a bondline, according to one embodiment.

FIG. 29 is a top view depicting an exemplary technique for measurement of tolerance for image plane flatness between the leading ends of two exemplary fiber optic bundles, according to one embodiment.

FIG. 30A is a perspective view depicting a camera using multiple modules and fiber optic bundles as described herein, according to one embodiment.

FIG. 30B is a perspective view depicting an example of an internal mechanical design of an array of fiber optic bundles and modules, according to one embodiment.

FIG. 31 is a perspective view depicting a camera according to one embodiment.

FIG. 32 is an exploded view of a portion of the camera of FIG. 31.

FIG. 33 is a perspective view depicting the division of fiber optic bundle into four fiber optic bundles, according to one embodiment.

FIG. 34 is a perspective view depicting an example of a tapered fiber optic bundle with cut and polished edges, according to one embodiment.

FIG. 35 is a series of views depicting two of the tapered fiber optic bundles of FIG. 34, arranged in a 2×1 array, according to one embodiment.

FIG. 36 is a side view depicting an example of an alternative structure utilizing a transmissive surface as described above, according to one embodiment.

FIG. 37 is a top view depicting an example of inclusion of a tapered fiber optic bundle that magnifies light to the imaging sensor, according to one embodiment.

FIG. 38 is a top view depicting exemplary use of a scanline imager imaging the entire area according to one embodiment.

FIG. 39 is a front view depicting an example of 10% tolerance on an imaging sensor, plus pre-distortion correction from a fiber taper, according to one embodiment.

FIG. 40 depicts examples of inward and outward facing MLA's, according to certain embodiments.

FIG. 41 is a series of side views depicting examples of different configurations of the microlens array, according to certain embodiments.

FIG. 42A is a side view depicting an example in which the MLA has tilted structures angled towards the optical center of the main lens across the entire imaging area, according to one embodiment.

FIG. 42B is a side view depicting an example of an optimized MLA for a large chief ray angle (CFA) with tilted lenslets, according to one embodiment.

FIG. 43A is a side view depicting MLA structures secured to the trailing ends of fiber optic bundles, according to certain embodiments.

FIG. 43B is a side view depicting the MLA structures of FIG. 43A secured to the trailing ends, and an MLA structure secured to the leading ends, of the fiber optic bundles and MLA, according to certain embodiments.

FIG. 43C is a side view depicting a fiber optic bundle with an integrated MLA, according to one embodiment.

FIGS. 44 and 45 are side views depicting examples of a dual-layered MLA configuration, according to certain embodiments.

FIG. 46A is a side view depicting an example of a dual-layered MLA that can be used to increase off-axis performance using two polymer layers and one glass surface, according to one embodiment.

FIG. 46B is a top-down view depicting an MLA as a single sheet, and an MLA as a tiled, planar array, according to certain embodiments.

FIG. 46C is a top view depicting a plurality of MLA strips positioned at various orientations to face a main lens, according to one embodiment.

FIG. 46D is a top view depicting a spherical MLA mapped to a spherical surface, according to one embodiment.

FIG. 46E is a perspective view depicting an MLA that has been formed in a trapezoidal shape, according to one embodiment.

FIG. 46F is a top-down view depicting an MLA with square lenslets, according to one embodiment.

FIG. 46G is a side view depicting an example of a main lens that is movable relative to an MLA, according to one embodiment.

FIG. 46H includes a series of side views of examples depicting various ways in which a beam splitter may be used to divide incoming light between image sensors, according to one embodiment.

FIG. 47A is a side view depicting an example of refocusable ranges with a sequential exposure system as the distances decrease to camera with exponentially decreasing range, according to one embodiment.

FIG. 47B is a side view depicting the use of optical folds, according to one embodiment.

FIG. 47C is a side view depicting an example in which a plurality of main lenses are used in conjunction with polarized filters, according to one embodiment.

FIG. 47D is a side view depicting the use of an active barrier/variable mask to provide sequential capture of image data, according to one embodiment.

FIG. 47E is a side view depicting the use of modules, tapered fiber optic bundles, and MLA's positioned at variable displacements from a main lens, according to one embodiment.

FIG. 48 is a front view depicting an exemplary arrangement of a main array with beam splitter (not shown) and retro-reflector at gaps design to facilitate implementation of a preview sensor, according to one embodiment.

FIG. 49 is a side view illustrating how the preview sensor of FIG. 48 is able to re-photograph the larger imaging surface.

FIG. 50 is a top view depicting the use of a secondary beam splitter to redirect a small portion of light from the larger image plane in order to direct the light to a preview sensor, according to one embodiment.

FIG. 51 is a top view depicting an example of a range finder configuration in which a completely separate lens/sensor system is leveraged to increase main sensor system light efficiency, according to one embodiment.

FIG. 52 is a side view depicting an example of an architecture employing a first parabolic reflector and a second parabolic reflector, according to one embodiment.

FIG. 53 is a side view depicting an example of architecture employing a first parabolic reflector and a second parabolic reflector, according to another embodiment.

FIG. 54A is a side view depicting an example of a bottom-up configuration, with a first parabolic reflector and a second parabolic reflector, according to another embodiment.

FIG. 54B is a side view depicting a camera with a depth sensing sensor separate from a visible light sensor, according to one embodiment.

FIG. 54C is a side view illustrating a rotating reflector that may be used for sequential capture of image data, according to one embodiment.

FIG. 54D is a top-down view depicting an example of a structure to generate a mesh of reflective surfaces, according to one embodiment.

FIG. 54E is a side view depicting an example of a structure including several modifications, according to one embodiment.

FIG. 54F is a side view depicting an example of a structure including a panoramic annular lens, or PAL, according to one embodiment.

FIG. 54G is a side, cross-section view depicting the PAL of FIG. 54F, along with a cylindrical field of view, transfer optics, and an image sensor, according to one embodiment.

FIG. 54H is a conceptual diagram depicting a subaperture reducer for a light-field camera with a disk image diameter of five pixels, according to one embodiment.

FIG. 54J is a side view depicting placement of the subaperture reducer, relative to a simplified schematic of the complete system, according to one embodiment.

FIG. 55A is a side view depicting an example of a structure that provides a 360° scan of an environment, according to one embodiment.

FIG. 55B is side view depicting an example of a structure that captures a complete 360° spherical capture environment through the use of a rotating reflector, according to one embodiment.

FIG. 55C is a side view depicting an example of a structure having a reflector with an irregular shape, according to one embodiment.

FIG. 55D is a side view depicting an example of a structure in which a spherical lens is used to image an environment, according to one embodiment.

FIG. 55E is a side view depicting an example of a structure in which a fiber optic bundle is used to convey light from a secondary lens to an image sensor, according to one embodiment.

FIG. 55F is a side view depicting the use of a combined tapered fiber optic bundle and microlens array, or combined structure, according to one embodiment.

FIG. 56 is an image diagram depicting an example of how the imaging plane can be divided into multiple FOV segments, according to one embodiment.

FIG. 57 is an image diagram depicting an example of an alternative approach for dividing an imaging plane into FOV segments, according to one embodiment.

FIG. 58 depicts a portion of a light-field image.

FIG. 59 depicts an example of an architecture for implementing the methods of the present disclosure in a light-field capture device, according to one embodiment.

FIG. 60 depicts an example of an architecture for implementing the methods of the present disclosure in a post-processing system communicatively coupled to a light-field capture device, according to one embodiment.

FIG. 61 depicts an example of an architecture for a light-field camera for implementing the methods of the present disclosure according to one embodiment.

FIGS. 62A through 62D depict various systems that use shaped mirrors, according to certain embodiments.

FIGS. 63A through 63C depict various systems that use redirecting optical elements with other configurations, according to certain embodiments.

FIGS. 64A through 64C depict various systems that use a variety of mechanically movable optical elements in order to capture a large field-of-view, according to certain embodiments.

FIG. 65 depicts a system having a coherent fiber array comprising many optical fibers, according to one embodiment.

FIG. 66 depicts a side view of a scanning device placed between two mirrors placed at a 90° angle relative to one another, with the scanning device centered between them, projecting light beams radially such that the light beams are reflected by the mirrors, according to one embodiment.

FIGS. 67A and 67B depict two different mirror reflector designs with a reflective surface that is, respectively, cone-shaped on the inside, with a circular opening, and pyramidal with four mirrors placed in a pyramid formation with a square opening, according to certain embodiments.

FIGS. 68A and 68B depict the dimension of the opening for the reflected beams of light from, respectively, a scanning device utilizing the cone-shaped mirror reflector of FIG. 67A, and a scanning device using the pyramidal mirror reflector of FIG. 67B, according to certain embodiments.

FIGS. 69A and 69B depict laser beams from a LiDAR VLP-16 centered in, respectively, the cone-shaped mirror reflector of FIG. 67A, and the pyramidal mirror reflector of FIG. 67B, according to certain embodiments.

FIG. 70 depicts the sampling points in an imaging plane perpendicular to the axis of rotation of a Velodyne VLP-16 LiDAR device and a conical mirror reflector design such as the cone-shaped mirror reflector of FIG. 67A, in which the sampling points form a group of 16 concentric circles, with the LiDAR laser beams projected into a field-of-view of 30°, according to one embodiment.

FIG. 71 depicts a polar plot for the projected energy vs. angle distribution, in units of watts/steradians (W/sr), for a Velodyne VLP-16 LiDAR device used with a conical mirror reflector design such as the cone-shaped mirror reflector of FIG. 67A, according to one embodiment.

FIG. 72 depicts the sampling points in an imaging plane perpendicular to the axis of rotation of a Velodyne VLP-16 LiDAR device and a pyramidal mirror reflector design such as the pyramidal mirror reflector of FIG. 67B, in which the sampling points form two rectangular grids, with the LiDAR laser beams projected into a field-of-view of 30° in one dimension, and 90° in the orthogonal dimension, according to one embodiment.

FIG. 73 depicts a polar plot for the projected energy vs. angle distribution, in units of watts/steradians (W/sr) for a Velodyne VLP-16 LiDAR device used with a pyramidal mirror reflector design such as the pyramidal mirror reflector of FIG. 67B, according to one embodiment.

FIG. 74 depicts an image of a soldier with spots that represent LiDAR sampling measurement points, with the black spots designating an intersection of the scanning beam with the foreground object (the soldier), and the white spots designating the intersection of the scanning beam with the plane in the background, according to one embodiment.

### DEFINITIONS

For purposes of the description provided herein, the following definitions are used:
Active area: the portion of a module that receives light to be provided as image data by the module
Beam splitter: an optical component that divides incoming light into at least two portions emitted along different vectors.
Conventional image: an image in which the pixel values are not, collectively or individually, indicative of the angle of incidence at which light is received by a camera.
Cylindrical shape: a shape resembling either the outward-facing (convex) shape of a cylinder, or the inward-facing (concave) shape of a cylindrical hole.
Cylindrical pattern: a pattern of surfaces arranged in a cylindrical shape.
Depth: a representation of distance between an object and/or corresponding image sample and a microlens array of a camera.
Disk: a region in a light-field image that is illuminated by light passing through a single microlens; may be circular or any other suitable shape.
Fiber optic bundle: a set of aligned optical fibers capable of transmitting light.
Image: a two-dimensional array of pixel values, or pixels, each specifying a color.
Input device: any device that receives input from a user.
Leading end: the end of a fiber optic bundle that receives light.
Light-field camera: any camera capable of capturing light-field images.
Light-field data: data indicative of the angle of incidence at which light is received by a camera.
Light-field image: an image that contains a representation of light-field data captured at the sensor.
Main lens: a lens or set of lenses that directs light from a scene toward an image sensor.
Microlens: a small lens, typically one in an array of similar microlenses.
Microlens array: an array of microlenses arranged in a predetermined pattern.
Module: an image sensor, including packaging.
Packaging: The housing, electronics, and any other components of an image sensor that reside outside the active area.
Preview lens: a lens capable of directing at least a portion of incoming light to a preview sensor.
Preview sensor: an image sensor capable of gathering image data that can be used to provide a real-time (or small-delay) preview image indicative of an actual image that may be generated based on the incoming light.
Reflector: an object, such as a mirror, that has a surface that is at least partially reflective of light.
Sensor, or “image sensor”: a light detector in a camera capable of generating electrical signals based on light received by the sensor.
Spherical shape: a shape resembling either the outward-facing (convex) shape of a sphere, or the inward-facing (concave) shape of a spherical cavity.
Spherical pattern: a pattern of surfaces arranged in a spherical shape.
Tapered fiber optic bundle, or “taper”: a fiber optic bundle that is larger at one end than at the other.
Trailing end: the end of a fiber optic bundle that emits light.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art. One skilled in the art will recognize that many types of data acquisition devices can be used in connection with the present disclosure, and that the disclosure is not limited to cameras. Thus, the use of the term “camera” herein is intended to be illustrative and exemplary, but should not be considered to limit the scope of the disclosure. Specifically, any use of such term herein should be considered to refer to any suitable device for acquiring image data.

In the following description, several techniques and methods for processing light-field images are described. One skilled in the art will recognize that these various techniques and methods can be performed singly and/or in any suitable combination with one another. Further, many of the configurations and techniques described herein are applicable to conventional imaging as well as light-field imaging. Thus, although the following description focuses on light-field imaging, all of the following systems and methods may additionally or alternatively be used in connection with conventional digital imaging systems. In some cases, the needed modification is as simple as removing the microlens array from the configuration described for light-field imaging to convert the example into a configuration for conventional image capture.

### Architecture

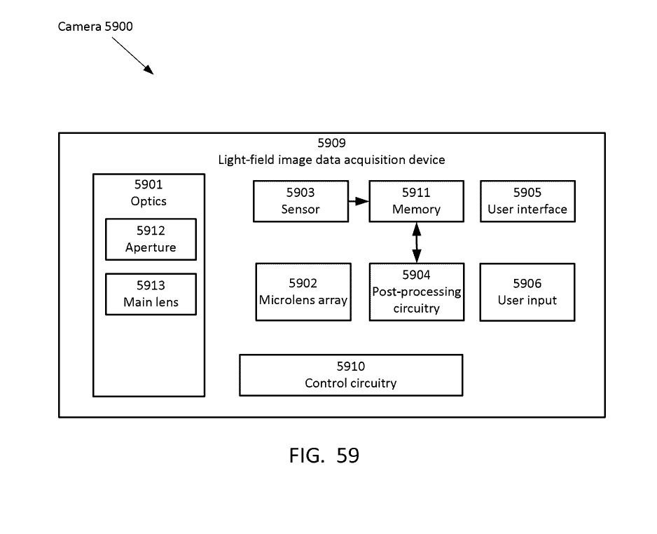

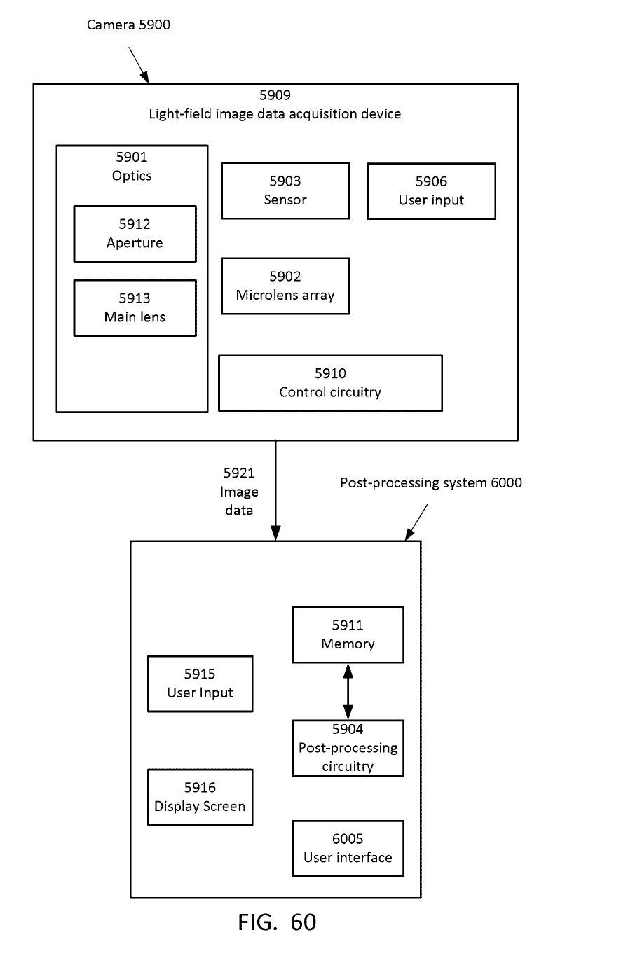

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science. Referring now to FIG. 59, there is shown a block diagram depicting an architecture for implementing the method of the present disclosure in a light-field capture device such as a camera 5900. Referring now also to FIG. 60, there is shown a block diagram depicting an architecture for implementing the method of the present disclosure in a post-processing system 6000 communicatively coupled to a light-field capture device such as a camera 5900, according to one embodiment. One skilled in the art will recognize that the particular configurations shown in FIGS. 59 and 60 are merely exemplary, and that other architectures are possible for camera 5900. One skilled in the art will further recognize that several of the components shown in the configurations of FIGS. 59 and 60 are optional, and may be omitted or reconfigured.

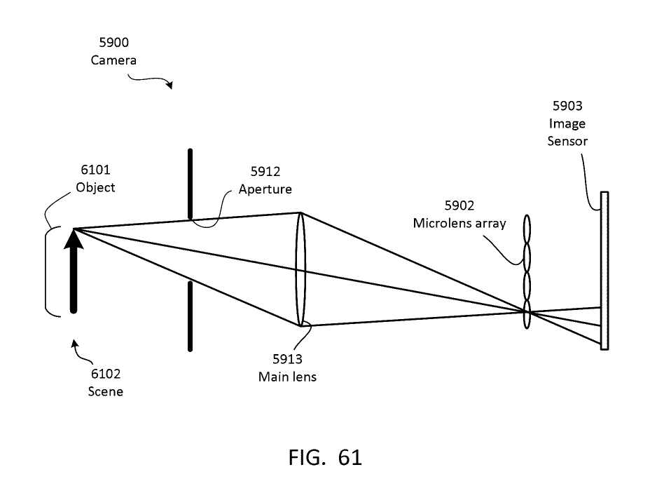

In at least one embodiment, camera 5900 may be a light-field camera that includes light-field image data acquisition device 5909 having optics 5901, image sensor 5903 (including a plurality of individual sensors for capturing pixels), and microlens array 5902. Optics 5901 may include, for example, aperture 5912 for allowing a selectable amount of light into camera 5900, and main lens 5913 for focusing light toward microlens array 5902. In at least one embodiment, microlens array 5902 may be disposed and/or incorporated in the optical path of camera 5900 (between main lens 5913 and image sensor 5903) so as to facilitate acquisition, capture, sampling of, recording, and/or obtaining light-field image data via image sensor 5903. Referring now also to FIG. 61, there is shown an example of an architecture for a light-field camera, or camera 5900, for implementing the method of the present disclosure according to one embodiment. The Fig. is not shown to scale. FIG. 61 shows, in conceptual form, the relationship between aperture 5912, main lens 5913, microlens array 5902, and image sensor 5903, as such components interact to capture light-field data for one or more objects, represented by an object 6101, which may be part of a scene 6102.

In at least one embodiment, camera 5900 may also include a user interface 5905 for allowing a user to provide input for controlling the operation of camera 5900 for capturing, acquiring, storing, and/or processing image data. The user interface 5905 may receive user input from the user via an input device 5906, which may include any one or more user input mechanisms known in the art. For example, the input device 5906 may include one or more buttons, switches, touch screens, gesture interpretation devices, pointing devices, and/or the like.

Similarly, in at least one embodiment, post-processing system 6000 may include a user interface 6005 that allows the user to provide input to switch image capture modes, as will be set forth subsequently. The user interface 6005 may additionally or alternatively facilitate the receipt of user input from the user to establish one or more other image capture parameters.

In at least one embodiment, camera 5900 may also include control circuitry 5910 for facilitating acquisition, sampling, recording, and/or obtaining light-field image data. The control circuitry 5910 may, in particular, be used to switch image capture configurations in response to receipt of the corresponding user input. For example, control circuitry 5910 may manage and/or control (automatically or in response to user input) the acquisition timing, rate of acquisition, sampling, capturing, recording, and/or obtaining of light-field image data.

In at least one embodiment, camera 5900 may include memory 5911 for storing image data, such as output by image sensor 5903. Such memory 5911 can include external and/or internal memory. In at least one embodiment, memory 5911 can be provided at a separate device and/or location from camera 5900.

For example, when camera 5900 is in a light-field image capture configuration, camera 5900 may store raw light-field image data, as output by image sensor 5903, and/or a representation thereof, such as a compressed image data file. In addition, when camera 5900 is in a conventional image capture configuration, camera 5900 may store conventional image data, which may also be stored as raw, processed, and/or compressed output by the image sensor 5903.

In at least one embodiment, captured image data is provided to post-processing circuitry 5904. The post-processing circuitry 5904 may be disposed in or integrated into light-field image data acquisition device 5909, as shown in FIG. 59, or it may be in a separate component external to light-field image data acquisition device 5909, as shown in FIG. 60. Such separate component may be local or remote with respect to light-field image data acquisition device 5909. Any suitable wired or wireless protocol can be used for transmitting image data 5921 to circuitry 5904; for example, the camera 5900 can transmit image data 5921 and/or other data via the Internet, a cellular data network, a Wi-Fi network, a Bluetooth communication protocol, and/or any other suitable means.

Such a separate component may include any of a wide variety of computing devices, including but not limited to computers, smartphones, tablets, cameras, and/or any other device that processes digital information. Such a separate component may include additional features such as a user input 5915 and/or a display screen 5916. If desired, light-field image data may be displayed for the user on the display screen 5916.

### Overview

Light-field images often include a plurality of projections (which may be circular or of other shapes) of aperture 5912 of camera 5900, each projection taken from a different vantage point on the camera's focal plane. The light-field image may be captured on image sensor 5903. The interposition of microlens array 5902 between main lens 5913 and image sensor 5903 causes images of aperture 5912 to be formed on image sensor 5903, each microlens in microlens array 5902 projecting a small image of main-lens aperture 5912 onto image sensor 5903. These aperture-shaped projections are referred to herein as disks, although they need not be circular in shape. The term “disk” is not intended to be limited to a circular region, but can refer to a region of any shape.

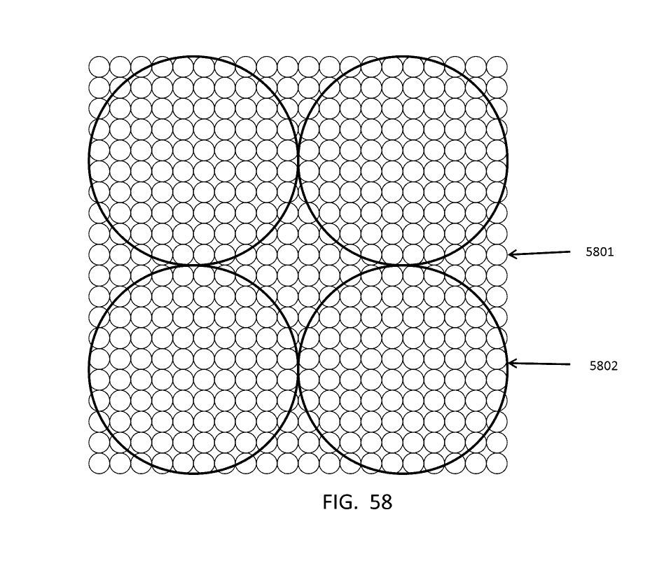

Light-field images include four dimensions of information describing light rays impinging on the focal plane of camera 5900 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a 4-D (x,y,u,v) resolution of (400,300,10,10). Referring now to FIG. 58, there is shown an example of a 2-disk by 2-disk portion of such a light-field image, including depictions of disks 5802 and individual pixels 5801; for illustrative purposes, each disk 5802 is ten pixels 5801 across.

In at least one embodiment, the 4-D light-field representation may be reduced to a 2-D image through a process of projection and reconstruction. As described in more detail in related U.S. Utility application Ser. No. 13/774,971 for “Compensating for Variation in Microlens Position During Light-Field Image Processing,” (Atty. Docket No. LYT021), filed Feb. 22, 2013, the disclosure of which is incorporated herein by reference in its entirety, a virtual surface of projection may be introduced, and the intersections of representative rays with the virtual surface can be computed. The color of each representative ray may be taken to be equal to the color of its corresponding pixel.

### Image Sensors and Packaging

The image sensor 5903 of a light-field camera, such as the camera 5900, may be of any known type. According to some embodiments, the image sensor 5903 may be of a type commonly used for digital imaging, in both light-field and conventional imaging devices. In alternative embodiments, the image sensor 5903 may be specifically designed for use in a light-field camera.

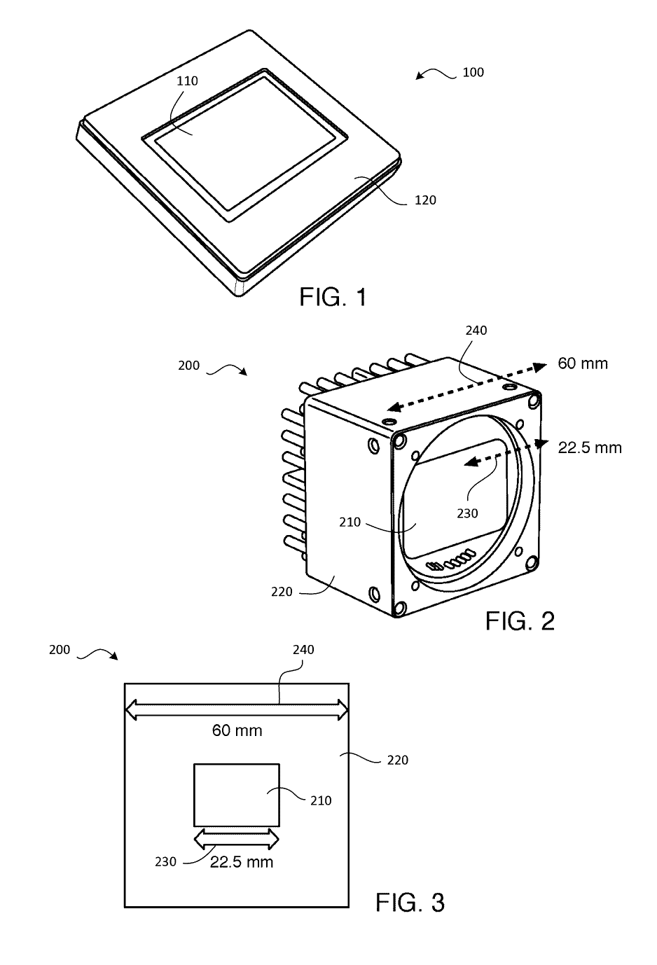

FIG. 1 is a perspective view depicting an example of an image sensor 100, according to one embodiment. The image sensor 100 has an active area 110 encircled by packaging 120. As shown, the active area 110 may be much smaller than the overall minimum size of the packaging 120.

FIG. 2 is a perspective view depicting an example of a machine vision camera module, or module 200, that may be used in an array configuration, according to one embodiment. The module 200 may have an active area 210 and packaging 220. The module 200 has a relatively small form factor that may provide a favorable ratio of package-to-active-area sizing, as indicated by the exemplary width 230 of the active area and width 240 of the package.

FIG. 3 is a front view of the module 200 of FIG. 2, according to one embodiment. FIG. 3 depicts the width 230 and the width 240 to illustrate the footprint of the active area 210 and that of the packaging 220, which may define a sensor enclosure around the active area 210.

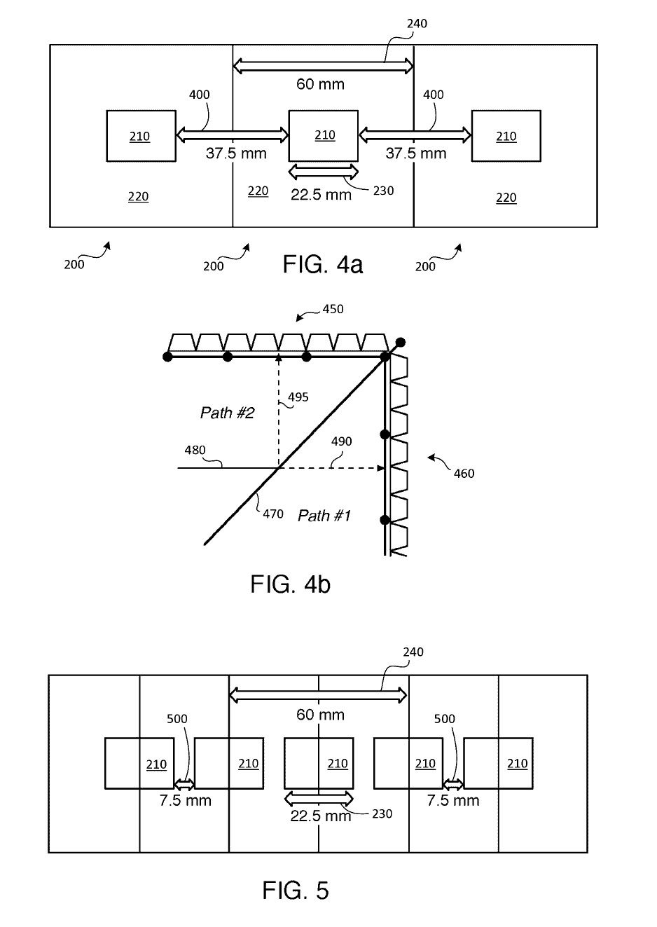

FIG. 4A is a front view of multiple modules 200 stacked side-by-side, according to one embodiment. FIG. 4A illustrates the evident challenge of simply stacking sensors next to each other. The result of such stacking is the presence of gaps 400 between the active areas 210 of adjacent modules 200. Such gaps 400, if not accounted for, may cause the captured image to show corresponding discontinuities, and may also result in the inefficient capture of light, as some of the light received would not be captured by an active area 210, but would instead impinge against the package 220 of one of the modules 200.

FIG. 4B is a side view depicting an example configuration in which modules 200 are arranged into a first array 450 and a second array 460, including a beam splitter 470, according to one embodiment. The first array 450 and the second array 460 may each be generally planar, with the planes angled at 90° relative to each other. The beam splitter 470 may be positioned to divide incoming light 480 into a first beam 490 directed toward the first array 450 and a second beam 495 directed toward the second array 460.

FIG. 5 is a front view depicting the arrangement of active areas 210 and packaging 220 that results from use of the beam splitter 470 as shown in FIG. 4B, according to one embodiment. The beam splitter 470 may increase the density of the active areas 210 receiving light by a factor of two. FIG. 5 illustrates the virtual imaging plane that would result, although the two planes would be separated on two or more separate axes. Gaps 500 still remain between the active areas 210. Gaps 500 are smaller than the gap 400 of FIG. 4A, but may still cause the resulting image to have discontinuities.

Additional beam splitters can be added, at the expense of light efficiency. In the particular configuration depicted in FIG. 5, approximately twelve to sixteen beam split image surfaces could be used, which could correspond to six to eight beam splitters, depending on mechanical configuration, to result in a virtually contiguous image surface. However, in such a configuration, only approximately 10% of the available light would hit each pixel, which may have a detrimental effect on efficiency and image quality.

### Tapered Fiber Optic Bundles

In at least one embodiment, the described system makes use of recent breakthroughs in fiber optic technologies that allow extremely dense fiber bundles to be manufactured efficiently and enable light to be rerouted and/or focused over the distance of the fiber bundle with more than 50% and, possibly even 80% or more, light transmission with very low image distortion. In particular, by modifying how these fiber bundles are manufactured, compelling advances for light-field computational imaging may be achieved. Such advances may have particular utility for video applications.

Further, in at least one embodiment, a fiber bundle manufacturing process can be used that allows for magnification or demagnification by stretching the fibers through a heat process, resulting in the ability to create an image plane at the ‘magnified’ end of a fiber bundle that is physically larger than the active area of a coupled image sensor at the opposite end of the fiber bundle. The image sensor may be directly mounted to the compressed and demagnified end of the fiber bundle. Each fiber can have a dimension smaller than the size of a pixel, resulting in a highly accurate averaging of light at the opposite end of the bundle, and further resulting in highly accurate light collection at the pixel level of the sensor. Further, the demagnification process may maintain an exact fiber-for-fiber alignment between the fibers at the compressed side and at the unmodified side. In this manner, extremely accurate results can be achieved.

In at least one embodiment, the system is implemented by optically stitching the active area of each individual image sensor so as to scale each pixel to a ratio equivalent to the required increase in active area size that is large enough to meet or exceed the minimum dimensions of the packaging. As a result, the gaps caused by image sensor packaging may be negated so that multiple image sensors may cooperate to capture an image without any optical seams (within a predetermined tolerance) between each of the discrete image sensors.

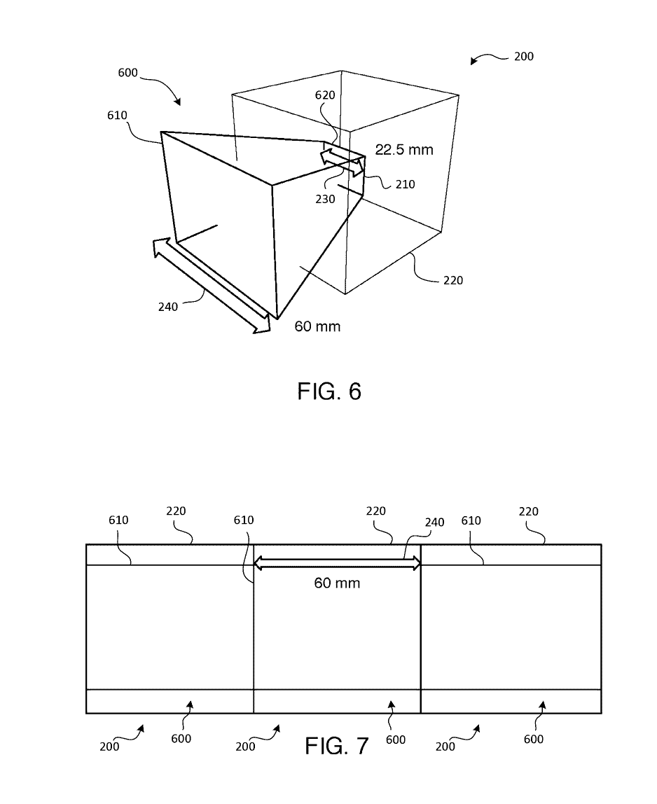

FIG. 6 is a perspective view depicting an example of an individual image sensor, or module 200, with an active area 210 and packaging 220, according to one embodiment. A fiber optic bundle 600, such as a bonded fiber bundle, may direct light into the active area 210. The fiber optic bundle 600 may have approximately 3× magnification along an optical axis. Thus, the fiber optic bundle 600 may have a leading end 610 that dimensionally matches the width 240 of the package 220, and a trailing end 620 that dimensionally matches the width 230 of the active area 210.

FIG. 7 is a front view depicting a 3×1 array of modules 200 and fiber optic bundles 600, according to one embodiment. The magnified end (i.e., the leading end 610) of each fiber optic bundle may have a width equal to or greater than the width 240 of the package 220 of each of the modules 200. The leading ends 610 of the fiber optic bundles 600 may cooperate to define a single, seamless surface at the image plane. As a result, the modules 200 may cooperate to capture a single, seamless image.

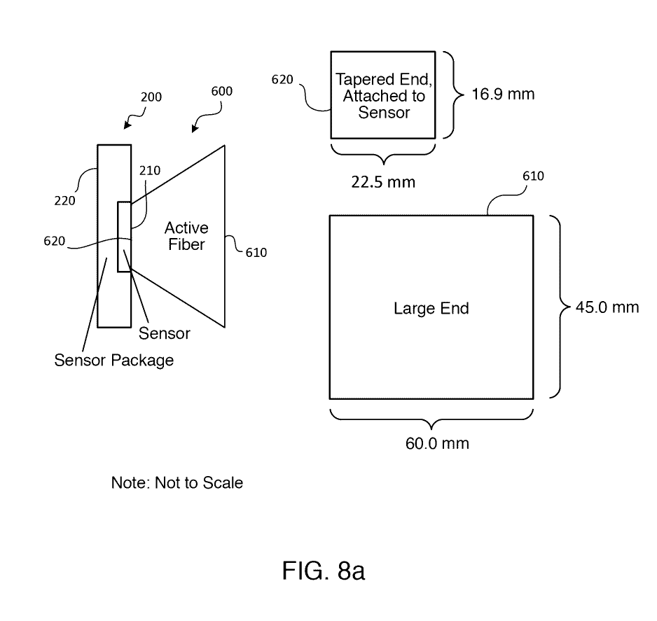

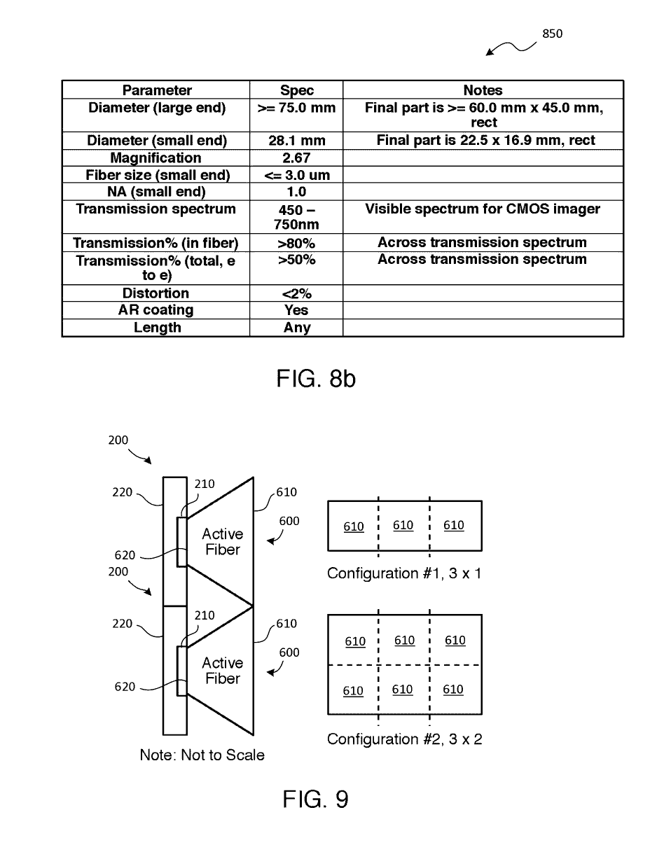

FIG. 8A includes a side view of the module 200 and the fiber optic bundle 600 of FIG. 6, and front and rear views of the fiber optic bundle 600 in isolation, according to one embodiment. The dimensions and other values shown in FIG. 8 are merely exemplary. The “large end” may be the leading end 610 of the fiber optic bundle 600, while the “tapered end” may be the trailing end 620.

FIG. 8B is a table 850 illustrating exemplary parameters and specifications that may be used in the construction of a camera with multiple image sensors and fiber optic bundles, according to certain embodiments. The values shown in the table 850 are merely exemplary; many other configurations may be used within the scope of the present disclosure.

FIG. 9 includes a side view and a front view, depicting exemplary arrangements of modules 200 and fiber optic bundles 600, according to certain embodiments. A 3×1 configuration and a 3×2 configuration are illustrated. These particular configurations are merely exemplary; other configurations are possible to provide a wide variety of image resolutions and aspect ratios. For example, a 5×11 configuration may be used in one alternative configuration (not shown). In any case, the example shown in FIG. 9 can be used to illustrate how the modules 200 can be effectively stitched by aligning the leading ends 610 of the corresponding fiber optic bundles 600 to provide a larger overall imaging plane.

The systems and methods described herein may provide a way to use light-field customized dense fiber bundle technologies to couple multiple image sensors of existing types and sensor technologies together. These techniques may thus avoid problems with seams that may otherwise be present in the final image due to sensor package size and electronics footprint. Further, these techniques may avoid the limitations that can otherwise exist when light splitting is used to optically seam arrays together, which can reduce light transmission to a level that adds significant noise.

Further, the systems and methods described herein can improve data throughput capabilities for video applications so that they exceed the transmission capabilities of most commercially available interfaces. The ability to receive image data from multiple image sensors, in parallel, may provide such enhanced throughput rates. The system can thereby transfer and store data from array segments independently, in a manner that is beneficial and efficient from a manufacturing standpoint.

Additionally, the ability to stack professionally leveraged image sensors to form sensor arrays may allow for higher quality imaging without the need of custom silicon fabrication. The system can thereby avoid the need for a large imaging plane that could otherwise exceed full frame formats.

The described system and method may provide the ability to mount commercially available image sensors, including dies, packaging, electronics, interfaces, and/or the like, at the compressed end of the fiber bundle element. Such an arrangement may provide a virtually unlimited pixel count as well as an extremely large and seamless highly efficient imaging plane through the use of an array of fiber optic bundles and sensors, as described previously. No custom image sensor fabrication is required.

Additionally, the cost of materials for the fiber optic bundles may be very low. Process costs can be reduced by constructing a dedicated manufacturing pipeline and process by which tapered fiber optic bundles can be rapidly and inexpensively manufactured.

Various embodiments include additional enhancements. One such enhancement relates to the fact that light may exit a tapered fiber optic bundle with an increased angle, relative to the angle at which the light entered the tapered fiber optic bundle. The ratio of exit angle to entry angle may be proportional to the ratio of magnification provided by the tapered fiber optic bundle. For example, if light enters the fiber at an angle of 10 degrees relative to the axis of the fiber, and the magnification of the fiber is approximately 3:1, the angle of exit will be approximately 30 degrees.

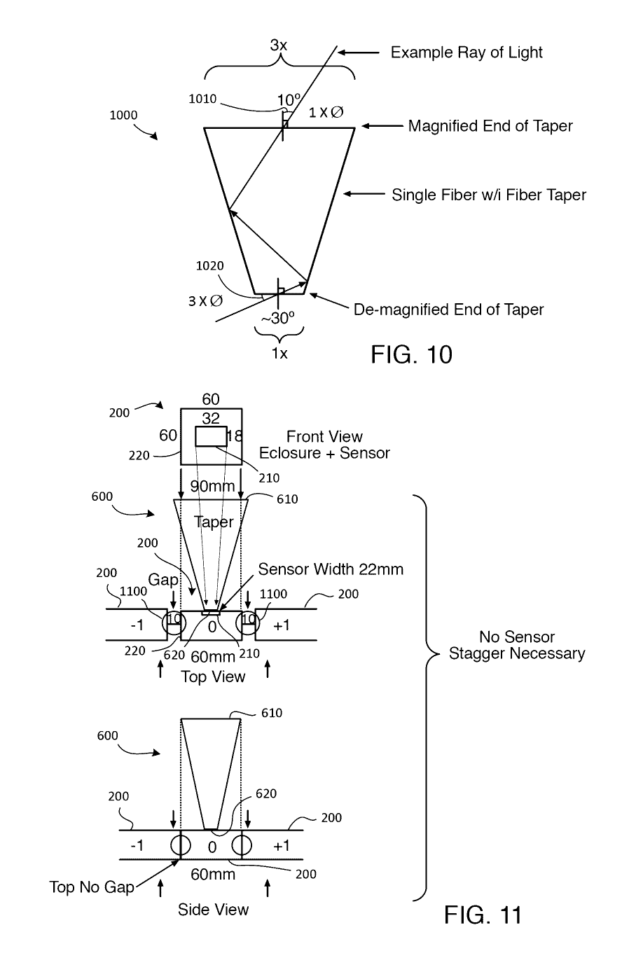

FIG. 10 is a side view depicting a single fiber 1000 within a tapered fiber optic bundle, such as the fiber optic bundle 600 of FIG. 6. The angles at which the light reflects within the interior of the fiber 1000 provide an angle of exit 1020 that is approximately three times an angle of entry 1010, demonstrating how light exits at a potentially increased exit angle. The angle of entry 1010 and the angle of exit 1020 are exaggerated in FIG. 10 to illustrate the change.

This change in angle of incidence of the light can have a beneficial effect on image sensor efficiency. Certain image sensors respond best when receiving more collimated light, such as light entering the sensor at an angle of about 15°. Accordingly, in at least one embodiment, the system redirects light entering the camera such that the light impinges on the active area of each image sensor at an angle that optimizes the light collection efficiency of the system. Various aspects of the camera, such as the length and magnification of the tapered fiber optic bundles, may be configured in a manner that optimizes the light collection efficiency.

In at least one embodiment, the active area of one or more of each image sensor may not be square. The magnification of each of the tapered fiber optic bundles may be limited to have a magnified dimension that is greater than or equal to the largest mechanical dimension for the larger active sensor area dimension. For example, if the packaging of each module is 60 mm×60 mm, and the sensor is 20 mm×15 mm, the magnified end (i.e., the leading end) of the optical fiber bundle may be configured to be at least 60 mm, resulting in an approximate magnification factor of 3×, and an imaging area of approximately 60 mm×45 mm. The imaging area can be split multiple times to allow for decreased magnification factors per tapered fiber optic bundle, at the expense of decreased light transmission and increased overall system size, but with decreased angular magnification of each fiber.

In the architecture described herein, there are two ends of each fiber optic bundle: a large, leading end (magnified, used at the imaging plane) and a small, trailing end (minimized, used at the sensor). In at least one embodiment, the leading end of the tapered fiber optic bundle is magnified so that its minimum dimension is at least as large as the maximum dimension of the packaging of the corresponding image sensor. In this manner, when incorporating the packaging behind the tapered fiber optic bundle, there is more than sufficient mechanical spacing without the need to stagger the fiber optic bundles and/or the image sensors to increase density.

For example, suppose the packaging of each module is 60 mm×60 mm, and the sensor is 20 mm×15 mm. A magnification factor of 4 may be applied, so that the smallest dimension of the sensor (15 mm) is magnified to include the maximum dimension of the enclosure (60 mm). The aspect ratio is preserved, so that the leading end of the tapered fiber optic bundle is 80 mm×60 mm in size.

As another example, if the packaging of each module is 60 mm×60 mm, and the sensor is 20 mm×15 mm, the leading end of each fiber optic bundle can be about 80 mm×60 mm, resulting in the ability to stitch all packaging without any staggering or beam splitters (or the like), at the expense of an increased taper in the fiber optic bundles, and thus a larger overall imaging plane.

FIG. 11 includes front, top, and side views depicting an array of image sensors, or modules 200, and tapered fiber optic bundles, or fiber optic bundles 600, according to one embodiment. The leading end 610 of each fiber optic bundle 600 may contain the small dimension of the largest side of the packaging 220 of the corresponding module 200. This may result in increased magnification and imaging area without the need to stagger the electronics. Such an approach may facilitate the use of a beam splitter (or multiple beam splitters, depending on the system configuration) and configuration of each of the rows of modules 200 into two aligned imaging planes. The top view illustrates the presence of gaps 1100 between the modules 200. In the side view, the modules 200 may be positioned to abut each other such that no gaps are present.

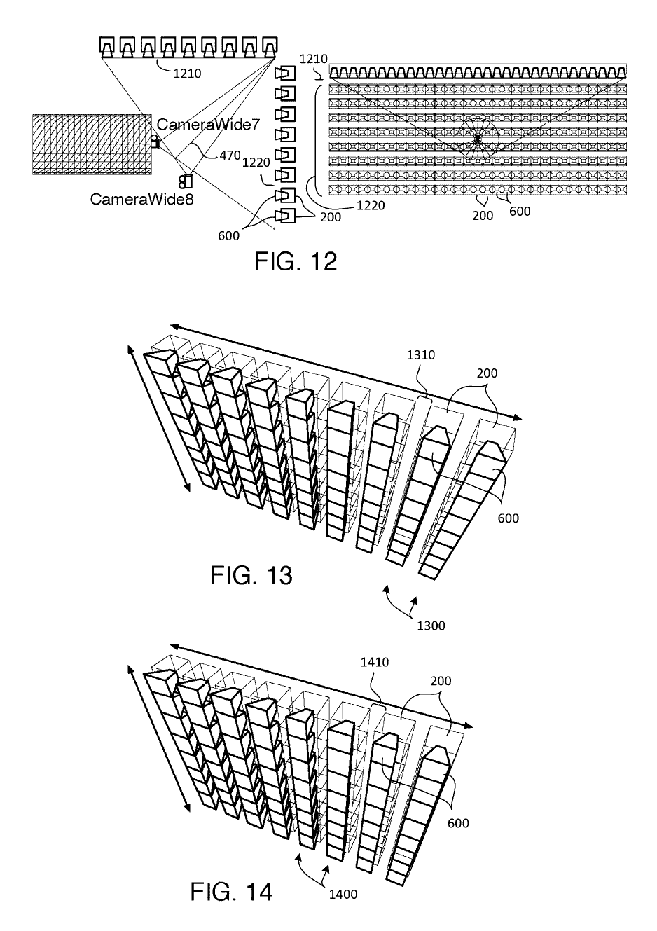

FIG. 12 includes a side view and a front view depicting a configuration that uses a beam splitter in conjunction with modules 200 that receive light through tapered fiber optic bundles, or fiber optic bundles, 600, according to one embodiment. The left side of the FIG. 12 depicts a side view, wherein the design for the beam splitter 470 can be seen dividing the optical path into a first plane 1210 and a second plane 1220, allowing for additional package spacing. The right side of the FIG. 12 depicts a front view, wherein the rows of the modules 200 can be seen; the virtual imaging plane that results from the combination of the top and bottom paths intersecting with one another may result in a contiguous imaging surface. Any suitable arrangement can be used that allows for increased electronics dimensions through the use of scaled pixels with tapered fiber optic bundles, including for example a horizontal arrangement, a vertical arrangement, a checkerboard arrangement, and/or the like.

Use of the beam splitter 470 may allow further increased resolution by capturing light at surfaces displaced from each other by 90° (or in alternative embodiments, a different angle). Some light transmission may be sacrificed due to the fact that each surface may only receive about half of the incoming light received through the aperture. However, greater mechanical configuration flexibility may be obtained by rotation of the planes.

In alternative embodiments, any other optical method can be used for directing light in multiple optical paths. Thus, reference herein to a “beam splitter” can be considered to include any such alternatives, including for example, but not limited to, polarizers, birefringent materials, prisms, various optical coatings, mirrors, and/or the like.

FIG. 13 is a perspective view depicting an example of a configuration for the modules 200 and fiber optic bundles 600 of the first plane 1210 of FIG. 12, according to one embodiment. The first plane 1210 may receive light from along a first path. The modules 200 may be arranged in nine vertically-oriented columns 1300 of eight modules 200 each, for a total of seventy-two modules 200. A gap 1310 may be present between each adjacent pair of the columns 1300.

FIG. 14 is a perspective view depicting an example of a configuration for the modules 200 and fiber optic bundles 600 of the second plane 1220 of FIG. 12, according to one embodiment. The second plane 1220 may receive light from along a second path. The modules 200 may be arranged in eight vertically-oriented columns 1400 of eight modules 200 each, for a total of sixty-four modules 200. A gap 1410 may be present between each adjacent pair of the columns 1400.

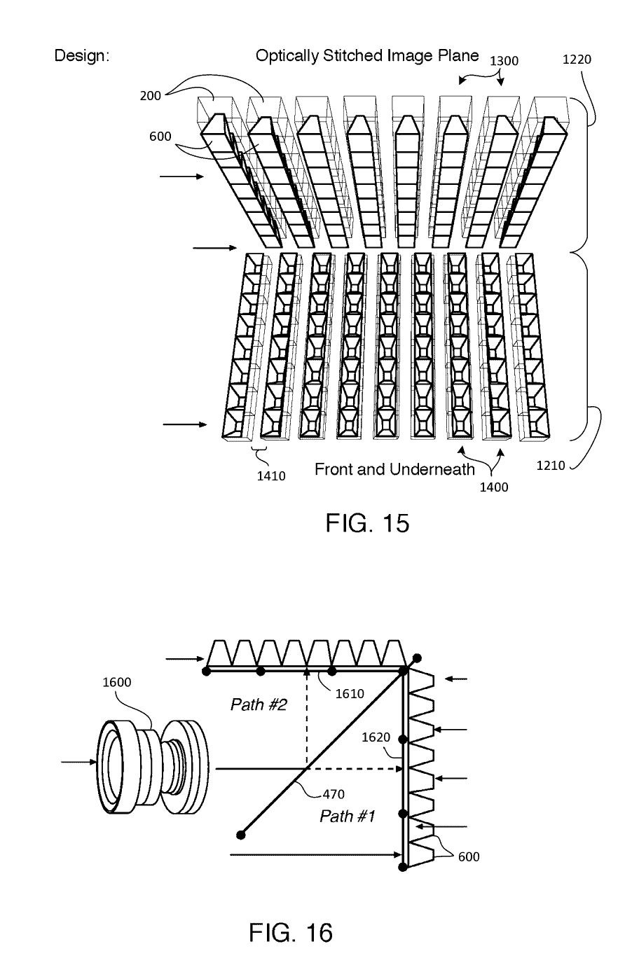

FIG. 15 is a perspective view depicting how the first plane 1210 and the second plane 1220 may be aligned with each other, according to one embodiment. As shown, the columns 1300 of the first plane 1210 may be staggered relative to the columns 1400 of the second plane 1220, such that the light received by the modules 200 of the second plane 1220 negates the gaps 1310 between the columns 1300, and the light received by the modules of the first plane 1210 negates the gaps 1410 between the columns 1400.

FIG. 16 is a side view depicting an example configuration of tapered fiber optic bundles, or fiber optic bundles 600, that may be used to direct light to image sensors (not shown), according to another embodiment. A beam splitter 470 may again be used to direct light from a main lens 1600 to fiber optic bundles 600 arranged along a first plane 1610 and a second plane 1620.

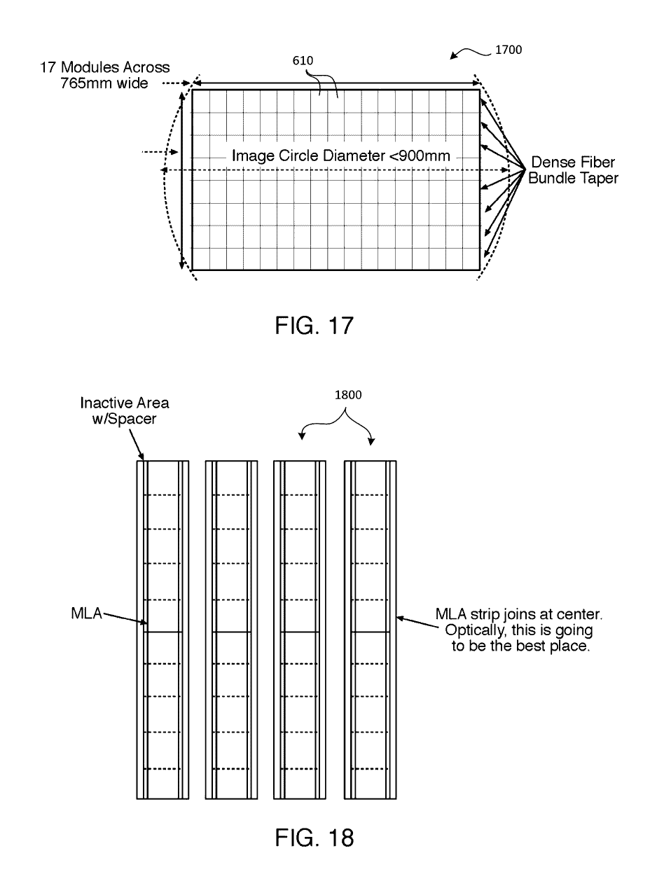

FIG. 17 is a virtual view depicting a tiled imaging plane 1700 according to one embodiment. The leading ends 610 of fiber optic bundles 600 may be tiled to define the imaging plane 1700. The various values and numerical labels in FIG. 17 are merely exemplary; other dimensions and numbers of modules 200 and fiber optic bundles 600 may be used.

The above-described configurations may provide additional benefits. For example, such configurations may allow for a spherically curved imaging plane without the requirement of trapezoidal fiber customizations, as discussed in more detail below. In addition, these configurations provide the ability to orient each row or column independently, and/or to install custom rows and/or columns of the microlens array in strips without seams when viewed as the virtual complete sensor. Furthermore, these configurations may facilitate improved mechanical design.

FIG. 18 is a front view depicting an example of strips 1800 for mounting micro lens optics to the rows or columns of fiber optic bundles and sensors, according to one embodiment. In various embodiments, the microlens array may be positioned in any of various locations, including but not limited to between the module 200 and the fiber optic bundle 600, and between the main lens 1600 and the fiber optic bundle 600. The microlens array may be divided into strips 1800 and secured to the fiber optic bundles 600 and/or modules 200 of the columns, as shown in FIG. 18, providing additional mechanical clearance for other adjustments and design.

In at least one embodiment, in order to allow for increased sensor density without the use of multiple imaging planes (or in combination with other applications such as HDR, depth, and/or the like), a multi-length face plate approach may be employed. By mounting two or more faceplates with offsets between them, or by incorporating fiber tapers at different lengths, and staggering at a minimum of every other row and/or column, it is possible to allow for increased package size with increased sensor density, while gaining increased light transmission efficiency by eliminating additional beam splitter paths.

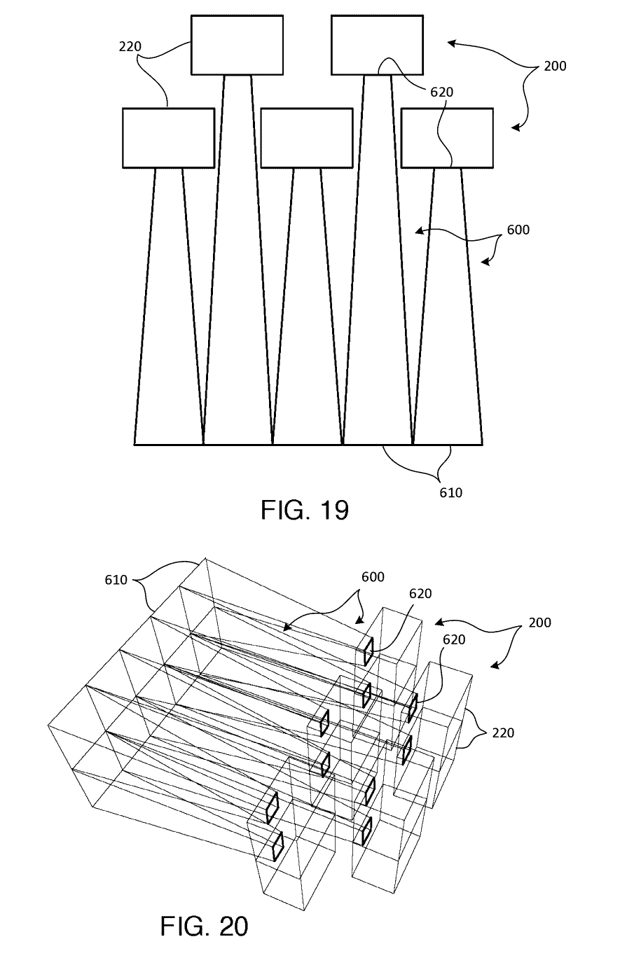

FIG. 19 is a top view depicting an example of a multi-length tapered fiber optic bundle solution, according to one embodiment. Each of the fiber optic bundles 600 may have a faceplate bonded to it to facilitate the use of various lengths of fiber optic bundles 600 with a contiguous imaging plane, and without the necessity of a beam splitter. By staggering multiple face plate lengths, the mechanical spacing required along X and Y (from the front) may decrease to the minimum dimension of the packaging 220 of each module 200.

As mentioned previously, in the architecture described herein, there are two ends of each tapered fiber optic bundle, or fiber optic bundle 600: a large, leading end 610 (magnified, used at the imaging plane) and a small, trailing end 620 (minimized, used at the module). In at least one embodiment, the leading end 610 of the fiber optic bundle 600 is magnified so that the largest dimension of the leading end 610 is at least as large as the maximum dimension of the packaging 220 of the module 200.

For example, suppose the electronics/enclosure of each module 200 is 60 mm×60 mm, and the active area 210 is 20 mm×15 mm. A magnification factor of 3 is applied, so that the largest dimension of the active area 210 (20 mm) is magnified to include the maximum dimension of the packaging 220 (60 mm). The aspect ratio is preserved, so that the resulting leading end 610 becomes 60 mm×45 mm.

In this manner, when incorporating the packaging 220 behind the fiber optic bundle 600, in at least one embodiment, the lengths of the faceplates/fiber optic bundles 600 are staggered to provide an overlap between the packaging 220 of the modules 200. In the example described above, an overlap of 15 mm is provided in one dimension, with no overlap in the other dimension (since the large dimension of the leading end 610 is matched to the largest side of the packaging 220). Staggering the lengths of the fiber optic bundles 600 in this manner may provide increased mechanical density and decreased active imaging area. Further, such staggering may provide higher light transmission by enabling the use of a lower magnification ratio in the fiber optic bundles.

Such a configuration may allow for any number of staggered tiers, given certain mechanical requirements to include two or more lengths. For example, in one embodiment, five to seven lengths can be provided for five to seven tiers of modules 200 that are staggered from each other.

FIG. 20 is a perspective, wireframe view from the rear of the tiered approach of FIG. 19. In this example, the arrangement produces a contiguous imaging plane with two lengths of fiber optic bundles 600. The leading ends 610 of the fiber optic bundles 600 may be aligned and positioned coplanar to each other to define the imaging plane.

In at least one embodiment 9 μm fiber pitch optics can be used at the leading ends 610 of the fiber optic bundles 600, and an approximately 3× magnification ratio/factor can be used to provide an approximately 3 μm pitch fiber at the trailing end 620. However, any suitable size of optical fibers can be used. In other embodiments, other fiber technologies can be used as well as any statistical or interstitial EMA design, and/or any material, refractive index, numerical aperture, and/or the like.

In at least one embodiment, the modules 200 are tiled, faceted, or stepped (terms that may be used interchangeably) in a cylindrical fashion, angling the normal of the leading end 610 of each fiber optic bundle 600 to be perpendicular to the chief ray angle. In at least one embodiment, this approach may be modified to increase or decrease this angle depending on certain optical system components or mechanical design considerations. The fiber optic bundle 600 in this approach may be polished at the required angle to allow for simplified mechanical design, and/or an enclosure can be provided to accommodate these angles. Similar techniques can be used for the beam splitter or other optically splitting solution.

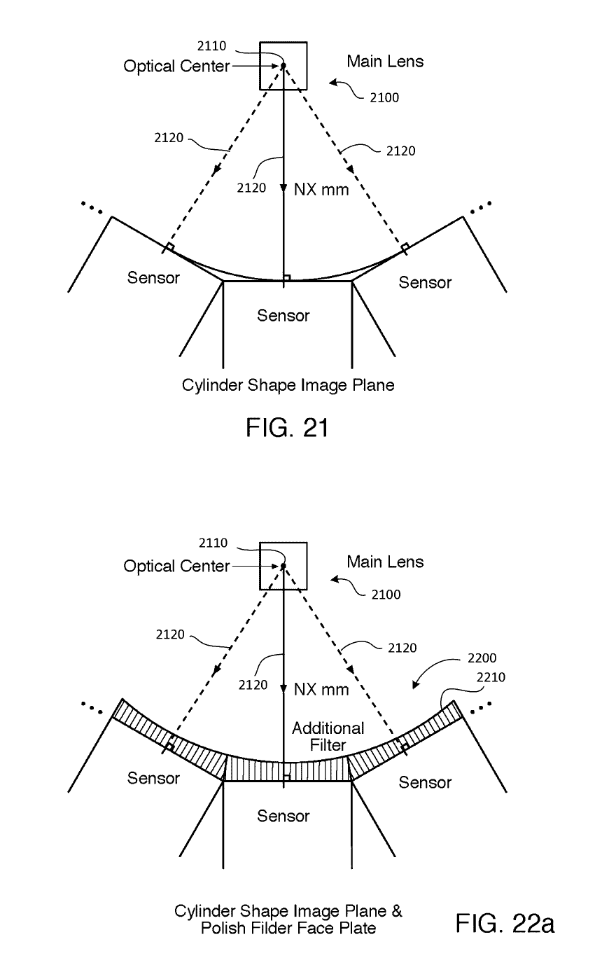

FIG. 21 is a top view depicting a cylindrically faceted approach, wherein the image sensors and/or fiber optic bundles 600 are arced about the optical center 2110 of the main lens 2100, according to one embodiment. The center of the imaging surface may thus be kept perpendicular to the corresponding ray 2120 leading to the optical center 2110. In at least one embodiment, this arrangement may be constructed on a variable approach, where the ability to curve these tiles or return to a flat imaging plane is possible. This may allow the optical center of the main lens to drift depending on the requirements for focal length, focus, and/or calibration. This may result in a single axis exhibiting a cylindrical form (with step functions at each image sensor). Illumination and aberration may become more computationally intensive without a contiguous cylindrical surface.

In at least one embodiment, an additional fiber face plate is added with a single surface that matches the faceted function of the leading end 610 of each fiber optic bundle 600, with a polished exterior surface. This design may eliminate the face plate. This surface may be directly polished in this configuration with each fiber optic bundle individually or as a whole mechanical apparatus.

FIG. 22A is a top view depicting a cylindrically faceted approach, according to another embodiment. A polished fiber face plate 2200 may be added to match the faceted surface of the leading ends 610 of the fiber optic bundles. The polished fiber face plate 2200 may be manufactured to include an accurately cylindrical surface 2210.

In at least one embodiment, these fibers, and all of the components in the system that are bonded to or between additional fibers, are bonded using a matched refractive indexed epoxy, UV cure or other appropriate adhesive. Alternatively, these bonds may be made in a temporary fashion (such as by mechanical bonds and gaskets) or with other adhesives that may be removable. Such attachment methods are not limited to the embodiment of FIG. 22A, but may be used to facilitate the attachment of any combination of fiber structures, faceplates, and/or other optical components, including but not limited to those in the other embodiments set forth in this disclosure.

In at least one embodiment, a polished fiber face plate surface may additionally or alternatively be fabricated by bonding the fiber surfaces together, and then directly polishing the surface into the desired cylindrical or spherical shape without orienting the centers of each respective leading end 610 to be perpendicular to the optical center. Alternatively, some hybrid of the two options can be used, blending the partially angled and partially polished approaches.

FIG. 22B is a side view illustrating an arrangement of fiber optic bundles 2250 that have been bonded together and polished to provide a polished fiber face plate surface 2260, according to one embodiment. The fiber face plate surface may thus be formed from the fibers of the fiber optic bundles 2250, rather than from the attachment of an additional element to the fiber optic bundles 2250.

With the cylindrical surface approach, it is possible that the alternate axis (for example, cylindrical along x, the alternate axis being y) will exceed the ideal angles for entry and exit. Thus, in at least one embodiment, a cylindrical (stepped) approach is used, wherein an additional faceplate is added to a spherical imager in a stepped or smooth approach. The cylindrical (x axis) may remain stepped with either approach. This is beneficial as all shapes may remain linear, and thus may not require trapezoidal distortion. The above description is merely exemplary; for example, x and y can be interchanged as the dominant axis (so that cylindrical would be along y instead of x). This may be directly manufactured into the leading ends of the fiber optic bundles as in FIG. 22B, without the attachment of separate face plates as mentioned in the previous cylindrical face plate section.

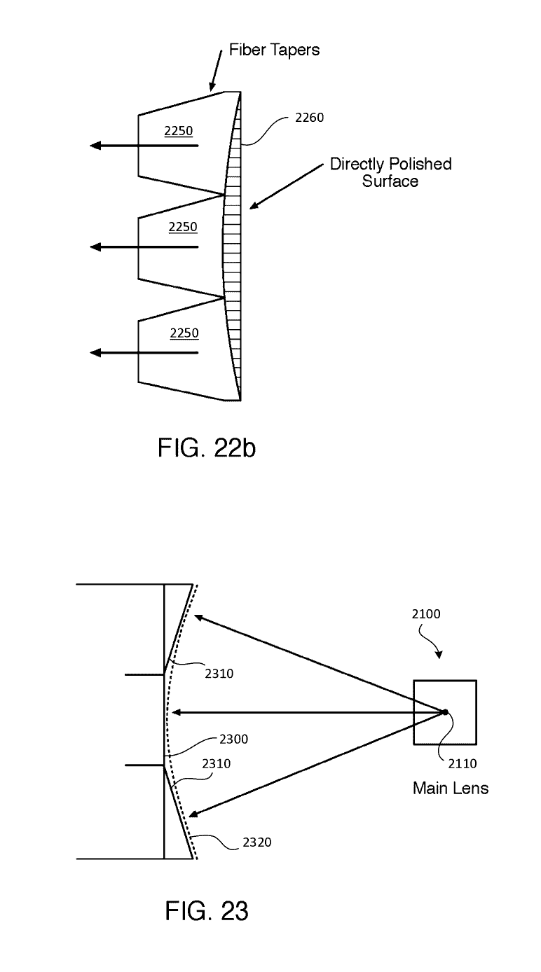

FIG. 23 is a side view depicting a single column 2300 of the faceted cylindrical imaging surface, which may be a section of a spherical imaging surface, according to one embodiment. The faceted cylindrical imaging surface may appear to be completely flat from the side view, although from the top it may appear cylindrical. Additional face plates are manufactured to include faceted surfaces 2310 and/or or smooth/polished surfaces 2320 along the opposite dimension, causing the resulting shape to be faceted or polished spherical.

In at least one embodiment (not shown), fiber optic bundles may be formed with trapezoidal shapes for greater accuracy in configuring the tiled spherical shape. In this design, the center of the leading end of each fiber optic bundle, including any offset from the flat surface, may be perpendicular to the optical center 2110 of the main lens 2100, as in FIG. 21.

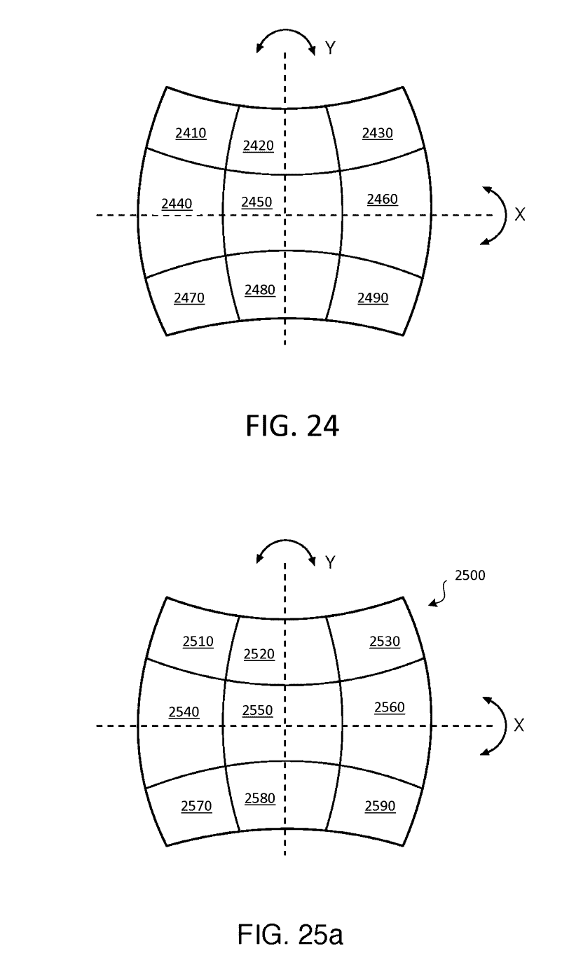

FIG. 24 is a front view depicting an example of trapezoidal faceted fiber taper surfaces that result when generating a spherical faceted surface, according to one embodiment. As shown, leading ends 2410, 2420, 2430, 2440, 2450, 2460, 2470, 2480, and 2490 of tapered fiber optic bundles may be angled and arranged to define a generally spherical, concave shape.

In another embodiment, fiber surfaces may be bonded together, and then a spherical surface may be directly polished into the adjoining leading ends of the fiber optic bundles that define the resulting fiber structure, without orienting each leading end to be perpendicular to the optical center. In yet another embodiment, some hybrid solution may be performed that combines the angled and polished approaches.

In at least one embodiment, as a further advance, a polished fiber faceplate is bonded or otherwise secured to the leading ends of the fiber optic bundles. The polished fiber faceplate may have the tile shape on the side adjoining the leading ends, and a spherical surface on the alternate (imaging) side.

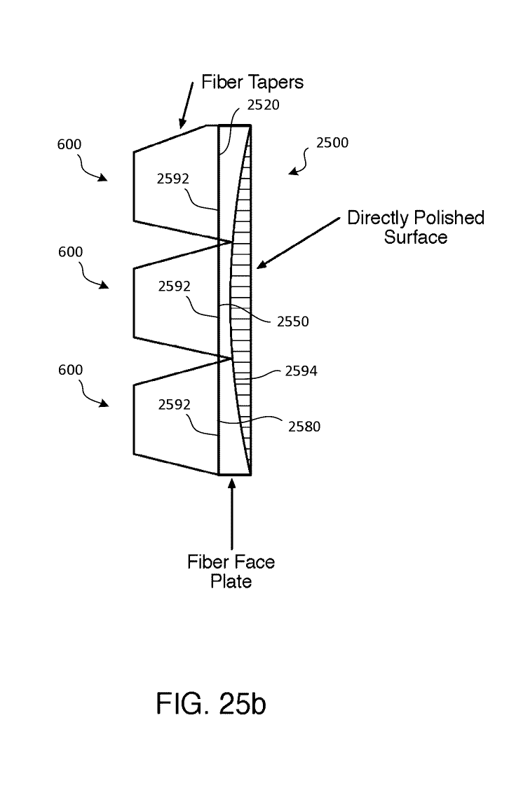

FIG. 25A is a front view depicting the use of a polished fiber faceplate 2500 to provide a generally spherical concave surface on the imaging side, according to one embodiment. The leading ends 2510, 2520, 2530, 2540, 2550, 2560, 2570, 2580, and 2590 of the fiber optic bundles 600 may be covered by the polished fiber faceplate 2500, which may be shaped, at its trailing end, to match the profile of the combined leading ends 2510, 2520, 2530, 2540, 2550, 2560, 2570, 2580, and 2590. Such an approach may additionally provide the ability to produce non-trapezoidal fiber optic bundles (resulting in gaps between the fiber optic bundles themselves) with the added trapezoidal and tapered polished faceplates to fill in the gaps and produce the desired spherical surface.

FIG. 25B is a side, section view depicting the use of the polished fiber faceplate 2500 of FIG. 25B. As shown, the fiber optic bundles 600 may have non-trapezoidal shapes. The trailing end of the polished fiber faceplate 2500 may provide interfacing shapes 2592, and may have a spherical surface 2594 at its leading end.

In at least one embodiment, the modules 200 and fiber optic bundles 600 are mounted in a configuration wherein each of the modules 200 is angled, with a commensurate angle to the cut and polish of the trailing end 620 of the fiber optic bundle 600. This may provide additional mechanical flexibility and/or alternative design options.

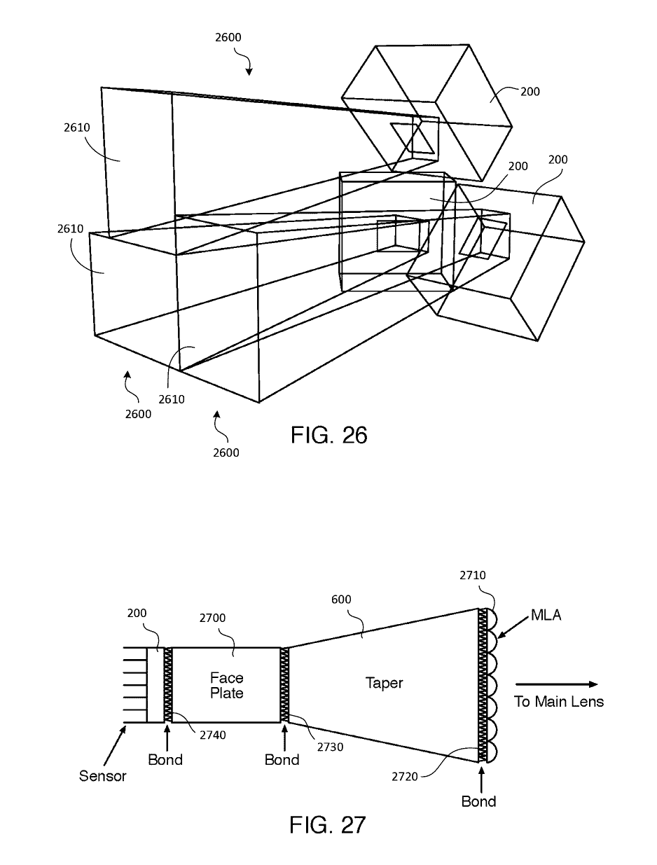

FIG. 26 is a perspective, wireframe view depicting exemplary asymmetrical stacking of modules 200 and fiber optic bundles 2600, according to one embodiment. The leading ends 2610 of the fiber optic bundles 2600 may be arranged asymmetrically, and the fiber optic bundles 2600 may be angled to provide for mounting of the modules 200 at various orientations.

In any of the described configurations, the image sensors may be bonded to a fiber face plate or taper, and/or temporarily bonded without an adhesive via a pressure mounted system. This may be done with or without removing the sensor's CFA or pixel MLA (not referring to plenoptic MLA), with the cover glass removed. For example, the image sensor, including the active area, can be mounted to a structural plate, the fiber can be attached to a second structural plate, a gasket can be placed between the two plates, and then the plates can be machine-screwed together to form a semi-permanent bond between the components. The tapered fiber optic bundles may or may not be bonded to a faceplate between the fiber optic bundle and image sensor.

FIG. 27 is a side view depicting an example of a fiber optic bundle bonding configuration with a faceplate 2700 between the microlens array, or MLA 2710, fiber optic bundle 600, and image sensor, or module 200, according to one embodiment. Bonds 2720, 2730, and 2740 may be formed between the MLA 2710 and the fiber optic bundle 600, between the fiber optic bundle 600 and the faceplate 2700, and between the faceplate 2700 and the module 200, respectively. The bond 2720 between the MLA 2710 and the fiber optic bundle 600 may be replaced with an air-gap, depending on the configuration of the MLA 2710.

### Tolerances and Mechanical Design

In at least one embodiment, each module in the array is mounted with a permanent mechanical alignment stage, or with a temporary mechanical alignment mechanism that is calibrated and then removed after initial manufacture. Any suitable mechanism can be used to ensure that tolerances are maintained for appropriate alignment and reconstruction of the larger imaging plane.

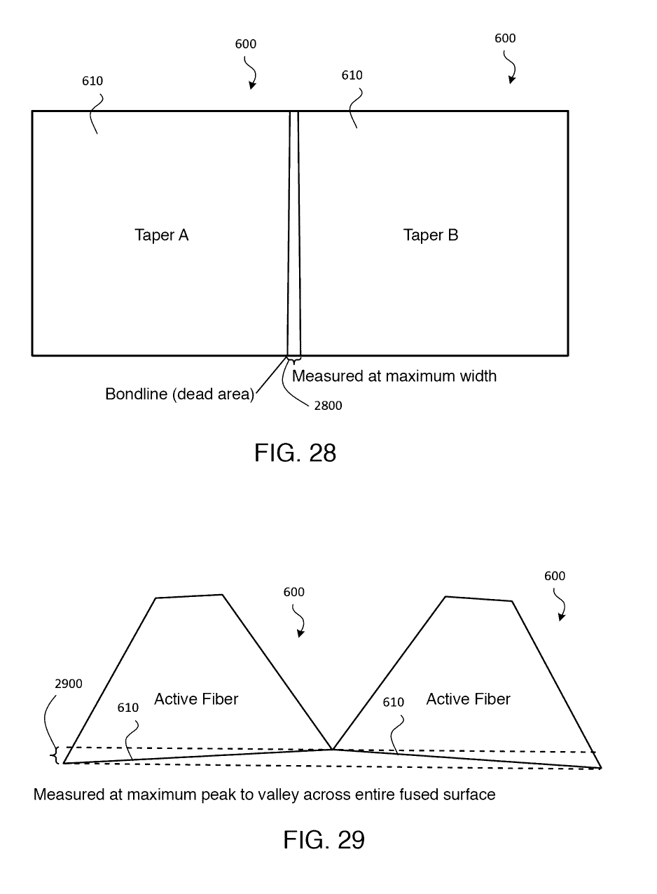

FIG. 28 is a front view depicting an example of bondline tolerances between the leading ends 610 of two exemplary fiber optic bundles 600 separated by a bondline 2800, according to one embodiment. The bondline 2800 may advantageously be as thin as possible to prevent seams from appearing in the final image. In at least one embodiment, the tolerance in the bondline 2800 is a maximum of 30 μm.

FIG. 29 is a top view depicting an exemplary technique for measurement of tolerance for image plane flatness between the leading ends 610 of two exemplary fiber optic bundles 600, according to one embodiment. The design specification in this embodiment may have the leading ends 610 coplanar; however, manufacturing limitations may cause the presence of a departure 2900 from coplanarity. In at least one embodiment, the tolerance for this departure 2900 is a maximum of 100 μm.

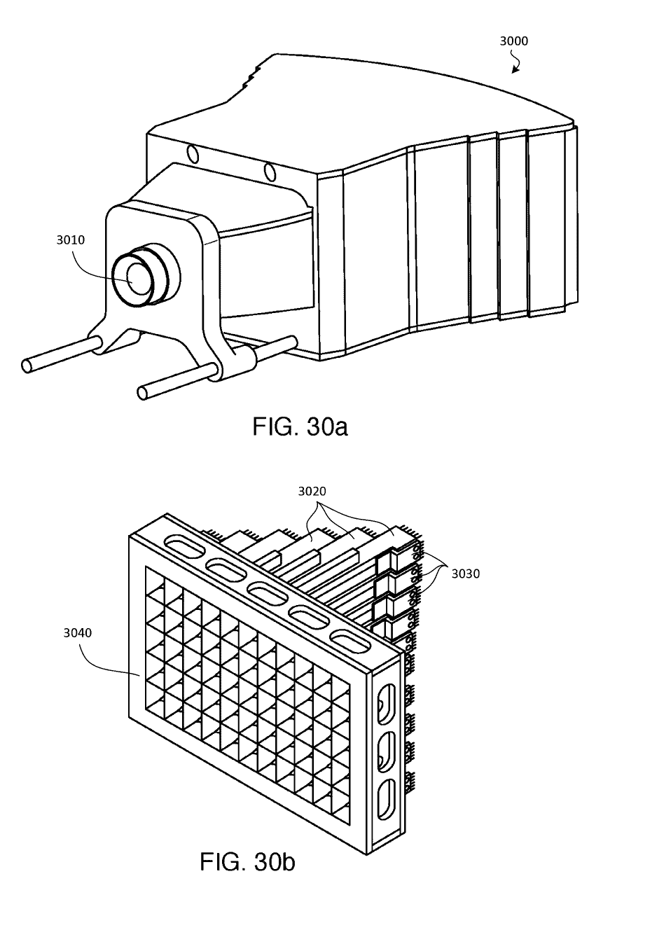

FIG. 30A is a perspective view depicting a camera 3000 using multiple modules 200 and fiber optic bundles 600 as described herein, according to one embodiment. The camera 3000 may have a main lens 3010 through which light is directed into the interior of the camera 3000 to the leading ends 610 of the fiber optic bundles 600 (not shown in FIG. 30A).

FIG. 30B is a perspective view depicting an example of an internal mechanical design of an array of fiber optic bundles 3020 and modules 3030, according to one embodiment. In this example, five face plate lengths are included. A grid 3040 may retain the leading ends (not shown) of the fiber optic bundles 3020.

With certain focal length and imaging plane dimensions, in at least one embodiment, the main lens may not require any internally moving parts for focus. Rather, the lens may move on a bellows system to provide accurate focus and a less complex, yet higher optical quality, lens design. Further, removal of the aperture blade requirements may have additional cost reduction benefits. The lens movement system may be motorized for additional efficiencies.

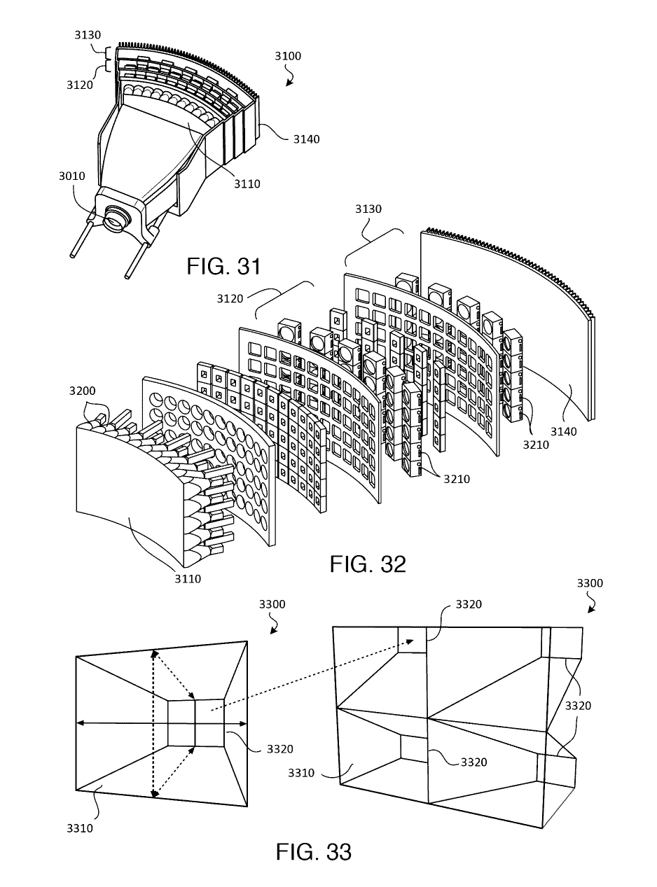

FIG. 31 is a perspective view depicting a camera 3100 according to one embodiment. The top panel of the enclosure of the camera 3100 has been removed to expose internal parts. A main lens 3010 may be similar to that of FIG. 30A. In this configuration, there is a cylindrically curved (step function) fiber image plane 3110, with two staggered image sensor layers 3120, 3130, with a heat sink 3140 on the rear.

FIG. 32 is an exploded view of a portion of the camera 3100 of FIG. 31. Many of the internal components of the camera 3100 are shown, including the fiber image plane 3110, which may be defined by the leading ends of the fiber optic bundles 3200. The fiber image plane 3110 is depicted as a cylindrical surface in this example, although it can be planar, spherical, and/or faceted. The fiber optic bundles 3200 may have fiber faceplates with two separate lengths to convey image data to the modules 3210 of the image sensor layers 3120, 3130. Mechanical design of the fiber optic bundles 3200, the fiber face plate, modules 3210, and module mounting systems is also shown for each of the image sensor layers 3120, 3130, along with the heat sink 3140. The depicted architecture is merely an example; many other variants can be constructed.

The heat sink 3140 may serve to cool the array. In at least one embodiment, further cooling of a dense array system may be provided, for example through the use of Peltier units (thermo-electric coolers) at each image sensor. Other approaches can be used, including for example alternative heat sinks, fans, liquid cooling systems, and/or the like.

A dense fiber array structure may provide the ability to scale the product design for any number of markets/products with the same components. For example, the architecture can be implemented in any suitable dimensions, such as a 2×5 array or a 200×500 array. Depending on the dimensions, certain components may be changed, such as the main lens and mechanical design to accommodate the larger system. The physical sensor parts can be stacked together in a manner similar to Lego blocks.

In at least one embodiment, each sensor in the system may be attached to the electronics with a socket such as a zero-insertion force (ZIF) connector, to provide simplified installation and maintenance of the system. In at least one embodiment, certain electronic components within the system can be mounted or tethered on flexible or flexi-rigid cable technologies (such as for PCI boards or other cables to/from servers/storage, and/or the like), and/or any other methodology that provides the ability to stack the electronics and/or mechanical requirements as deeply as desired.

In another implementation, where only four fiber optic bundles and image sensors are used, a single fiber optic bundle can be used that contains, at the demagnified (i.e., trailing) end, an image circle. The diameter can be the same as or larger than that of the image circle, or smaller in the case where pixel loss is acceptable. The image circle may be cut vertically into four equal segments, and then rotated individually along the y-axis to provide a seamless image plane at the magnified end, and four offset demagnified sensor planes with increased mechanical separation as depicted in FIG. 33.

FIG. 33 is a perspective view depicting the division of fiber optic bundle 3300 into four fiber optic bundles, according to one embodiment. The left-hand side depicts the fiber optic bundle 3300, which may have a leading end 3310 and a trailing end 3320. On the right-hand side, the fiber optic bundle 3300 is rotated along the y-axis and reconfigured for mechanical separation at the trailing end 3320. The arrow on the right-hand side points to a bonding point for an image sensor to the corresponding portion of the divided trailing end 3320. The image sensor and electronics can be bonded to the associated portions of the trailing end 3320. The leading end 3310 may remain undivided, providing a single planar imaging plane.

In this configuration, a single, larger, tapered fiber optic bundle may be divided into four (or more) equal sections. Those sections may then be used to mount the required modules, including packaging, with appropriate mechanical spacing. To allow for the required mechanical spacing, it may be advantageous not to put the four (or more) segments back together in the same fashion as originally produced prior to the cut. Each segment may have its own distinct shape, and may include a specific inward angle. For example, in the depicted example, the top-right quadrant may minimize inward scaling by the magnification factor into the center of the trailing end 3320. If this quadrant taper is turned up-side-down and repositioned in the location of the top-left quadrant, the resulting trailing end may then be positioned at the furthest location away from the center of the original fiber optic bundle 3300, not positioned at the top left of the large end of the segment, as shown in FIG. 33. If this is performed for all of the segments respectively, the resulting shape may provide a seamless imaging plane at the leading end 3310 and simultaneously provide the maximum mechanical spacing for the packaging of the image sensors through the production and division of a single tapered fiber optic bundle.

Such a design may provide significant cost reductions for the tapered fiber optic bundle manufacturing process. Production of only a single fiber optic bundle (in an embodiment that only requires four image sensors) may be less expensive than the production of four separate fiber optic bundles. In other embodiments, the configuration described above can be leveraged in configurations with multiple fiber optic bundles to provide light to more than four image sensors. This may facilitate the implementation of higher resolution and/or custom configurations.

In the above-described embodiments, it is assumed that the fiber optic bundles are cut and polished at angles that are viable for the mechanical design, including cubed edges at the image plane (at the leading end) as well as the sensor (minimized) end, so as to ensure that fiber optic bundles can be bonded together with sufficient surface area. In an alternative embodiment, the system can be implemented using a mechanical design that eliminates the bonding process. In at least one embodiment, the shape of the fiber optic bundle is made broad enough to cover an installation or process for optical image plane stitching.

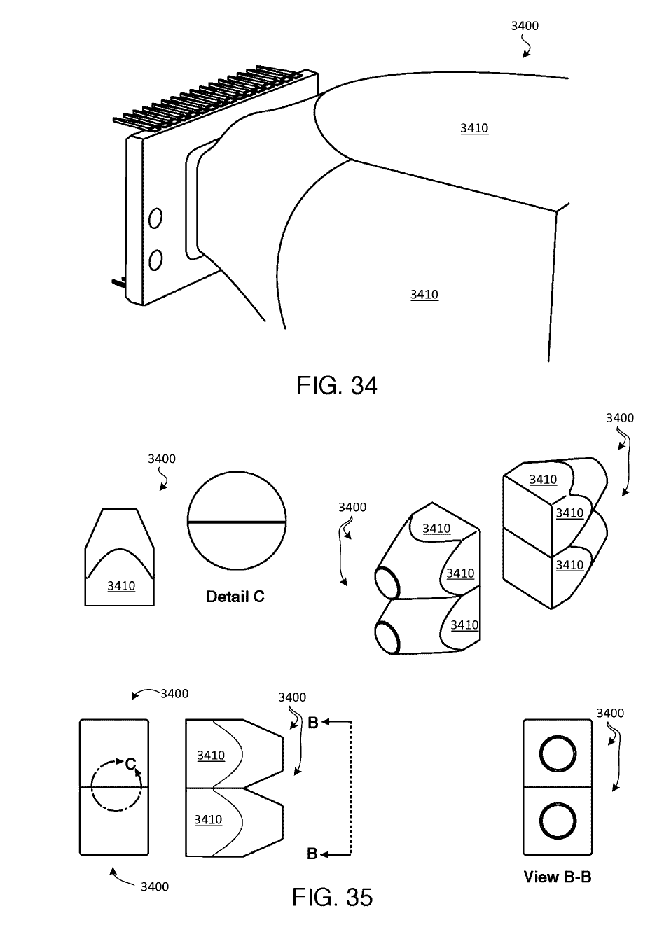

FIG. 34 is a perspective view depicting an example of a tapered fiber optic bundle 3400 with cut and polished edges 3410, according to one embodiment. When multiple tapered fiber optic bundles are bonded together, the polished edges 3410 may provide the surfaces required for the bonding process.

FIG. 35 is a series of views depicting two of the tapered fiber optic bundles 3400 of FIG. 34, arranged in a 2×1 array, according to one embodiment. The polished edges 3410 of adjoining tapered fiber optic bundles 3400 may be secured together.

### Advantages

Use of the tapered fiber optic bundles described herein may have many advantages. These advantages may include more flexibility and compactness in system geometry, which may result in greatly increased accuracy of depth estimation from a computational imaging standpoint. Further, obtaining high optical quality and/or a high F-number may be accomplished at a comparatively smaller cost.

For example, a system leveraging a 35 mm optical format can have an F/2 lens and a 50 mm focal length. This system may provide, assuming 1 GP resolution requirements, about a 0.9 μm pixel pitch and a 25 mm entrance pupil (EP). Increased entrance pupil size provides increased parallax, and therefore (generally speaking) more accuracy for all aspects of depth computation, motion/vector tracking, and computational imaging.

In general, a 0.9 μm pixel pitch and 25 mm EP is a very challenging design, requiring greater than state-of-the-art optical design in order to achieve 550 pixels/mm, not to mention the increased QE of small pixel design (due to less physical area for photon collection), decreased photons available at video rates per pixel (due to potentially less integration time), scatter of wavelengths of light in silicon (particularly red, about a 7.6 μm diffusion potential) and diffraction limitations (due to the airy disc as determined by the lens parameters and resulting pixel size requirements), all resulting in significant reduced image quality for a light-field imaging system, as well as for any standard 2D imaging system.

For the above-described 0.9 μm pixel system, the diffraction limitations would suggest a lens of less than F/0.5 design to help avoid diffraction limitations, although the color diffusion in silicon may continue to exist and other aberrations or distortions may occur due to such a challenging lens design. Using conventional techniques, designing such a lens with high quality imaging is extremely challenging, if not impossible. For example, if a 100 mm focal length is desired with an F/0.5 design, the theoretical entrance pupil required may exceed 400 mm, which is an extraordinarily large optical apparatus with huge potential cost, size, and weight implications, and a significant mechanical challenge.

The approach described herein may address such limitations of existing systems. One may leverage existing pixels used for existing professional applications (e.g. 5.5 μm) with a 3:1 magnification fiber taper ratio to allow for electronics/mechanical design, resulting in an approximate 16.5 μm virtual pixel. This pixel size may provide a significantly increased photon collection area (even in exchange for the transmission loss through the fiber bundles), with nearly 0 pixels of color diffusion. Further, this pixel size may be well below diffraction limitations, even at larger F-numbers (i.e., smaller apertures).

Using the techniques described herein, a system may be designed with an imaging plane greater than about 600 mm in width, as opposed to a 35 mm wide imaging plane as mentioned above, to result in the same pixel resolution, with a lens producing an equivalent field of view (FOV) as a standard 50 mm lens (approximately a 900 mm lens) with an F/9. The result may be a 100 mm entrance pupil with a readily available optical design. The imaging qualities of such a system are vastly superior to conventional designs.

In another embodiment, geared at the same increase in system geometry but requiring an increase in system transmission and/or where mechanical enclosure requirements are potentially larger, the system can be implemented in a manner wherein the main lens projects an image onto the MLA (micro lens array), followed by a single or tiled fiber faceplate (or other transmissive surface). This may result in a viewed image at the rear of the fiber face plate, with high transmission as the fiber elements have very high efficiency when used as a relay alone. The image may appear similar to viewing an image on ground glass, yet may retain higher overall MTF/image quality.

In at least one embodiment, behind this arrangement, N/resolution cameras can be arranged in an array to re-photograph the image as projected onto the fiber face plate surface. Each sensor may use a focal length that is matched across the array and to the corresponding FOV of required coverage. Some overlap may be desirable as well. The lenses may have extremely wide F numbers (such as 0.5, for example), as the total range of depth-of field (DOF) to be captured per lens is very shallow. However, the overall FOV acquired through the computational system may be extremely wide. One advantage to this approach may be simplified system design.

Use of a non-planar surface for imaging, as described above, may help to reduce the effects of aberrations in the main lens of a camera. Known methods often utilize software correction efforts and/or extensive calibration routines to correct for lens aberration. Such aberration effects may not be as apparent in the image derived from a non-planar surface such as a cylindrical or spherical surface, as described herein.

### Alternative Sensors and Transmissive Surfaces

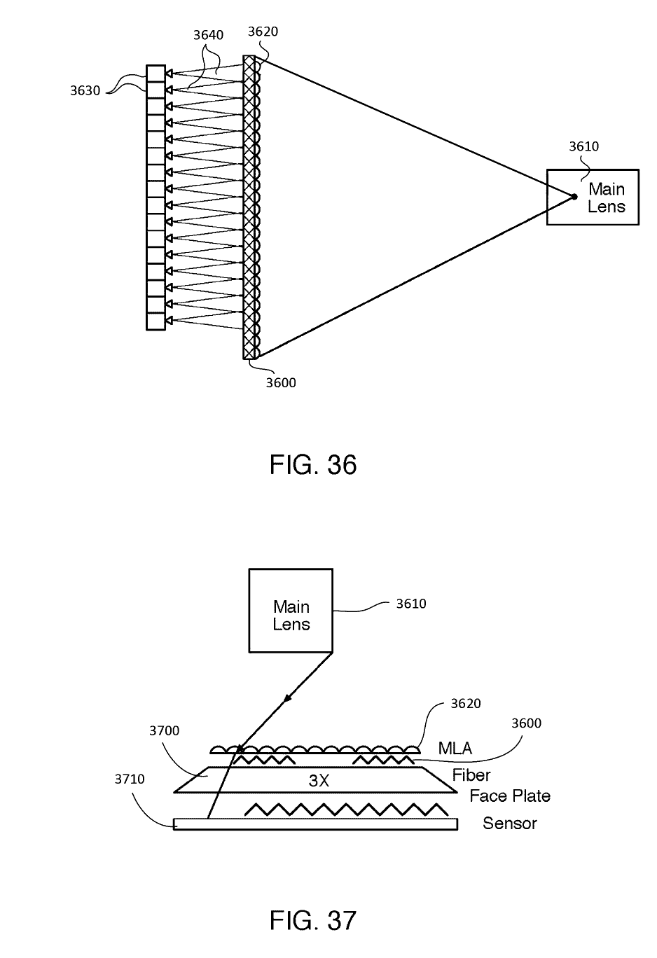

FIG. 36 is a side view depicting an example of an alternative structure utilizing a transmissive surface 3600 as described above, according to one embodiment. A main lens 3610 may transmit images onto the microlens array, or MLA 3620, followed by the transmissive surface 3600. The transmissive surface 3600 may be a fiber face plate, ground glass, or the like. The image may be re-imaged by a series of image sensors, or modules 3630, and lenses with or without overlapping fields of view. The image may be conveyed from the transmissive surface 3600 to the modules 3630 by tapered fiber optic bundles 3640.

In at least one embodiment, between the MLA 3620 and the tapered fiber optic bundles 3640 and/or face plate, an additional fiber plate may be interjected to further diffuse the transmission of light and provide increased angular sensitivity or altered directionality to the modules 3630. With a demagnification of the image plane to the modules 3630 (such as an arrangement wherein the plane behind the MLA 3620 is at 1×, and the sensor side is 3× magnified), the angles of exit may be ⅓ the angles of entry, which may produce increased sensitivity for the modules 3630, and provide the ability to use extremely large apertures (e.g. F/0.5 on a <APS-C system) without decreased sensitivity at the high incident angles of entry. Such an approach can applied in many different architectures and applications, not limited to light-field capture, such as for example traditional capture as well as projection technologies.

FIG. 37 is a top view depicting an example of inclusion of a tapered fiber optic bundle 3700 that magnifies light to the imaging sensor, according to one embodiment. Such magnification may reduce the angles of exit from the MLA 3620 to the image sensor, or module 3710 (or in the alternative, modules), according to one embodiment.

In at least one embodiment, the module 3710 may be replaced with one or more scanline sensors for non-moving or other forms of imagery. Scanline sensors, including flatbed scanners, are commercially available and may be used behind the main lens 3610 and MLA 3620, with or without the fiber bundle technologies and/or with or without the beam splitting technologies described herein. For volume capture applications, the use of the scanline illumination system may be left active if desired.

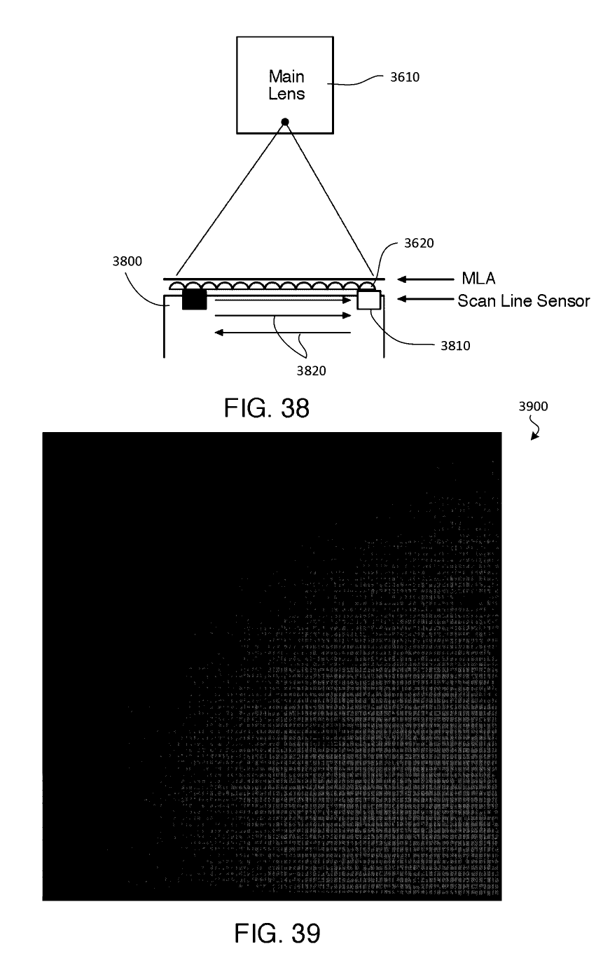

FIG. 38 is a top view depicting exemplary use of a scanline imager 3800 imaging the entire area according to one embodiment. The scanline imager 3800 may be of any known type, and may be used in conjunction with other components described previously, including but not limited to the main lens 3610 and MLA 3620. As shown in FIG. 38, the scanline imager 3800 may have a scanline sensor 3810, which may move along a linear pathway indicated by the arrows 3820.

In at least one embodiment, global shutters can be used. Alternatively, mechanical shutters plus a rolling shutter may be used. As yet another alternative, rolling shutters can be used alone.

### System Calibration

In at least one embodiment, each sensor and microlens is carefully calibrated and aligned, so as to ensure high quality imaging and reconstruction of the light-field. In at least one embodiment, the process to perform such calibration includes, in no particular order, two-dimensional calibration steps/processes as well as light-field calibration.

Such calibrations can be performed in hardware/manufacturing or in software, or in any combination thereof. In at least one embodiment, calibration is performed in hardware as close to the ideal specifications as possible, and further corrections are made in software as needed. In some environments, a combination of hardware and software calibration processes can be used. In further refinement of the technology into mass-production markets, the software calibration process can, in some cases, be a higher percentage of the calibration process due to more lax tolerances for lower price point markets.

Two-dimensional calibrations may include, but are not limited to, standard image sensor optimization and calibration. This may include, but is not limited to, hot spot removal, dead pixel removal, ADC optimizations, dark time/noise calibration, and/or the like. Array calibrations may include, but are not limited to, standardization of all image sensors in the array to an ideal state. Additionally or alternatively, image sensors may be adjusted to match an average or single image sensor within the array to ensure continuity and consistency between each of the imaging elements. Light-field calibrations may include, for example, alignment of each microlens and the standardization of the pixels captured within the light-field, as well as computational adjustments for lens distortion, vignetting, and/or other aberrations produced within the optical system.

In some cases, use of fiber optic technologies can produce additional static noise artifacts that can be described as fixed noise patterns, “chicken wire” artifacts, seam gap distortions, and/or other artifacts arising from use of the fiber optic bundles. Other calibrations can be performed to alleviate these artifacts, including but not limited to static fiber noise removal and seam gap removal.

In at least one embodiment, within the current tolerances provided in the image plane reconstruction, given the large magnified pixel structures, the seam gap accounts for approximately one pixel per image sensor. A gap of this magnitude may easily be accounted for within light-field image reconstruction so that the resulting image does not display any visible seams.

FIG. 39 is a front view depicting an example 3900 of 10% tolerance on an imaging sensor, plus pre-distortion correction from a fiber taper, according to one embodiment. The black pixels represent the area where no light is present due to the alignment of the active fiber surface. In at least one embodiment, the system achieves 1% tolerance of lost pixels, although the exact tolerances are determined by the calibration and alignment process.

### MLA Considerations and Design

In at least one embodiment, the MLA (micro lens array) is directly mounted (with appropriate spacing, focal length (FL), and/or the like) to the leading end of each fiber optic bundle. In various embodiments, the MLA may be front-facing with thick glass/substrate bonded directly to the fiber surface or with an included air-gap, or rear-facing (lenslets facing the fiber vs. facing the lens) with an air gap and manufactured onto a substrate for structure.

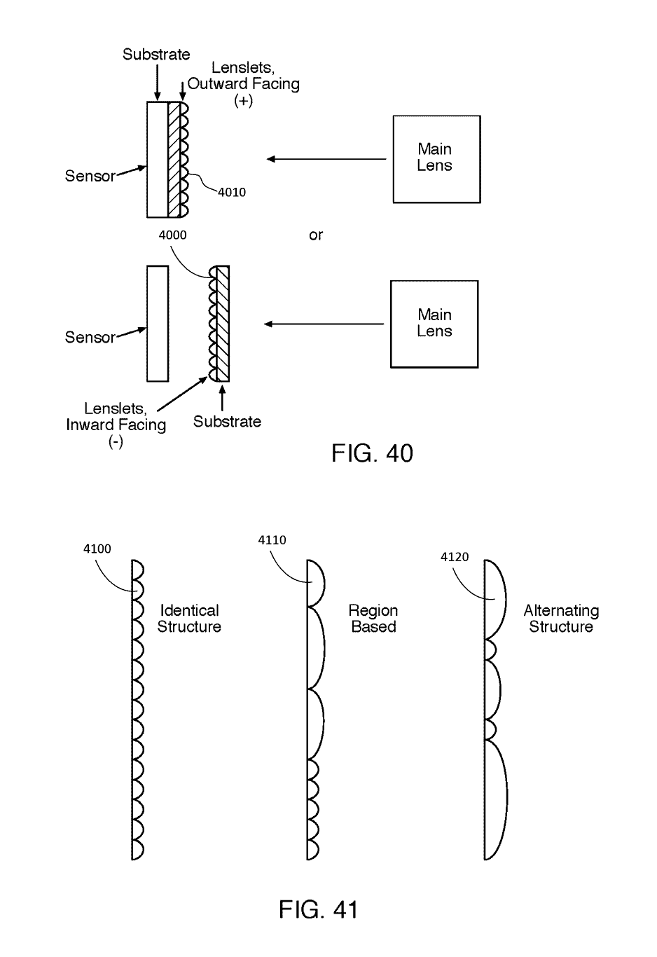

FIG. 40 depicts examples of inward and outward facing MLA's 4000 and 4010, respectively, according to certain embodiments. In various embodiments, the MLA may be an identical structure throughout the array, or may vary in focal length per lenslet or per region.

FIG. 41 is a series of side views depicting examples of different configurations of the microlens array, according to certain embodiments. These configurations may include one in which the MLA 4100 is an identical structure, one in which the MLA 4110 varies by region, and one in which the MLA 4120 varies in an alternating or random fashion. In at least one embodiment, the MLA may be constructed in such a way that every lenslet has separate parameters in order to optimize the imaging capability of the system.

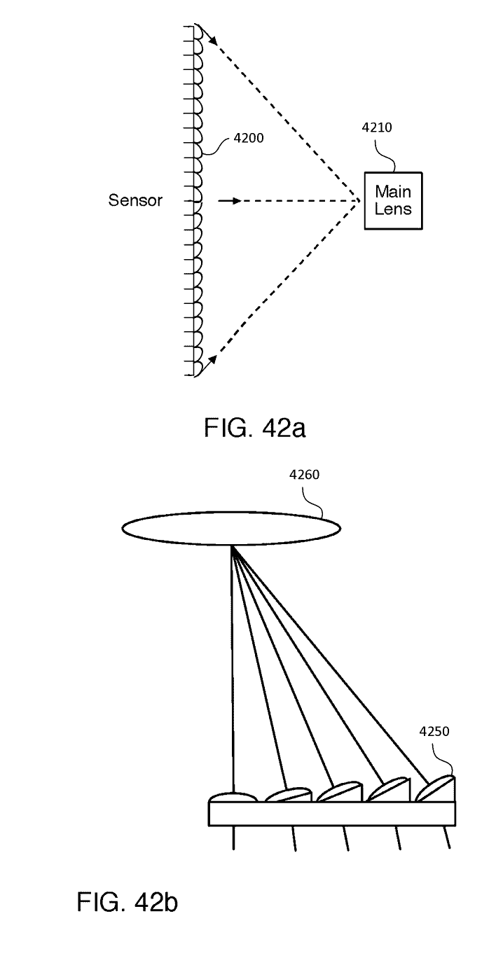

FIG. 42A is a side view depicting an example in which the MLA 4200 has tilted structures angled towards the optical center of the main lens 4210 across the entire imaging area, according to one embodiment. If desired, the microlenses of the MLA 4200 may have variable tilt so that each microlens is oriented toward the optical center.

FIG. 42B is a side view depicting an example of an optimized MLA 4250 for a large chief ray angle (CFA) with tilted lenslets, according to one embodiment. The lenslets may be tilted such that each lenslet is oriented generally toward the optical center of the main lens 4260.

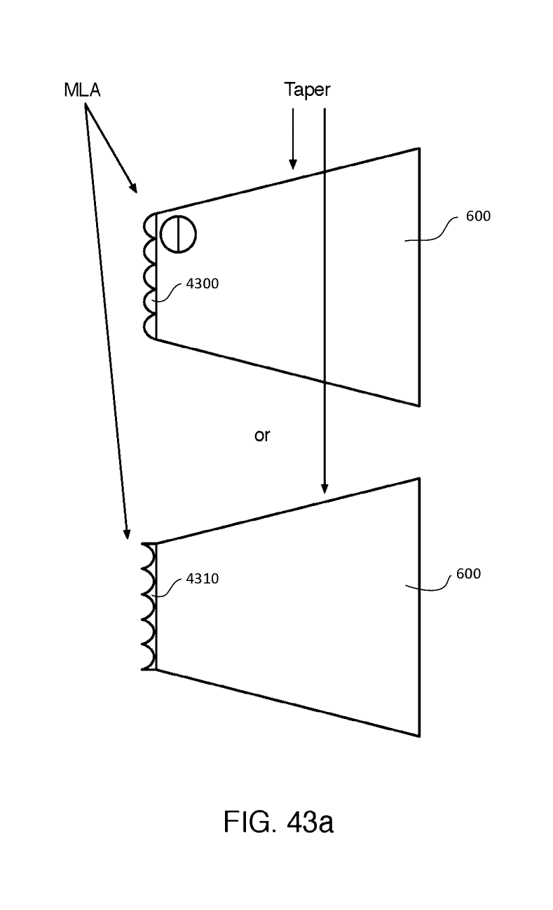

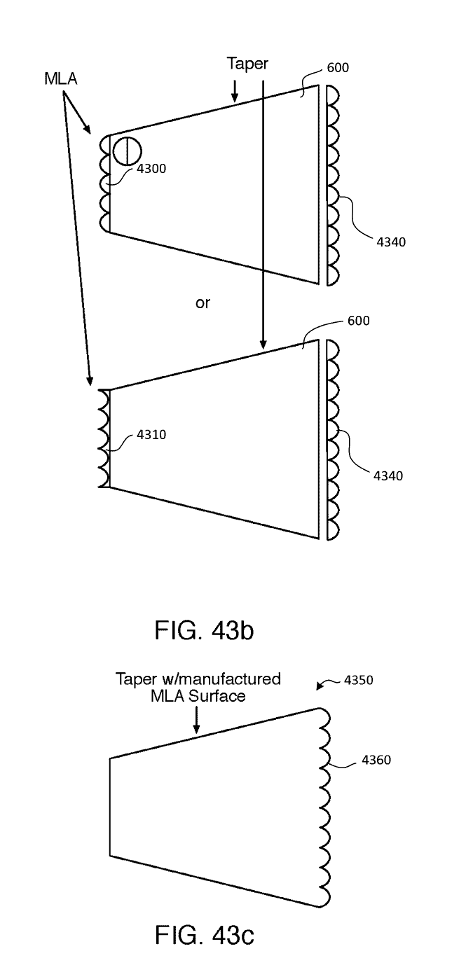

In at least one embodiment, the MLA may be constructed at the demagnified (i.e., trailing) end of the fiber optic bundles to help compensate for the increased exit angles. An example is shown in FIG. 43A.

FIG. 43A is a side view depicting MLA structures 4300, 4310 secured to the trailing ends of fiber optic bundles 600, according to certain embodiments. The MLA structure 4300 provides convex microlenses, while the MLA structure 4310 provides convex microlenses.

In at least one embodiment, MLA structures (and/or other optical structures) may be used at both the entrance and exit of the tapered fiber optic bundle, with or without air gaps, and with or without manufacturing the MLA's on a substrate. An example is shown in FIG. 43B.

FIG. 43B is a side view depicting the MLA structures 4300, 4310 of FIG. 43A secured to the trailing ends, and an MLA structure 4340 secured to the leading ends, of the of fiber optic bundles 600 and MLA, according to certain embodiments. An air gap may or may not be present between the fiber optic bundle 600 and the MLA structure 4300, the MLA structure 4310, or the MLA structure 4340.

In at least one embodiment, the MLA structure(s) may be manufactured into the surface of the fiber optic materials directly, with or without additional optics, and with or without a tapered design. An example is shown in FIG. 43C.

FIG. 43C is a side view depicting a fiber optic bundle 4350 with an integrated MLA 4360, according to one embodiment. The MLA 4360 may be formed into the leading end of the fiber optic bundle 4350. Additionally or alternatively, an MLA (not shown) may be formed into the trailing end of the fiber optic bundle 4350.

In at least one embodiment, the MLA design may be multi-layered in order to provide more optimized structure for imaging. Such an approach may be used independently, or in combination with any of the other approaches.

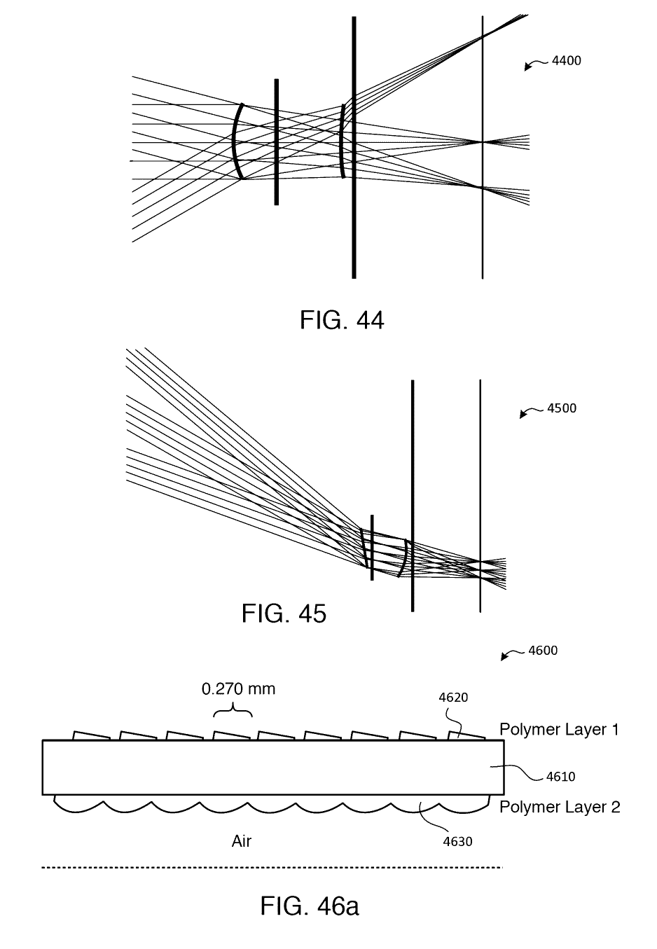

FIGS. 44 and 45 are side views depicting examples 4400, 4500, respectively, of a dual-layered MLA configuration, according to certain embodiments. A dual-layered MLA configuration may be used to increase off-axis performance and provide good collimation with a dual substrate approach (such as glass and polymer).

In some embodiments, the leading ends of fiber optic bundles may be combined to form a very wide fiber optic plane, for example, having a width of 10 cm, or even 1 m or larger. A microlens array may be secured to or formed on the leading ends. A set of cameras may be positioned to receive image data from the fiber optic bundles to image based on the resolution of the microlenses and the image sensor itself. A wide variety of alternative configurations may alternatively be used, as follows.

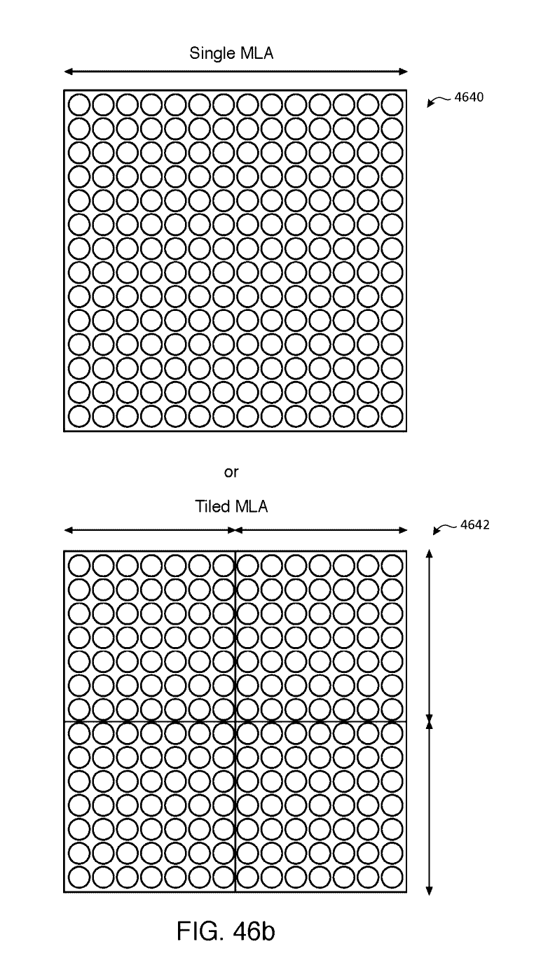

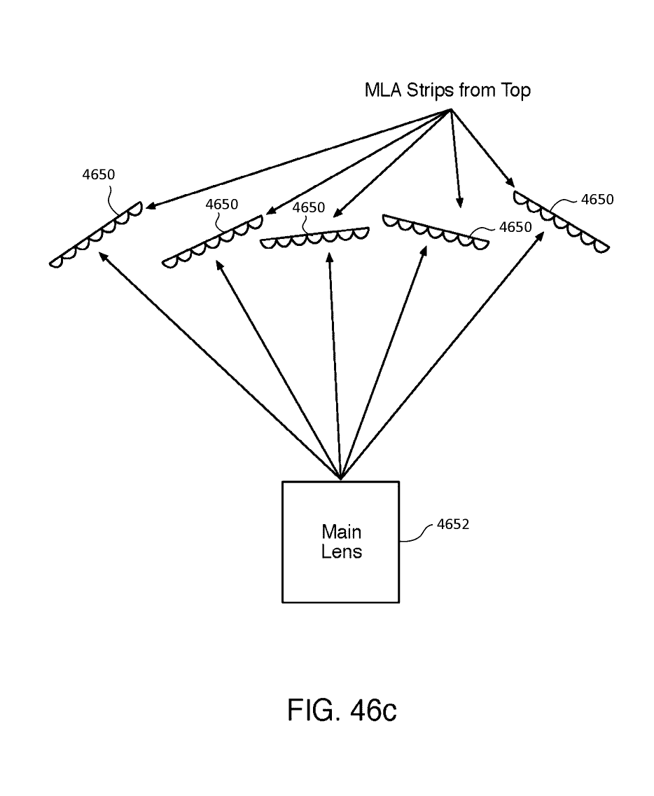

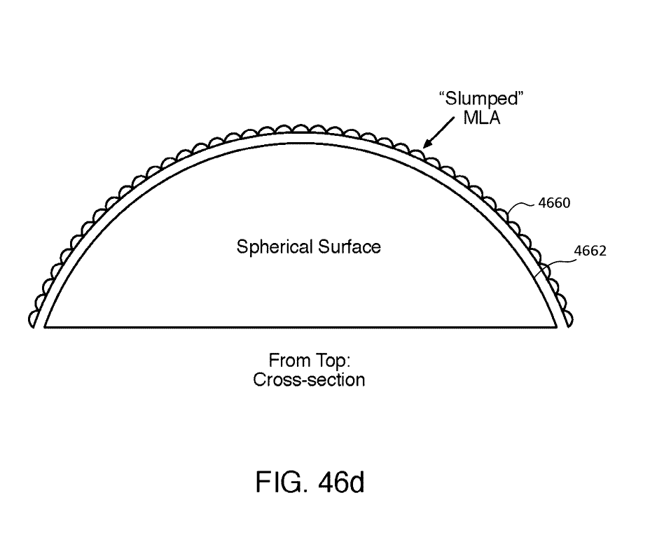

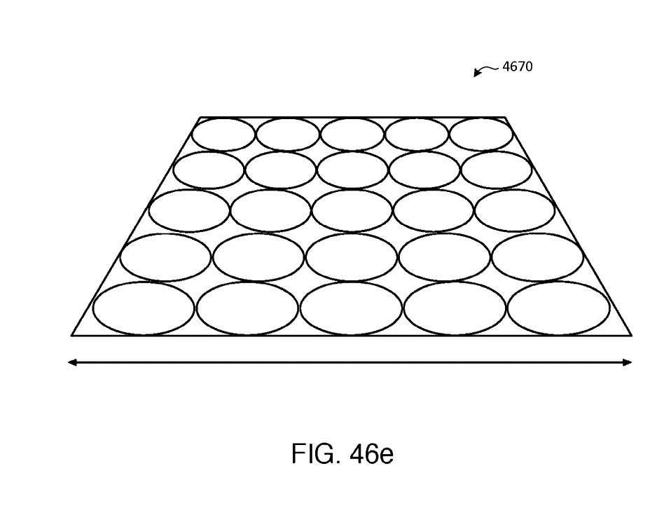

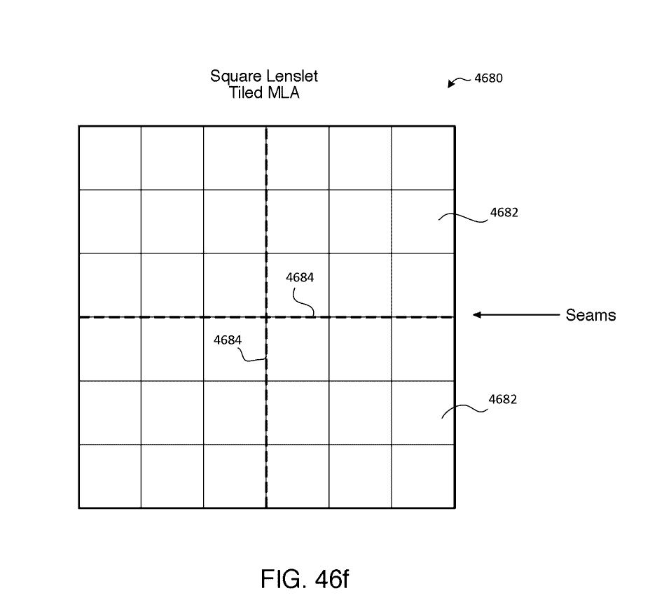

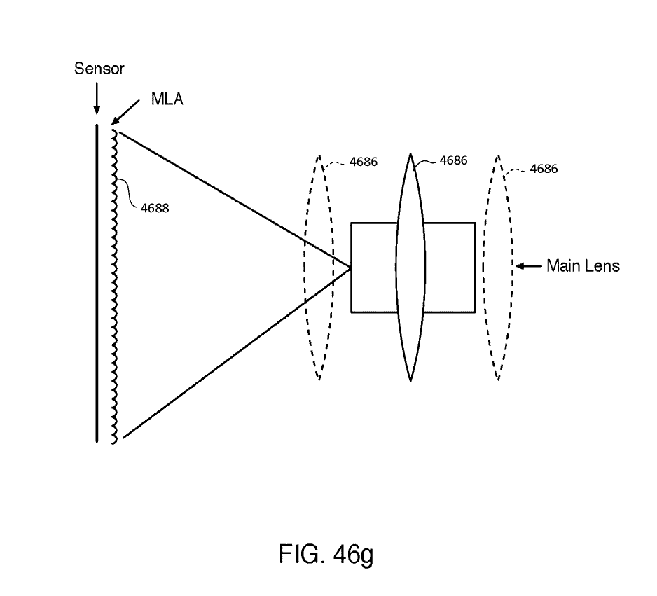

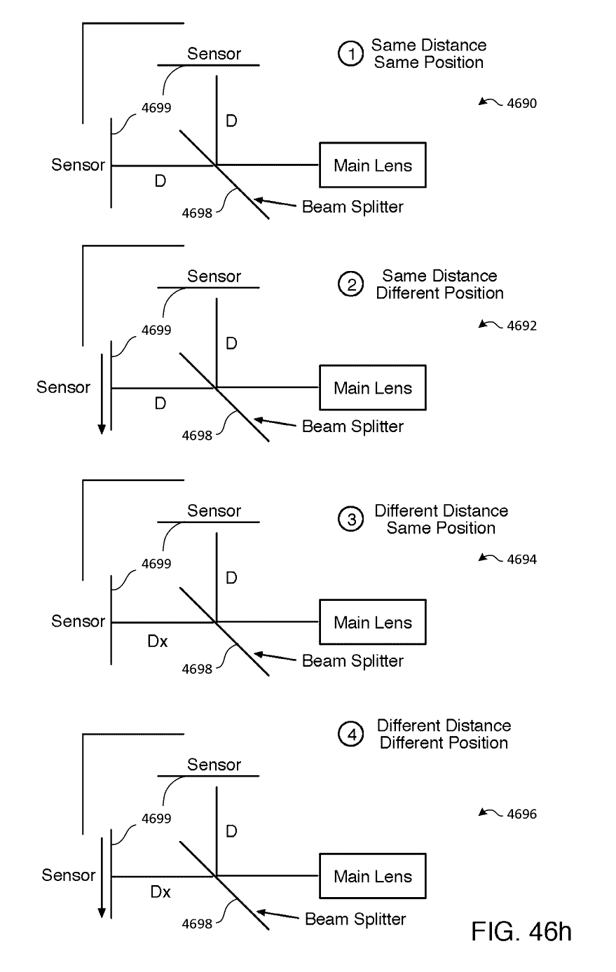

FIG. 46A is a side view depicting an example 4600 of a dual-layered MLA that can be used to increase off-axis performance using two polymer layers and one glass surface 4610, according to one embodiment. MLA's 4620 and 4630 may be formed in the polymer layers on either side of the glass surface 4610. In various embodiments, the MLA may be a single sheet, or tiled in a planar array.

FIG. 46B is a top-down view depicting an MLA 4640 as a single sheet and an MLA 4642 as a tiled, planar array, according to certain embodiments. The MLA 4642 has four components, but may have more or fewer in other embodiments. If desired, each component of the MLA 4642 may consist of only a single microlens.

In at least one embodiment, if a beam splitter or other optically splitting element is used, the MLA may be provided in strips, with the active imaging area being aligned to either over-scan the lens/scene or lined with precision to avoid overlap. See, for example, FIGS. 15 and 18. In at least one embodiment, these strips in this configuration may be angled to optimize the transmission of light for a specified optical system. FIG. 46C depicts an example.

FIG. 46C is a top view depicting a plurality of MLA strips 4650 positioned at various orientations to face a main lens 4652, according to one embodiment. The MLA strips 4650 may be secured to fiber optic bundles and/or other components.

In at least one embodiment wherein a spherical or cylindrical surface is used, the MLA may be “slumped” to map to this exact shape, or may be manufactured directly in this form. FIG. 46D depicts an example.

FIG. 46D is a top view depicting a spherical MLA 4660 mapped to a spherical surface 4662, according to one embodiment. The MLA 4660 may be manufactured in a spherical form, or may be manufactured in planar form or in a different shape, and subsequently processed to provide the curvature of FIG. 46D. For a spherical surface, the MLA can be distorted such that the XY dimensions, when imaged, retain a rectilinear pixel structure (as the taper is trapezoidal). FIG. 46E depicts an example.

FIG. 46E is a perspective view depicting an MLA 4670 that has been formed in a trapezoidal shape, according to one embodiment. The trapezoidal shape may help provide a rectilinear pixel structure when mapped to a spherical surface.

In at least one embodiment wherein tiles are used for the MLA, square lenslets may be used to provide higher seaming accuracy. This may allow the lenslets to be tiled together. FIG. 46F depicts an example.

FIG. 46F is a top-down view depicting an MLA 4680 with square lenslets 4682, according to one embodiment. The square lenslets 4682 may be tiled together at seams 4684.

In another embodiment, an MLA can be created with a high-speed mechanical translation stage to provide alignment, or time-sequential focus sweeps during capture. In yet another embodiment, a variable lens structure can be created via liquid lenses, birefringent materials, polarized optics, and/or the like, so as to provide the ability to electronically vary focal length in a time-sequential method, or for alignment purposes. FIG. 46G depicts an example.

FIG. 46G is a side view depicting an example of a main lens 4686 that is movable relative to an MLA 4688, according to one embodiment. In addition or in the alternative, the MLA 4688 may translate relative to the main lens 4686. Motion of the main lens 4686 may additionally or alternatively be replaced with other mechanisms for altering main lens optics, such as liquid lenses, birefringent materials, polarized optics, and/or the like.

In another embodiment, multiple optical paths, which may include beam splitters, prisms, etc., are provided behind the main lens in order to generate multiple imaging planes that may be configured at identical focal distances from the main lens for the purposes of noise reduction. Alternatively or additionally, identical focal distances can be used with an XY sub-pixel offset for the purposes of noise reduction and super resolution. Alternatively or additionally, varied focus distances can be used so as to increase the refocusable range and decrease the “zero lambda” refocus issue. Any combination of the above-described strategies can be used, as depicted for example in FIG. 46H.

FIG. 46H includes a series of side views of examples 4690, 4692, 4694, and 4696 depicting various ways in which a beam splitter 4698 may be used to divide incoming light between image sensors 4699, according to one embodiment. The image sensors 4699 may be offset relative to each other, toward or away from the beam splitter 4698 and/or in a direction perpendicular to that of the approaching light, as shown.

### Main Lens

In at least one embodiment, the main lens of the system is able to generate an image circle at or greater than the maximum dimensions of the image plane diameter. This lens may be fixed, or combined with a focus modification system including liquid lenses, birefringent materials, polarized optics, and/or the like, to provide the ability to electronically and/or mechanically vary focal length in a time-sequential manner (or for alignment purposes). By capturing light-field “focus sweeps” in a time-sequential manner, one is free to reconstruct the light-field with drastically increased refocusable range.

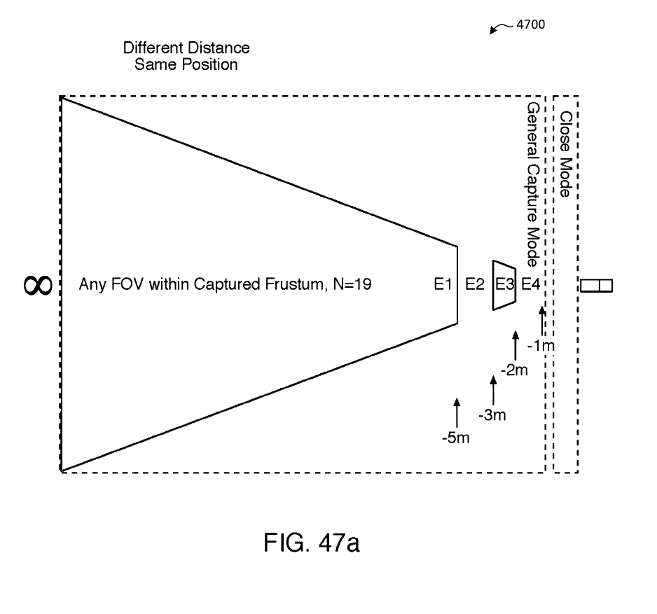

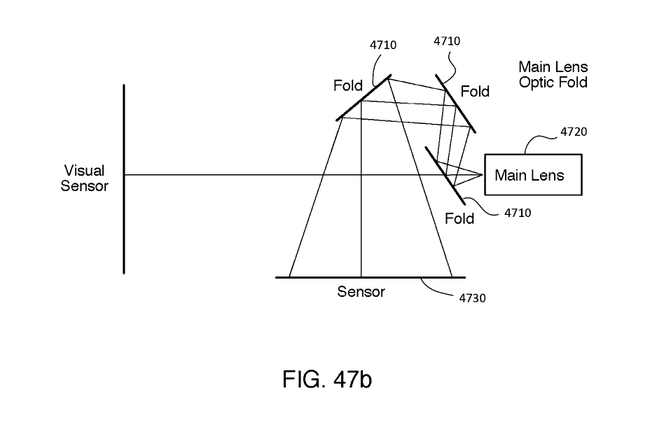

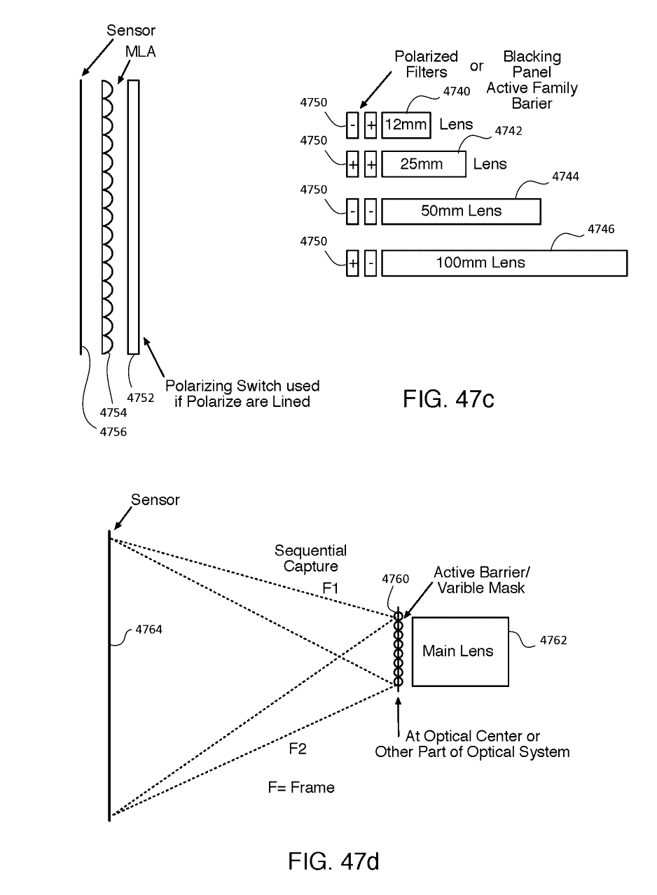

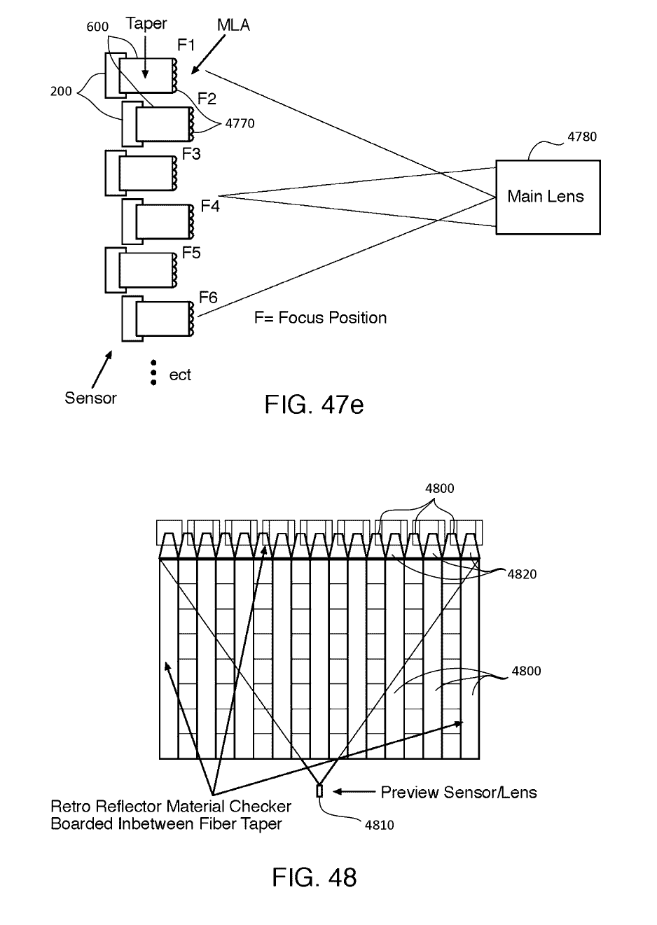

FIG. 47A is a side view depicting an example 4700 of refocusable ranges with a sequential exposure system as the distances decrease to camera with exponentially decreasing range, according to one embodiment. Through computational processing, it is possible to reconstruct the desired focus plane with increased range of depth-of-field. The depicted example shows an architecture in which four exposures are considered; in other embodiments, any number of exposures can be considered.

In consideration of a desired 24 frame-per-second (FPS) output after computational processing, a repeating 5× exposure system may be ideal to produce 120 FPS capture, which may allow for reconstruction of 24, 30, 48 and 60 FPS playback. This additionally may provide the ability to generate synthetic shutter reconstruction, motion blur reconstruction, and/or increased depth estimation accuracy as well as increased motion vector accuracy to benefit the entire computational imaging ecosystem, at the expense of increased data rates. The FPS for actual capture may vary depending on application and may exceed 360 FPS for as long as any desired single exposure requires.

Data may be acquired at any bit depth and/or color space. In at least one embodiment, data is acquired at 10 bits at these higher frame rates and may be converted to log color space to increase color accuracy at these lower bit depths. Other implementations can provide 16 bit log or linear capture capabilities.

In at least one embodiment, any suitable additional technologies can be used to perform the functions described. Such additional technologies may include, but are not limited to: liquid lenses, birefringent and polarization technologies, acoustic/standing wave optical technologies, mechanical methods (such as moving the lens at high speeds), and/or any other technology that provides the ability to refocus the main lens, or refocus the MLA in any fashion to sequentially capture multiple focus positions to generate light-field acquisition.

In at least one embodiment, the system can also provide square wave control. In this manner, an interval can be provided between frames that is less than a predetermined threshold time value, with minimal or no variation in between the switching time to provide the highest quality exposure per frame.

In at least one embodiment, one or more optical folds can be added to the main lens/optical system in order to reduce the overall footprint of the imaging system. FIG. 47B depicts an example.

FIG. 47B is a side view depicting the use of optical folds 4710, according to one embodiment. The optical pathway between the main lens 4720 and the image sensor 4730 may thus be compacted to reduce the footprint of the camera in which it is implemented.

In at least one embodiment, a camera may include multiple main lenses with varied focal lengths (static, variable, and/or electronically switching) with polarization techniques used in the image sensors and within the lens design to temporally allow for sequential switching between multiple focal lengths and perspectives. The image sensors, depending on polarization state, may only see a certain lens (or different lens simultaneously depending on the polarization state of a particular image sensor or region of the imaging plane), resulting in the sequential capture of light-field data from the lenses. Polarization states may be switched electronically, or may be a static pattern. Alternatively, active barriers and/or variable masks may be implemented with or without polarization or other mechanical means, in order to selectively block light from lenses. FIG. 47C depicts an example.

FIG. 47C is a side view depicting an example in which a plurality of main lenses 4740, 4742, 4744, and 4746 are used in conjunction with polarized filters 4750, according to one embodiment. Each of the polarized filters 4750 may have a distinct polarization setting. A polarizing switch 4752 may be positioned between the MLA 4754 and the image sensor 4756. The polarizing switch 4752 may optionally be set to align with the polarity of any of the polarized filters 4750 in order to determine which of the main lenses 4740, 4742, 4744, and 4746 is able to convey light through the MLA 4754 to the image sensor 4756.

In alternative embodiments, steps may be taken to remove the MLA, modify the MLA, combine the MLA design with that of another component, or completely remove the MLA at the sensor plane. For example, the MLA may be replaced with a sequential capture apparatus. Alternatively, the MLA may be combined with a variable mask at the aperture stop, optical center, or some other location within the optical system. The effective aperture size can be set at the equivalent of the main lens F/number×the desired N number. The apparatus can be configured to electrically switch in position around the aperture and record image data sequentially on the image sensor. At high speeds, such an approach can be virtually seamless. In at least one embodiment, such an approach can be combined with a larger MLA and/or lower individual exposure resolution in exchange for temporal resolution as compared with a single image captured only per switching state within the aperture. FIG. 47D depicts an example.

FIG. 47D is a side view depicting the use of an active barrier/variable mask 4760 to provide sequential capture of image data, according to one embodiment. The active barrier/variable mask 4760 may be positioned in the optical pathway between the main lens 4762 and the image sensor 4764.

In at least one embodiment, a method is implemented to allow the imaging plane tiles to exist at different distances from the main lens to produce interwoven varied focal lengths/focus positions within a single image. FIG. 47E depicts an example.

FIG. 47E is a side view depicting the use of modules 200, tapered fiber optic bundles 600, and MLA's 4770 positioned at variable displacements from a main lens 4780, according to one embodiment. The result may be the presence of multiple focal lengths and/or focus positions within a single captured image.

In at least one embodiment, a method is implemented to embed multiple focal lengths optically into a single lens and mask off regions to capture sequential or simultaneous multiple focus/focal length positions for the purposes of light-field imaging. Again, the captured image may have multiple focal lengths and/or focus positions.

### Advantages

The systems and methods described herein may provide a number of advantages over known camera designs for conventional and/or light-field imaging. These advantages may include, but are not limited to:
High dynamic range;
Wide gamut;
Shutter reconstruction;
Motion blur reconstruction;
Automated 3D camera tracking; and/or
Post-capture optical stabilization.

In at least one embodiment, the system provides extremely high frame rates (such as 120 frames per second or more), so as to minimize total motion blur. This may result in increased accuracy for depth and motion blur analysis.

In at least one embodiment, the system uses light-field computation so as to provide an approximate effective aperture size of N (diameter of pixels behind each lenslet)×main lens F/number, resulting in extremely wide DOF. This can reduce or eliminate focal blur in the image for computational processing.

The addition of the high frame rate information in combination with the light-field array of information and wide depth of field may provide significant benefits. These benefits may include significantly increased accuracy for all motion vectors, photogrammetry, depth analysis, and numerous other computational processes.

In at least one embodiment, the system is implemented as a post-capture process performed on light-field imaging data, which may only include 2D capture at high frame rates. Such a process may be performed as follows, for example:
Compute wide depth of field image from light-field capture;
Compute multiple perspectives/rays of information from within the main lens exit pupil;
Compute disparity/depth vector triangulated correlations (spatial analysis, which may include additional temporal frames compared with motion vectors for statistical accuracy calculations);
Compute motion vector tracked correlations (temporal analysis, which may include two or more frames);
Analyze image; and
Average error from all calculated vectors and statistically calculate the highest accuracy between all calculated data points.

One skilled in the art will recognize that other approaches are possible in other implementations of the image processing technology. Such approaches may follow different logic.

With the dense and accurate collection of image analysis enabled by the systems and methods described herein, many features can be derived providing unprecedented post-acquisition image control. These features may include, but are not limited to:
Infinite refocus: Post-capture refocus that allows multiple focus positions to be retargeted to match a single temporal position and seamlessly move among all possible focus positions contained in the scene.
Variable frame rate: With the high frame rate information and known rays of angular entrance into the optical system, the exact integration time can be computed and reconstructed.
Live action “deep imaging”: Deep imaging is a 3D image format traditionally used for computer generated materials. It is a format that allows a single XY pixel coordinate to store multiple RGBAZ pixels to reproject very complex scenes, including things like particle clouds. With the increased imaging data and vectors available, it is possible to generate live action deep image files where color and alpha are processed per pixel to generate a final image output with multiple RGBAZ pixels per XY coordinate.
“Bullet-Time” Effects: Multiple light-field units may be used with aligned entrance pupils to produce a seamless array of perspectives by virtue of the light-field imaging data.
Volumetrically Aware Effects: With the RGB, RGBZ, or RGBAZ computationally calculated pixels, it is possible to modify portions of the image selectively based upon volume. This additionally applies to green screen removal where traditional color keys (or screens in general) are no longer necessary with volumetric information.
Automated 3D Camera Tracking: With the computational analysis data and a known “zero” frame, an extremely accurate real-world camera representation of the camera's movement may be produced.
Automated Segmentation and Rotoscope: With accurate motion vectors, perspective data, and high quality imaging analysis, it may be possible to segment an image in much more accurate methods than those used for state-of-the-art segmentation algorithms. Further, if a user defines an object, the outline or splines can be automatically propagated throughout a clip as the vectors and perspective analysis retain high correlation to the objects contained within a scene. This can additionally apply to motion capture applications, and potentially remove the necessity of tracking markers from these technologies. Such features may be computed in real time.
Computational Lens Flare Removal: The lenslet structure may facilitate automation of removal of lens flares. Artistic tools can be leveraged to generate photo-real lens flares with much higher quality imagery than when a flare hits the lens/sensor.
Extreme Low Light Capture: Due to the fixed aperture design and multiple perspectives of imaging data involved, in exchange for decreased refocusable range, it is possible to increase sensitivity of the resulting output pixels and increase the signal-to-noise ratio (SNR) of a single perspective and focus position at extremely low light conditions by averaging and/or adding retargeted perspective information to a single viewpoint to statistically decrease noise while retaining extremely high dynamic range.
Artistic Lens Flavor: Due to the ability to understand the physics of light involved in the captured scene given the multiple vector analysis performed, it may be possible to characterize any other existing lens and reproject the rays of light as acquired through the light-field system to generate a near exact reconstruction of the characterized lens while simultaneously providing additional artistic controls over these parameters.

In addition, the system described herein can be combined with other features and tools for a light-field video system. Such combination may enable the implementation of other features, methods, and/or advantages.

Through a mechanism that produces a pattern of various integration time exposures repeating or randomized beyond a single integration time, it is possible to generate drastically increased dynamic range given the high frame rate capture and use of the disparity and motion vectors generated. This can be a repeating pattern of any value greater than one. For example, in at least one embodiment, a repeating pattern of three to five exposures is provided, wherein the exposures are retargeted to each frame center (retarget −2, −1, +1, +2 frames in reference to frame 0) to generate the centered frame with significantly increased dynamic range. Due to the high frame rates, edge error may be statistically low and can be weighted based upon error tolerances.

In the same fashion, other color filtration methodologies may be leveraged sequentially from any point within the optical system that provides sequential wide color gamut capabilities. This may be done in combination with the above-described vector analysis to provide the ability to increase color gamut dramatically for each frame of a sequence.

In at least one embodiment, a dynamic filter such as a polarized filter may be added to the system. Such a filter may dynamically increase or decrease the ND filtration percentage. Additionally or alternatively, a static ND filter may be added to the described system.

### Other Sensor Modifications

In at least one embodiment, an ND mask can be added on a per-pixel or per-region basis, or in a random pattern, to increase dynamic range system potential, thereby increasing pixel resolution. In at least one embodiment, the mask can be computationally reconstructed based upon the known pattern of exposure per pixel to generate increased dynamic range with no loss of pixel resolution.

In at least one embodiment, the effective exposure of regions of pixels, individual pixels, and/or random patterns of pixels can be actively switched in a sequential manner. Further, in at least one embodiment, static per-pixel or per-region color filters can be provided to increase overall system color gamut. Yet further, in at least one embodiment, color filters may be actively switched in a sequential manner to allow for increased overall system color gamut.

### Preview Lens/Mode

In at least one embodiment, an additional preview lens system can be included to allow users the ability to have visual feedback for the image they are producing. Any of a number of different implementations are possible, four of which are described below.

Retro Reflector Design with Internal Beam Splitter for the MLA

In at least one embodiment, the empty mechanical space between each of the strips of sensors is fitted with a retro reflector, producing an image that can be re-photographed with a separate image sensor. Further, in at least one embodiment, the lens and sensor of this preview lens are matched such that the photographed FOV and the captured DOF closely, if not identically, match what should be anticipated through the computational process of the light-field image processing results.

FIG. 48 is a front view depicting an exemplary arrangement of a main array with beam splitter (not shown) and retro-reflector at gaps 4800 design to facilitate implementation of a preview sensor 4810, according to one embodiment. The gaps 4800 may reside between the fiber optic bundles 4820 of the array.

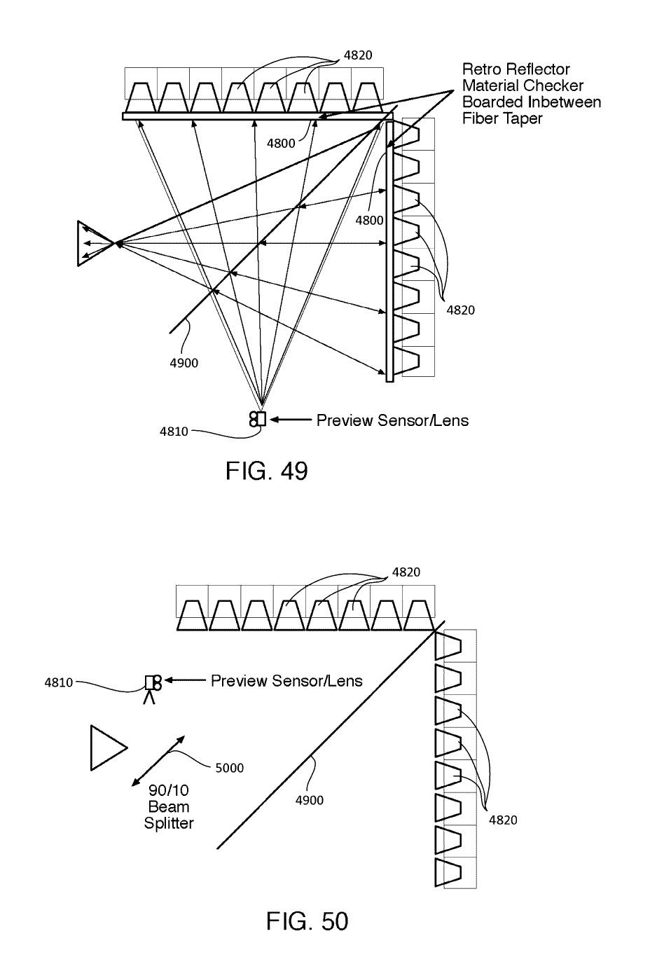

FIG. 49 is a side view illustrating how the preview sensor 4810 of FIG. 48 is able to re-photograph the larger imaging surface. The preview sensor 4810 may receive light from the beam splitter 4900 in conjunction with the retro-reflector design of FIG. 48.

In an alternative embodiment, a retro reflector can be included only at one of the two optical paths (such as at the top). A separate lens/image sensor may image that single plane alone. Alternatively, the system can leverage one of the two paths (such as the top), without a separate lens/sensor, and image both planes with varied image/optical parameters.

It should be noted that this structure can also be used for other image processing applications and is not necessarily specific to the preview lens concept. For example, the addition of this optical path can be used to increase dynamic range though capture of different integration time or increase color gamut through different color filters.

### Internal Beam Splitter

In at least one embodiment, an internal beam splitter is used to split off a small percentage of light to an additional sensor. This may not require the use of a beam splitter for the main image sensor below.

FIG. 50 is a top view depicting the use of a secondary beam splitter 5000 to redirect a small portion of light from the larger image plane in order to direct the light to a preview sensor 4810, according to one embodiment. The preview sensor 4810 may then be used to display a real-time result of an exemplary set of lens/sensor variables. The secondary beam splitter 5000 may optionally be used on conjunction with a primary beam splitter such as the beam splitter 4900 of FIG. 49, as shown.

Range Finder Solution with an Offset Imager

In at least one embodiment, a range finder solution can be used with an offset imager and display windows commensurate with other electronic viewfinder or range finder technologies. Any known electronic viewfinder and/or range finder technology may be used.

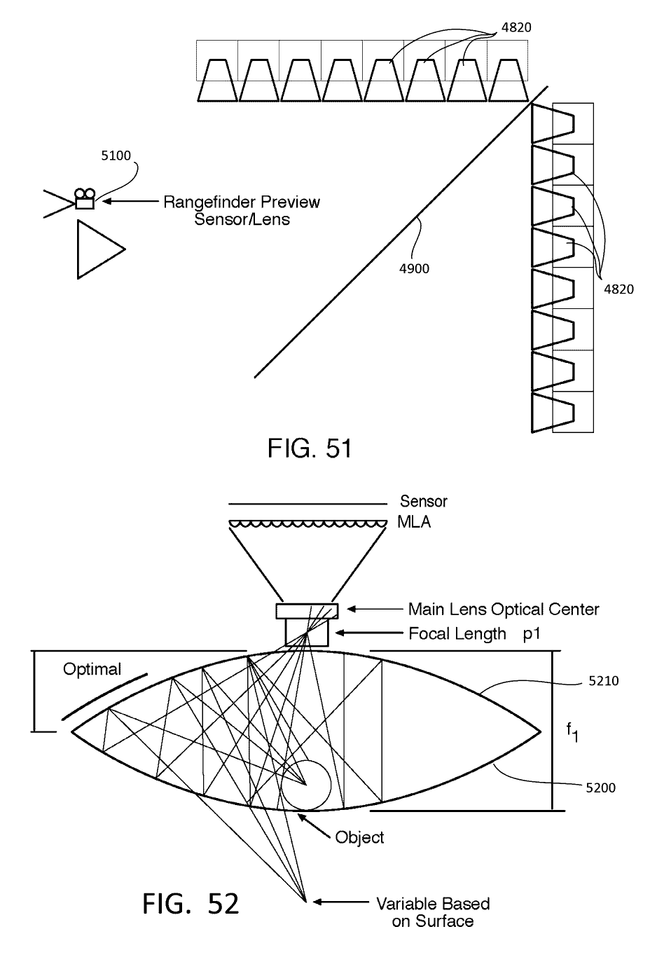

FIG. 51 is a top view depicting an example of a range finder configuration in which a completely separate lens/sensor system is leveraged to increase main sensor system light efficiency, according to one embodiment. Specifically, a rangefinder preview sensor 5100 may be used to retain light efficiency of a main image sensor, while still enabling production of a preview of the computational image.

### Real-Time Processing or Sub-Sampling

In at least one embodiment, real-time processing or sub-sampling of the complete light-field can be provided. The result may be displayed for a given set of parameters. This can be saved as an image or as metadata for further processing.

In any of the above variations, the lens/sensor configurations used for the preview can be saved as an image sequence or video file for immediate review of the captured scene. Additionally or alternatively, the parameters can be saved as a metadata stream to be used and then possibly modified for the complete light-field processing/reconstruction. The rate of key frame/data points for this process can be the same as the frame rate of the capture system, or can be increased for additional smoothness/accuracy, or can be reduced for lower sampling and algorithmic curve control/analysis/reconstruction. Further, all data points may be reanalyzed through algorithmic processing and/or manual intervention.

### Model/Volume Generation

In at least one embodiment, a high resolution light-field capture technology, such as those set forth herein, can be used to produce extremely high resolution images. With such imaging capability, customized mirrors and/or other optics may be used to capture up to a 360° view of an object.

In some embodiments, this may be done by orienting reflectors in a fashion that effectively redirects all rays of light to a central region of volume. The reflectors can be parabolic, or can be shaped according to any custom curve, surface shape, or the like, depending on the resolution requirements, or desired ray directionality of coverage. Flat mirror surfaces and/or other angled surfaces can be used. Any suitable number of facets can be used. Various methods and degrees of capture may be used, depending on the applicable scanning requirements.

Such a scheme may provide a single lens and single image capture technology solution for modeling, virtual reality (VR), and augmented reality (AR), as well as many other applications.

In at least one embodiment, each system is calibrated to determine the known directionality and positioning for each pixel's coordinate position in space. In one top-down approach, the system may include the main lens and optical technologies discussed above, and may include additional optics to redirect captured rays to a central volumetric region in which a first parabolic reflector has a focal length positioned at the optical center of the main lens, and second parabolic reflector has a different focal point at a distance that is predetermined based upon the size and shape of the object.

With this approach, the rays that pass through the optical center (the center sub-aperture) may reflect parallel to the lens. Rays that pass through other positions of the aperture may converge at differing locations to provide full volumetric coverage (parallax and/or depth).

As the focal point increases, the amount of captured volume may increase in width, but may also decreases in density per cubic mm. However, as the focal point decreases, the region of captured volume may decrease as well, as the density of acquired pixels increases.

In at least one embodiment, the system described herein provides a mechanism for using light-field data to ascertain physical volume, rather than just obtaining a single two-dimensional image. Light-field acquisition may provide the ability to computationally calculate the exact coordinates of a ray as it travels through space and strikes a surface. Every photon in this configuration must eventually terminate upon a surface and multiple reflections can be computationally interpreted.

FIG. 52 is a side view depicting an example of an architecture employing a first parabolic reflector 5200 and a second parabolic reflector 5210, according to one embodiment. Parabolic and/or non-parabolic reflector structures may be used. In FIG. 52, the first parabolic reflector 5200 and the second parabolic reflector 5210 may each have a single focal point. The system may include faceted reflective structures and/or smooth parabolic forms. If a faceted structure is used, the center of each facet may be aimed at the respective angle as defined by the reflector curve.

In another embodiment, the system may alternatively include multiple focal lengths within the second reflector. The first reflector may maintain the same focus position at the optical center of the main lens. Each reflector may be broken into R regions, and each R may have its own focus position with the volumetric captured region. These regions can be considered similar (but inverse) to the N number of light-field capture where the larger region produces an increased volumetric scanning area for a single region focus point at higher potential resolution. Smaller and more varied regions with more focus positions may provide greater volumetric scanning potential with decreased resolution per focus region. The regions can be radial and/or faceted.

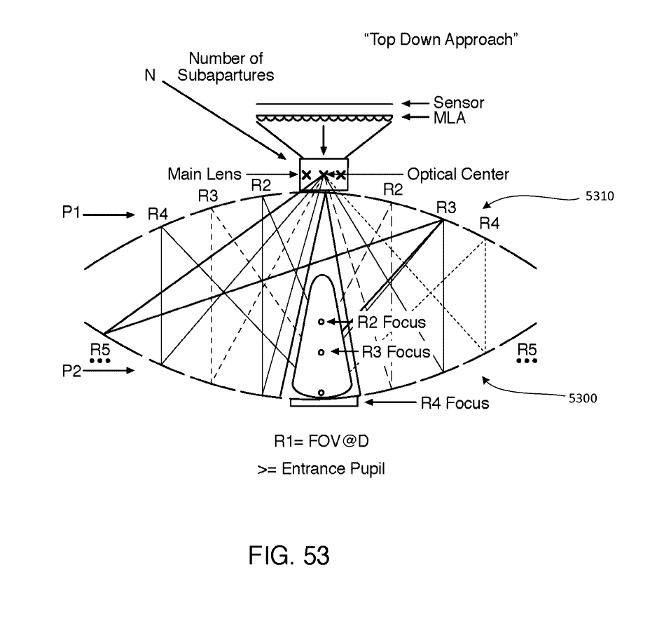

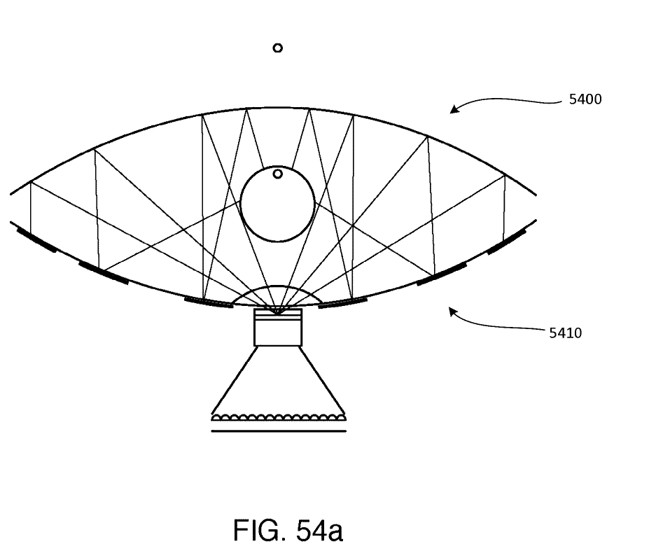

FIG. 53 is a side view depicting an example of architecture employing a first parabolic reflector 5300 and a second parabolic reflector 5310, according to another embodiment. The first parabolic reflector 5300 may have a single focus position at the optical center of the main lens. The second parabolic reflector 5310 may have multiple focus positions that may facilitate proper focus on various portions of an object positioned in the space between the first parabolic reflector 5300 and the second parabolic reflector 5310. In this disclosure, “parabolic” refers to shapes that are generally paraboloid, but may include shapes that are not precisely parabolic (for example, due to the provision of multiple focal points on the reflector).

In another embodiment, the light-field capture system may be placed in a bottom-up configuration, wherein the first reflector contains a focus point matched to the optical center of the main lens and the second reflector may or may not include multiple regions and varied focal lengths. If the second reflector includes multiple focal lengths, they may be directed to capture rays above and below the object to allow for a complete captured environment including below the object itself. In at least one embodiment, a glass surface is provided on which the object rests, in order to allow the rays to pass through the surface of the floor of the environment.

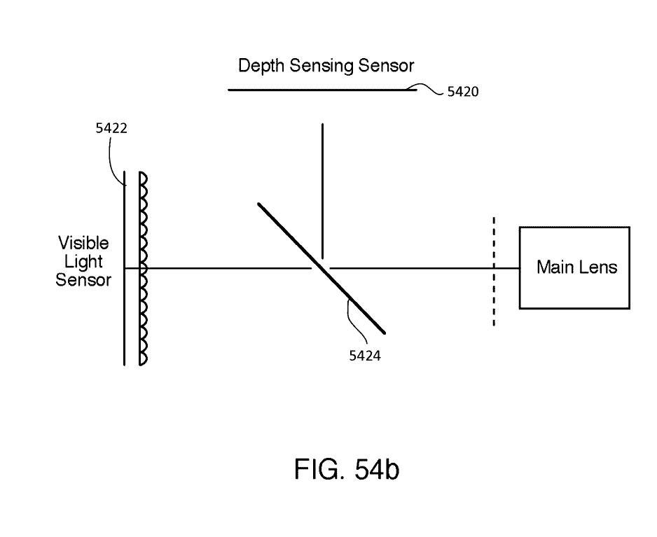

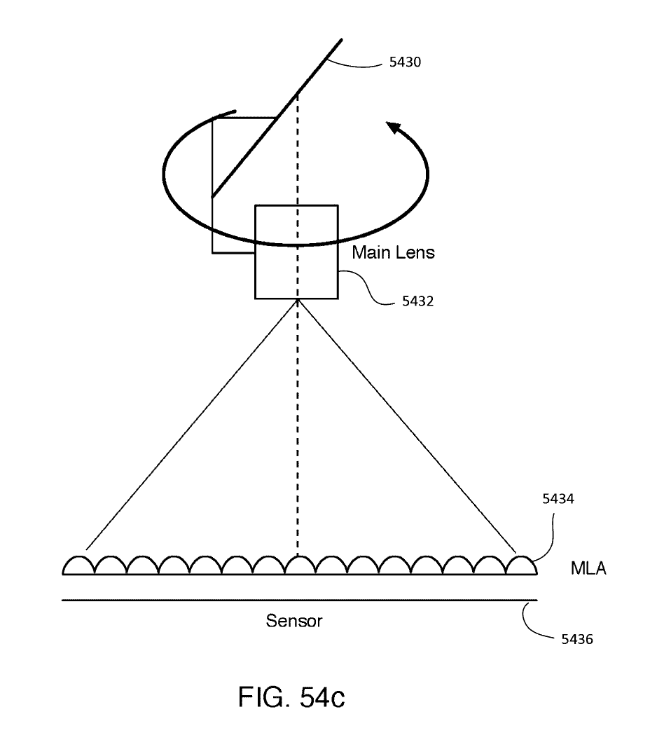

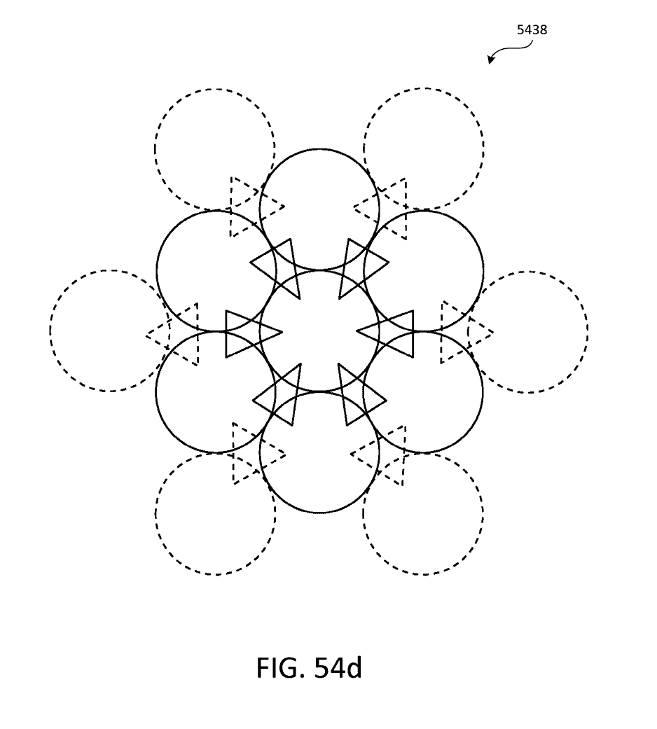

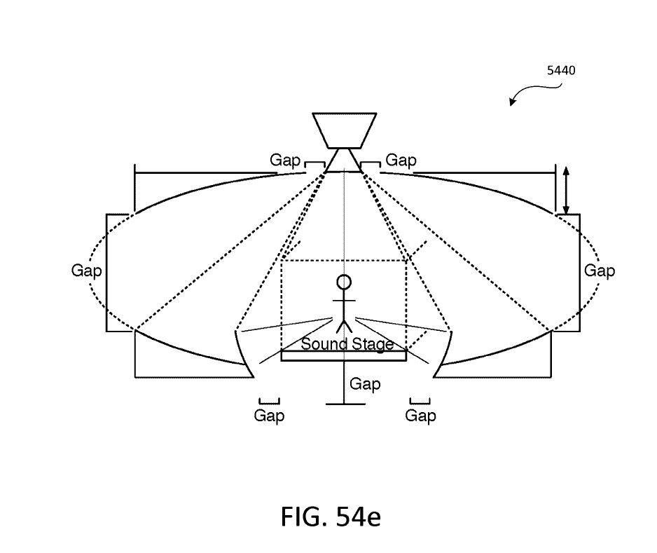

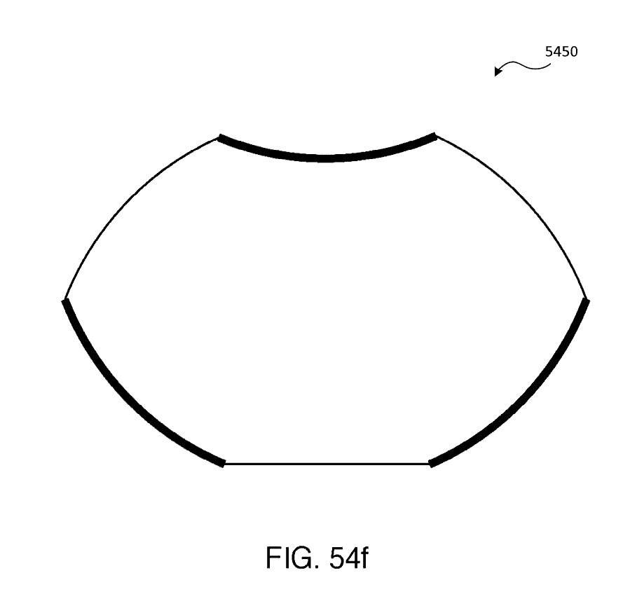

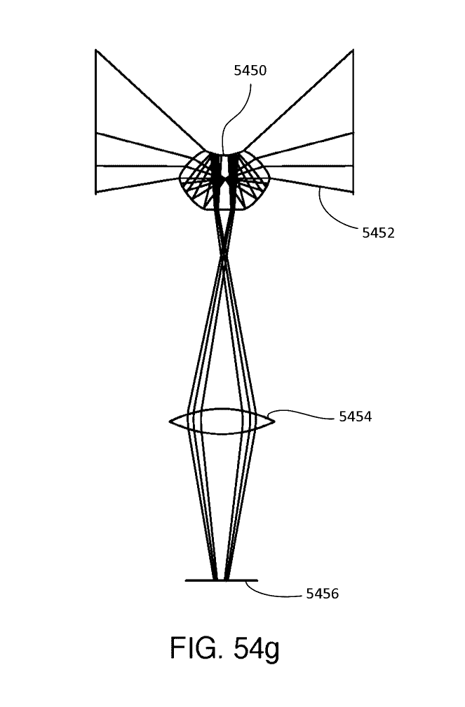

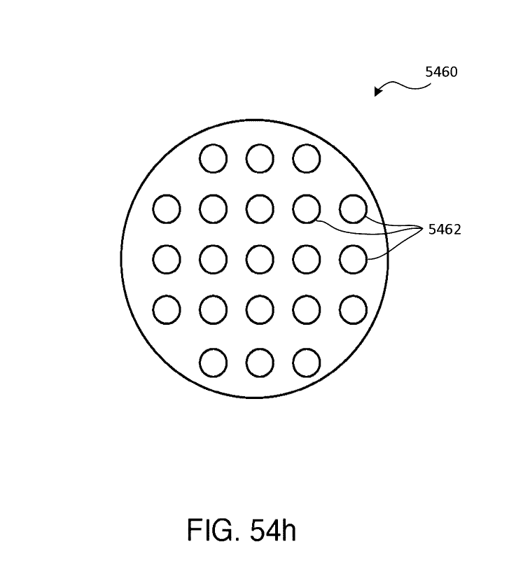

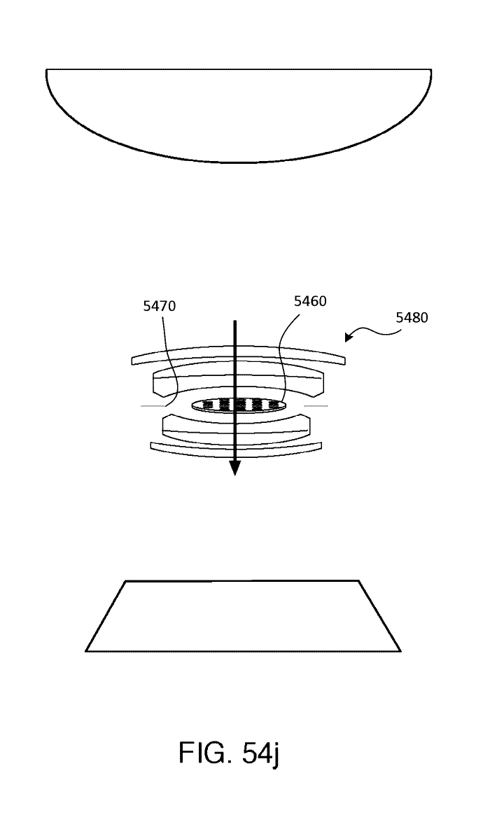

FIG. 54A is a side view depicting an example of a bottom-up configuration, with a first parabolic reflector 5400 and a second parabolic reflector 5410, according to another embodiment. The first parabolic reflector 5400 may have a focal length matched to that of the main lens optical center, and the second parabolic reflector 5410 have multiple focus positions to capture rays around the entire surface of the object.

In general, the focus point of a parabolic reflector can be matched to the main lens optical center for additional volumetric capture flexibility. However, in some configurations, other focal points can be used, as in FIGS. 53 and 54A. In at least one embodiment, the field of view for the above-described embodiments can be matched to the widest desired and/or widest possible rays that can be directed within the volumetric captured shape.

In at least one embodiment, lighting may be introduced around the lens, from within the apparatus, and/or from just outside of the pair of reflectors at the seams as noted above. The resolution of the image sensors may be decreased at any position within the volumetric captured regions in order to optimize the captured object and reduce bandwidth when possible.

In at least one embodiment, structured light, infrared (IR), laser, time-of-flight, and/or other depth sensing technologies can be added to emit light along the same optical path as the image sensor, along a split optical path, and/or along an intentionally off-axis path. This depth sensing light may optionally be produced sequentially from the same optical path and same image sensor with the coupling of an active filter that switches between accepting visible light and rejecting IR and/or other depth sensing frequencies, and a second state that accepts IR and/or other depth sensing frequencies and rejects visible light. The resulting light-field image can be captured, including light-field data for the volume alone and/or light-field data including imaging data as previously discussed. FIG. 54B depicts an example.

FIG. 54B is a side view depicting a camera with a depth sensing sensor 5420 separate from a visible light sensor 5422, according to one embodiment. A beam splitter 5424 may direct IR or other depth sensing light to the depth sensing sensor 5420, and direct visible light to be imaged to the visible light sensor 5422.

In at least one embodiment, N value may or may not be decreased, and a time sequential capture system can be implemented, where the reflectors rotate over time to decrease the resolution requirement per slice. This may increase resolution per facet and decrease volume resolution. The sequential capture and rotating facets may provide the same, if not higher, theoretical resolution as the same system with infinite N and extremely high single system resolution. FIG. 54C depicts an example.

FIG. 54C is a side view illustrating a rotating reflector 5430 that may be used for sequential capture of image data, according to one embodiment. The rotating reflector may transmit light through a main lens 5432 and an MLA 5434 to an image sensor 5436.

The particular arrangements described and depicted herein are merely exemplary. In other embodiments, any suitable single lens and single image capture schemes can be included to produce point projections, models, meshes, depth maps, volume measurements, and/or the like for a given object.

In at least one embodiment, these environments may be extremely large. For example, the imaging environment may be large enough to cover a sound stage, or even a stadium. Multiple objects may be positioned within and imaged within the environment.

In at least one embodiment, the facets of each parabolic reflector are produced with square tiled reflectors. Further, in at least one embodiment, the facets are produced with round, square, hexagonal, or other polygonal packed reflectors. Yet further, in at least one embodiment, these facets are manufactured onto a flexible material such that the resulting surface becomes like a malleable reflective fabric to form to any structural design requirements and allow for simplified setup containing complex configurations. These structures may be magnetic, and may be permanently or temporarily adhered to a secondary mechanical design/interface (magnetically or via another attachment mechanism) for appropriate alignment, configuration, and construction.

FIG. 54D is a top-down view depicting an example of a structure 5438 to generate a mesh of reflective surfaces, according to one embodiment. The circles may be reflectors connected together by flexible connectors such as fabric or mesh patches. The smaller each facet is within a regular pattern, the more parabolic the resulting shape becomes while retaining the flexibility to alter focus and/or angular curvature of the surface.

In at least one embodiment, these facets are built onto a motorized structure that provides the ability to dynamically alter the respective focus position of each reflective surface, either individually or as part of a fabric or other flexible surface. Further, in at least one embodiment, there are gaps between the two parabolic reflectors to provide clearance for lighting and/or other production required materials.

In at least one embodiment, there are gaps between the sound stage and the reflectors in order to allow for eye contact between the production team and the sound stage. This space may additionally be used to provide additional equipment space and/or additional lighting. Gaps may exist at any point within the volume. The sound stage may be elevated above the reflective surface to provide adequate spacing for the production team to work. Further, in at least one embodiment, the sound stage is elevated above the reflectors to ensure that there is no direct vibration introduced between the sound stage and the mirrors. Yet further, in at least one embodiment, there are gaps between the main lens and the reflectors in order to allow for additional equipment space and/or additional lighting. Gaps may exist at any position within the volume.

In at least one embodiment, one or more additional reflectors are positioned on the perimeter of the sound stage, or just around the sound stage (or around the gap) to focus rays of light in desired configurations (for example, from underneath an actor or from very low angles). These reflectors may have parabolic or other shapes, and may also contain multiple facets and/or focal points as disclosed in above previous statements. The additional reflectors may exist at any position within the volume, including below, above and/or anywhere that additional angular information and/or lighting is desired and/or required. In at least one embodiment, a “door” may be introduced by segmenting the reflective surfaces into a separate region to allow for mechanical separation and ease of entry/exit into and out of the volume.

FIG. 54E is a side view depicting an example of a structure 5440 including several modifications, according to one embodiment. Many of the above-described concepts are shown in combination with one another.

FIG. 54F is a side view depicting an example of a structure including a panoramic annular lens, or PAL 5450, according to one embodiment. Dark lines represent reflective surfaces. A PAL may have one or more glass elements and two or more reflective surfaces, which may produce a flat disk-shaped image of the entire 360° that surround the optical axis. A virtual disk-shaped image of the surroundings may be formed inside the lens.

FIG. 54G is a side, cross-section view depicting the PAL 5450 of FIG. 54F, along with a cylindrical field of view 5452, transfer optics 5454, and an image sensor 5456, according to one embodiment. The transfer optics 5454 may transfer the virtual disk-shaped image of the surroundings from the PAL 5450 to the sensor plane imaged by the image sensor 5456.

In at least one embodiment, the reflector surface of a PAL may be replaced with a panoramic annular lens. Any or all variations of panoramic optics may be used in addition to or in place of a PAL.

In at least one embodiment, a subaperture reducer is used. A subaperture reducer may increase the depth-of-field (DOF) of each subaperture image captured by the light-field camera system.

FIG. 54H is a conceptual diagram depicting a subaperture reducer 5460 for a light-field camera with a disk image diameter of five pixels, according to one embodiment. The subaperture reducer 5460 may be placed at or near the aperture plane, and may reduce the diameter of each subaperture while maintaining approximately the overall dimensions of the complete aperture. For a light-field camera with N pixels across a disk image, the subaperture reducer may have N evenly-spaced transmissive areas 5462 across the diameter of its surface. The circular shape is arbitrary; any other shape may alternatively be used.

FIG. 54J is a side view depicting placement of the subaperture reducer 5460, relative to a simplified schematic of the complete system, according to one embodiment. The subaperture reducer 5460 may be positioned in an aperture 5470, which may, in turn, reside in the lens array of a main lens 5480.

### Environment Generation

In at least one embodiment, the stitched capture technology described herein is used to produce images of extremely high resolution. This may result in the ability, with customized mirrors and/or other optical elements, to capture up to a 360° view of an environment.

Any or all of the variations described above in connection with model generation can be used in connection with environment generation, including for example N facet values, computational engine, and sequential capture. In at least one embodiment, the system is implemented in an outward-facing fashion, wherein reflectors are provided on the outside of the surface as opposed to the inside. As described, reflectors can be of any suitable shape.

As indicated previously, “parabolic” does not require adherence to a precise, mathematical parabolic shape. This description references parabolic reflectors in many instances in which other reflector shapes may be used, as needed for the particular application.

In at least one embodiment, the system includes additional optics positioned to capture vertically above the capture system. This may facilitate the capture of up to a 360° effective field-of-view.

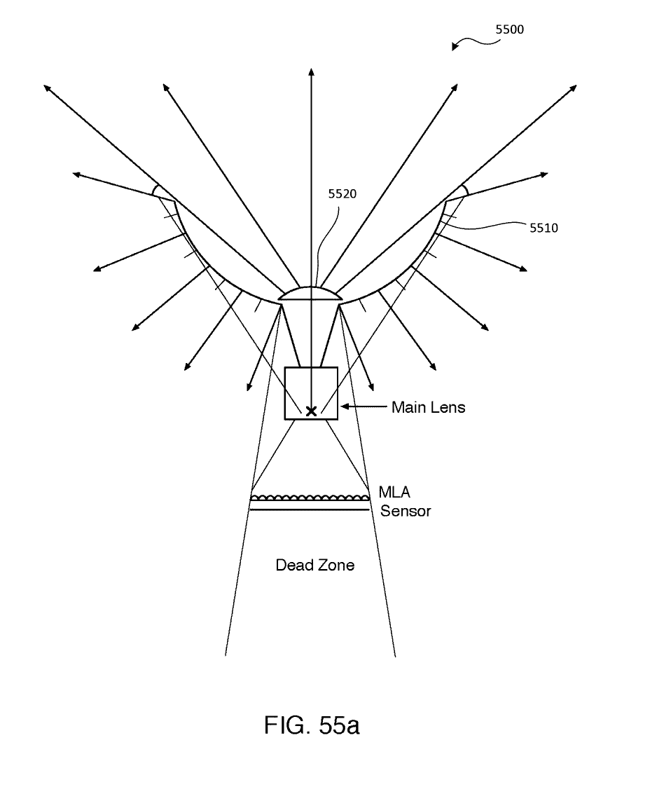

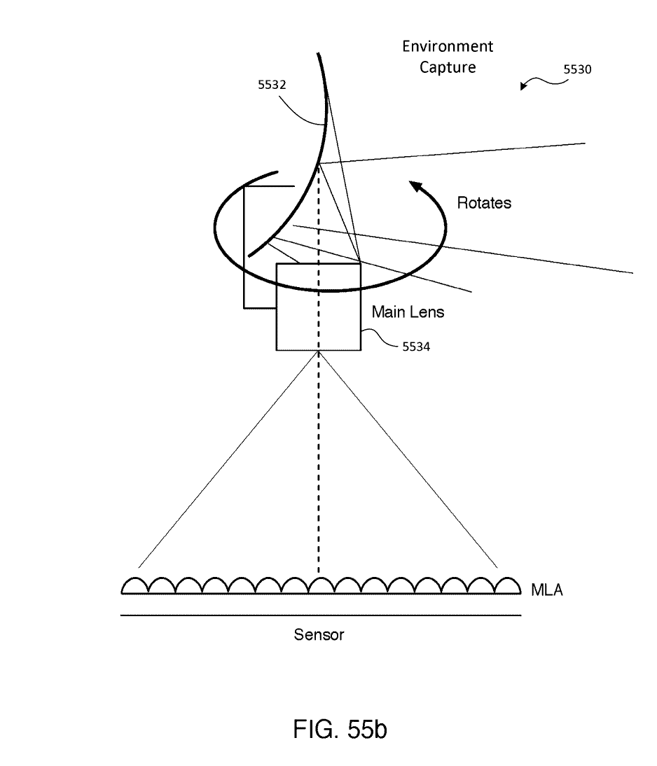

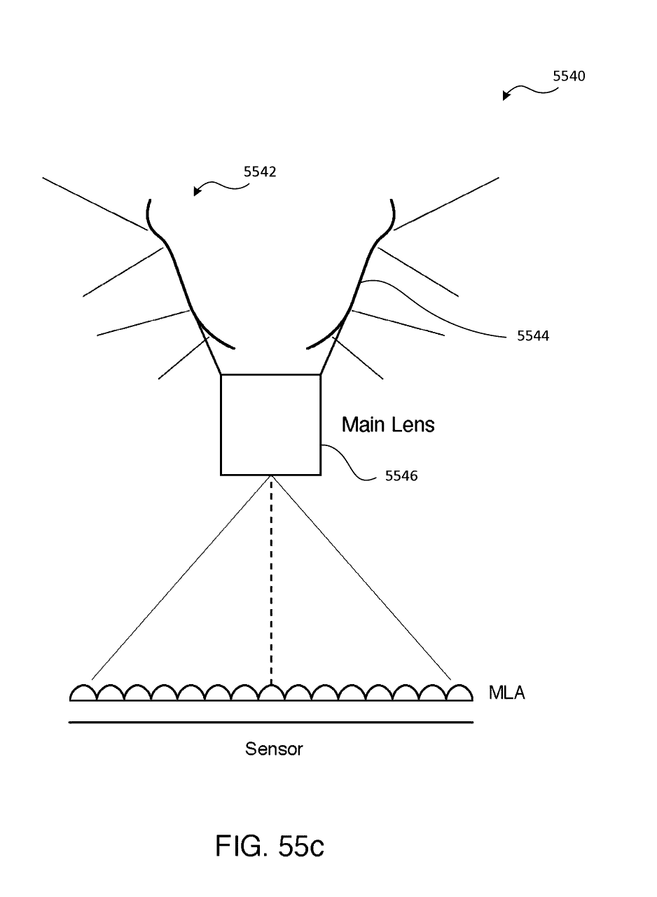

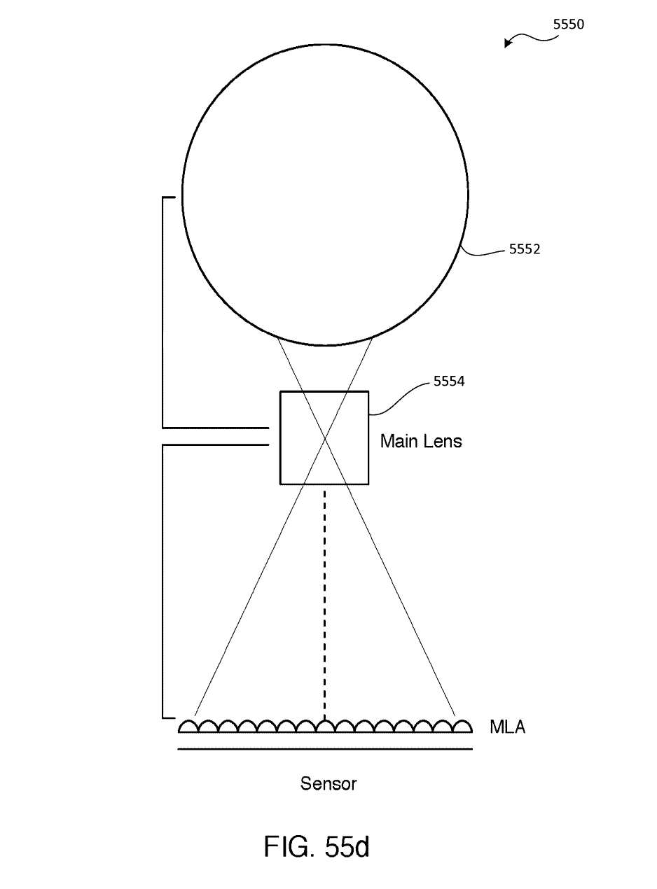

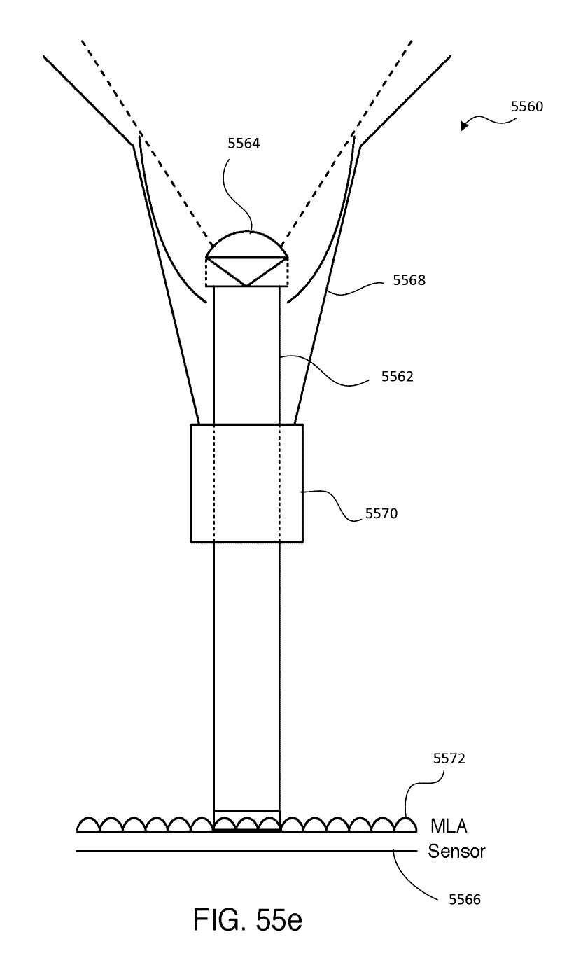

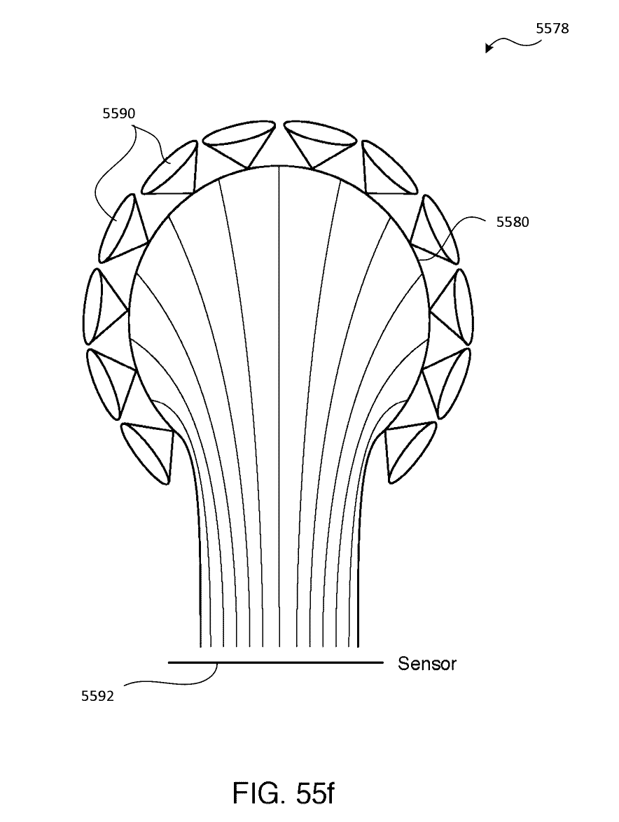

FIG. 55A is a side view depicting an example of a structure 5500 that provides a 360° scan of an environment, according to one embodiment. The structure 5500 may leverage a reflector 5510 and secondary lens 5520 with an upward facing light-field capture system.

In at least one embodiment, the system is able to employ image processing technology to generate high resolution environments from a light-field image captured through a single lens, or from a series of sequentially-captured light-field images. In at least one embodiment, as depicted in FIG. 55B, one or more rotating optical elements may be used.

FIG. 55B is side view depicting an example of a structure 5530 that captures a complete 360° spherical capture environment through the use of a rotating reflector 5532, according to one embodiment. The rotating reflector 5532 may be positioned above the main lens 5534. The rotating reflector 5532 may or may not be planar depending on the angles of coverage desired. The rotating reflector 5532 may have a cylindrical, spherical, or parabolic shape.

In other embodiments, the surface of a stationary or rotating reflector can be any shape. Optical compression can be employed by providing additional rays to regions of interest. For example, if overhead resolution is of less importance, more rays can be acquired between +45° and 45° by altering the reflective surface shape to optimize the imaging of such an environment. FIG. 55C depicts an example.

FIG. 55C is a side view depicting an example of a structure 5540 having a reflector 5542 with an irregular shape, according to one embodiment. The reflector 5542 may have relatively flat portions 5544 that optimize direction of light from between +45° and 45° into a main lens 5546. The resulting image may thus have more detail in these areas. Alternative reflector shapes may be used to alter the direction along which the most detail is captured.

In at least one embodiment, line scanners can be used to capture a high resolution scene using a system designed for environment capture. Such an embodiment may utilize any type of scanners, including for example flatbed scanners, which may optionally be combined with any of the environment capture optics disclosed herein.

In at least one embodiment, a spherical, semispherical, oblong, egg-shaped, or other unconventional lens, may be used. Such a lens may be made of any optical materials, and may be positioned above a main lens to image an environment. FIG. 55D depicts an example.

FIG. 55D is a side view depicting an example of a structure 5550 in which a spherical lens 5552 is used to image an environment, according to one embodiment. The spherical lens 5552 may be positioned above a main lens 5554, and may gather and direct light from the environment to the main lens 5554.

In at least one embodiment, the reflector includes multiple facets. Additionally or alternatively, in at least one embodiment, a system may be configured to use multiple light-field capture devices distributed inward (facing into a volume), outward (from a central location), or both simultaneously, so as to generate the required rays to define a particular object or space.

In at least one embodiment, the additional optical elements introduced into such an environment capture design may leverage dense fiber optic bundles to relay light from a secondary lens directly to an image sensor. FIG. 55E depicts an example.

FIG. 55E is a side view depicting an example of a structure 5560 in which a fiber optic bundle 5562 is used to convey light from a secondary lens 5564 to an image sensor 5566, according to one embodiment. The light may be collected in the secondary lens 5564 via a reflector 5568, and may pass through the main lens 5570 and a microlens array, or MLA 5572, en route to the image sensor 5566.

In at least one embodiment, the MLA is placed at the front of a tapered fiber optic bundle arrangement that includes a polished round surface and an array of lenslets in a 360-degree capture configuration. In this manner, light may be relayed directly to the sensor without a separate main lens or other MLA structures. FIG. 55F depicts an example.

FIG. 55F is a side view depicting the use of a combined tapered fiber optic bundle and microlens array, or combined structure 5578, according to one embodiment. The combined structure 5578 may have a polished round surface 5580 on which an array of lenslets 5590 are arranged. The lenslets 5590 may cooperate to act as a microlens array (MLA) by directing light into the remainder of the combined structure 5578 in a manner that preserves vector information regarding the origin of light entering the lenslets 5590. The vector information, along with color and intensity information, may be encoded on a sensor 5592. The lenslets 5590 may be integrally formed into the fiber structure of the combined structure 5578, or formed separately and attached.

### Non-Planar Imaging Planes

Traditionally, the shape of the imaging plane of a camera is matched to that of the image sensor. The configuration of the image sensor may be limited by the planar processes used in silicon wafer fabrication. Accordingly, imaging planes have traditionally been planar as well. However, in some instances, it may be advantageous to have a non-planar continuous imaging surface.

The use of fiber optic bundles may facilitate the use of non-planar imaging planes. In at least one embodiment, one or more fiber optic bundles may be machined or otherwise formed into the desired imaging plane shape. For example, the leading end(s) of one or more fiber optic bundles may be machined into a cylindrical, spherical, faceted, elliptical, parabolic, or other shape. The light gathered from the non-planar imaging plane may be conducted by the fiber optic bundle(s) to one or more planar image sensors of any known type. The imaging plane may have any concave, convex, or concave/convex shape. Thus, the shape of the imaging plane may be decoupled from that of the image sensor.

Use of a non-planar imaging plane may be applied to cameras employing only a single image sensor. The shape of the imaging plane may be controlled in a manner that modifies the resulting image to resolves and/or obviate various software processing steps that may otherwise need to be performed on the light-field data.

### Back-End Systems Design

In at least one embodiment, the system described herein uses existing interfaces and technologies. For example, 1 GP capture at 300 fps 10 bit requires approximately 350 GB/s. Such a data transfer rate may be challenging to obtain with existing technologies. However, with the tiled technologies proposed herein, handling 1/50^{th} or 1/100^{th} of the resolution (or any percentage depending on configuration) may be significantly easier on a per-module basis.

In at least one embodiment, the system is fragmented into multiple tiled streams for simplified data management, and the data streams from the individual image sensors are multiplexed or further fragmented. For example, four individual modules can be connected into a single stream, or a single module can be further broken down into four separate streams, depending on available bandwidth. In addition, the resulting captured data can be multiplexed into a single image from multiple individual files or streams. Alternatively, a single image file can be generated to include multiplexing, for example, as one tile from four tiles or one tile from all tiles. The larger image (or whatever portion has been tiled or presented) can then be refragmented for image processing requirements and/or display.

In at least one embodiment, raw light-field data can be taken in either a tiled or single image form. The raw light-field data may be distributed across a networked rendering (processor) infrastructure to further increase (wall-clock) render time speeds.

In at least one embodiment, pre-rendered aspects of the process can be automated, for example by allowing a user to identify captured sequences to pre-process, which are then automatically processed in the background. Pre-processing can be performed based on the computational requirements for the light-field excluding the final desired render. In at least one embodiment, the two-dimensional output and/or all other processing requirements may be performed in an automated fashion, or precomputed for model generation. This can additionally include automation of camera tracking and vector analysis as noted in the feature discussions.

In at least one embodiment, fiber optic transceivers can be included in order to extend the length of separation between the camera head and the back end systems. Further, in at least one embodiment, on-board storage can be provided for each device. Stationary and/or removable storage or any other storage method can be used, to tether a portable storage array in the same fashion as disclosed above for the back-end systems. Any storage mechanism can be used in connection with the described system, including for example, RAM-based storage, flash memory, solid-state drives, magnetic drives, optical drives, spinning disc arrays, and/or the like.

In at least one embodiment, the system can store the preview lens capture in any file/video format and or save a real-time computational preview of the captured image. Further, the system can store metadata in any form, including the choices made with the preview lens during capture and/or any other capture decisions made that would benefit from storage as a metadata stream.

In at least one embodiment, the system also implements a process to compress the file size of light-field data. Such compression may use any suitable compression technologies. Compression can also be based upon further analysis of the vectors in the scene and more intelligent light-field temporal compression technologies. Any suitable method can be used to compress the light-field data, including through the use of spatial and/or temporal algorithms.

### Computational Focal Length and Data Management

In at least one embodiment, the system can use lossless digital (“computational”) zoom and focal length (FL) automation, with an increase in overall system resolution by the ratio of the zoom factor (e.g. 2× zoom=4× resolution increase (2×W and 2×H=4×), where pixel density at the center of the fiber stack is greater (with commensurate MLA structure) and every array ring around a given center array stack can provide decreased resolution. The capture mechanism may reduce the pixel density recorded appropriately such that the center array stack captures at the same angular and pixel resolution, and the same consideration for each ring about this N+1 ring, where FL adjustments may be performed with no loss in captured resolution as the FL is adjusted. The image plane may increase in size and pixel density may scale accordingly in such fashion that the transmitted data is the same given that the pixel pitch scales to compensate for the FL digital zoom.

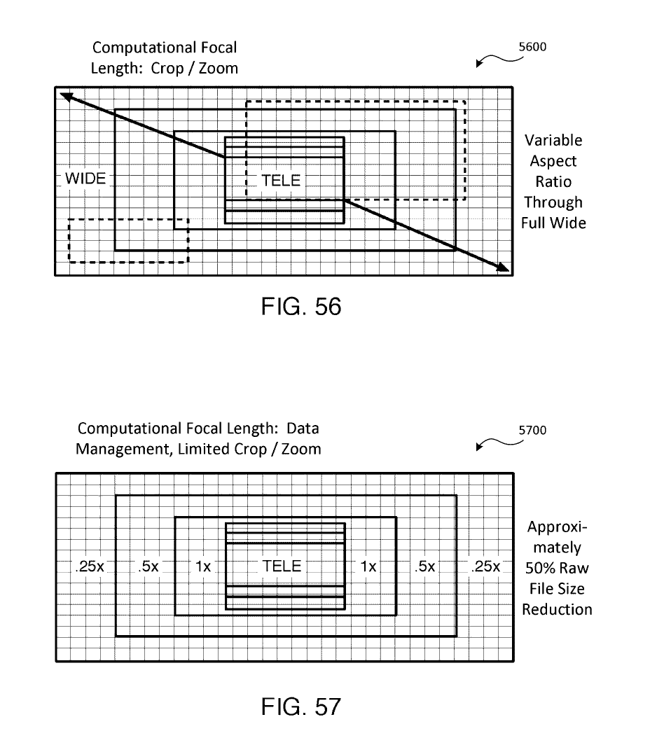

FIG. 56 is an image diagram depicting an example 5600 of how the imaging plane can be divided into multiple FOV segments, according to one embodiment. At full resolution (meaning no decrease in image sensor pixel density and no reduction of pixels), the system may provide the ability to freely look around the image with the additional crop factors, which results in the ability to alter the computational focal length.

FIG. 57 is an image diagram depicting an example 5700 of an alternative approach for dividing an imaging plane in to FOV segments, according to one embodiment. The sample rectangles designate examples of how the sensors may decrease in pixel density, or maintain the same density with a smaller imaging area and increase the magnification factor of the tapered fiber optic bundles by the respective factor required to maintain the same area. For example, 4× resolution reduction may require a 4× magnification increase to the existing magnification at the center of the array; if the center has a 3× magnification factor, this may result in a 12× magnification requirement. Alternatively, the system can maintain full resolution at the sensor level and perform data reduction depending on the final output desired resolution for the purpose of providing the capability of computational focal length adjustments with a single lens.

The particular rectangles and methods of FIGS. 56 and 57 are examples only. The techniques described above may be applied in different ways, or a variety of other focal length and/or data management techniques may be used.

In some alternative embodiments, identical pixel structures can be provided throughout the array to provide the ability to compress the raw data losslessly based upon a predetermined final output resolution requirement, where the entire FOV imaged will exceed the actual imaging requirements. In at least one embodiment, this may additionally be performed in a non-region based approach. For example, this compression may be applied in a radial fashion where each pixel sampled increases in pitch the further it is located from the center of the image sensor, across the imaging plane. The significance of this is that a single prime lens with extremely wide angle of view (AOV) and high resolution at the center image of the lens may allow all focal length (FL) functions to be performed digitally, with no loss in recorded resolution or modulation transfer function (MTF).

### Variations in Redirecting Optical Elements

In at least one embodiment, a system according to the present disclosure may use a mirror in order to provide a larger effective field-of-view, in a manner similar to that of FIG. 55A. Such a mirror may serve as a redirecting optical element, and may have any of a wide variety of shapes, including but not limited to spherical, elliptical, hyperbolic, and conical shapes. Such mirrors may provide a field-of-view that extends substantially full-circle about an axis.

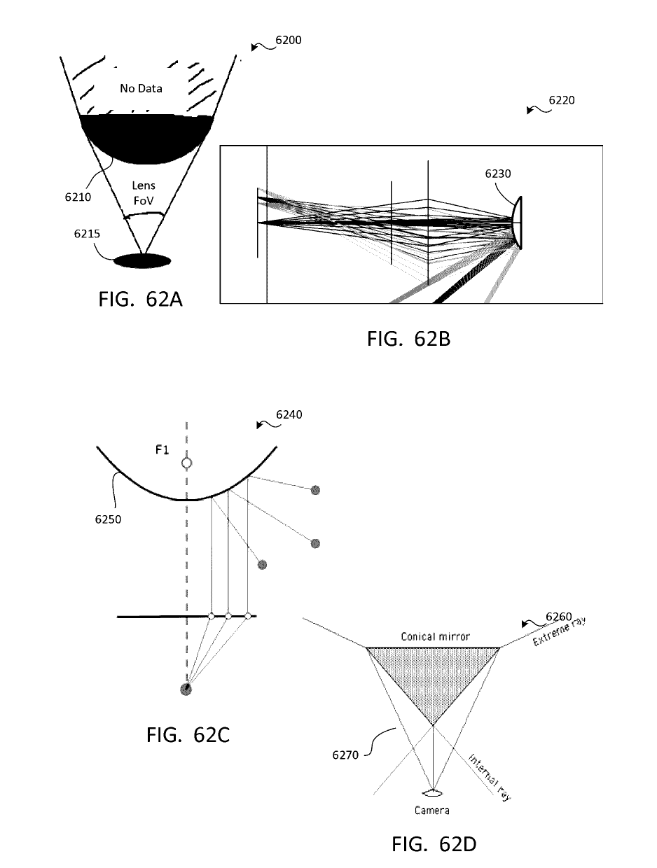

Referring to FIGS. 62A through 62D, various systems depict the use of shaped mirrors, as mentioned above. These embodiments are merely exemplary; in other embodiments, different redirecting optical elements and/or configurations may be used.

FIG. 62A depicts a system 6200 with a spherical mirror 6210. By leveraging an entrance pupil of a certain diameter and a microlens array (not shown), the spherical mirror 6210 may be placed at a specified distance from the field-of-view of the main lens 6215 to distribute the rays captured by the light-field subapertures to capture an effective field-of-view greater than 180°. The system 6200 may optionally have a second (or greater) optical path that passes through the surface of the spherical mirror 6210 in order to capture greater fields-of-view. This may be done, for example, by making the surface of the spherical mirror 6210 partially reflective, and partially transparent. Thus, light from behind the spherical mirror 6210 may be received by the main lens 6215 and imaged by the system 6200.

FIG. 62B depicts a system 6220 with an elliptical mirror 6230. FIG. 62C depicts a system 6240 with a hyperbolic mirror 6250. FIG. 62D depicts a system 6260 with a conical mirror 6270.

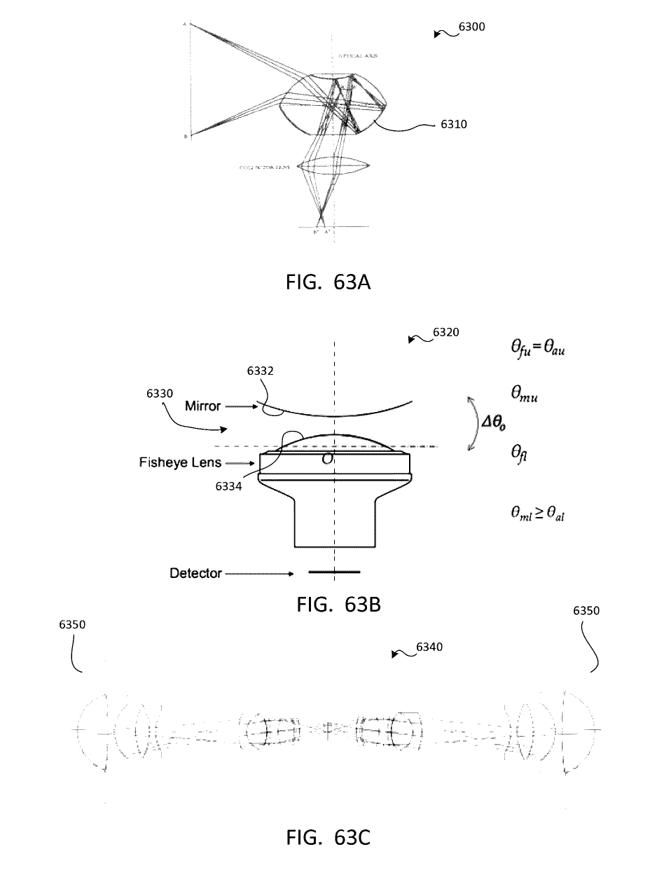

Referring to FIGS. 63A through 63C, various systems depict the use of redirecting optical elements with other configurations. Such configurations may include panoramic annular, catadioptric, and multiple fisheye elements, which are also merely exemplary.

FIG. 63A depicts a system 6300 with a panoramic annular element 6310. The panoramic annular element 6310 may have an optical design consisting of up to a singular piece of glass with spherically reflecting surfaces to produce a 360° annular virtual image of the environment about the optical axis of the system 6300. With these optics and a microlens array (not shown) with an EP with a diameter D, the subapertures of the light-field can reconstruct a greater field of view for immersive content.

FIG. 63B depicts a system 6320 with a catadioptric element 6330, which may include a curved mirror 6332 and a fisheye lens 6334. The combination of reflective and refractive optics may form high angle of view capture. Leveraging this approach with a microlens array (not shown) and an EP with a diameter D, the subapertures of the light field can reconstruct greater fields of view.

FIG. 63C depicts a system 6340 with multiple fisheye elements 6350. The system 6340 may have multiple light-field sensors and wide angle optics in the form of the fisheye elements 6350. The system 6340 may leverage these components to produce wide subaperture angles of coverage for full 360° light-field reconstruction.

### Mechanical Scanning

In some embodiments, one or more optical elements may be moved during the image capture process to provide a large effective field-of-view. Various combinations of optical elements may be used in connection with linear and/or rotary motion.

By leveraging a smaller field-of-view optical system, with and without a microlens array, one can trade off temporal resolution with spatial resolution (perspective/area). With high frame rate capture, one or more mechanical, optical, or opto-mechanical devices may be coupled to increase the effective field-of-view without the tradeoff of size of optics. This approach may include, but is not limited to, singular rotational mirrors, multi-stage rotational mirrors, rotational prisms, and other optical elements that alter the imaged field-of-view from the overall area in which capture is desired.

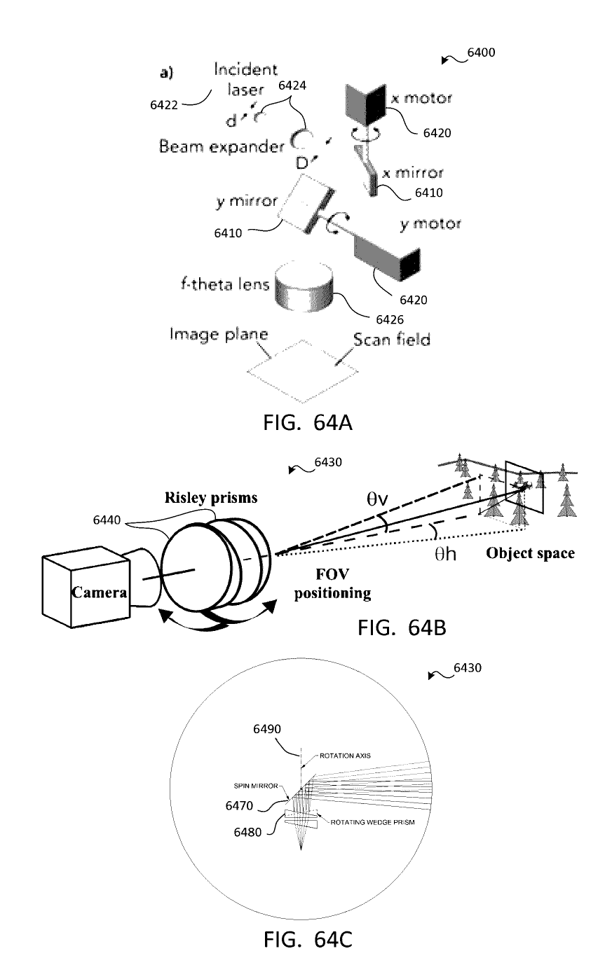

Referring to FIGS. 64A through 64C, various systems may use a variety of mechanically movable optical elements in order to capture a large field-of-view. The optical elements may include mirrors, Risley prisms, and/or wedge prisms, by way of example.

FIG. 64A depicts a system 6400 with mirrors 6410 that are rotated by motors 6420. The mirrors 6410 and motors 6420 may be used in conjunction with an incident laser 6422, one or more beam expanders 6424, and/or an f-theta lens 6426.

FIG. 64B depicts a system 6430 with Risley prisms 6440 that are rotated by one or more motors (not shown). The Risley prisms 6440 may be rotated in opposite directions, as indicated by the arrows.

FIG. 64C depicts a system 6460 with a spin mirror 6470 and a rotating wedge prism 6480. The spin mirror 6470 and the rotating wedge prism 6480 may rotate about an axis 6490 as shown to provide an effectively large field-of-view, which may extend substantially full-circle around the axis 6490.

### Coherent Fiber Arrays

In some embodiments, coherent fiber arrays may be used to provide a larger field-of-view. In some embodiments, conventional imaging, rather than light-field imaging, may be used in connection with coherent fiber arrays.

By leveraging dense or flexible fiber optic elements, it is possible to accurately mechanically align coherent fiber surfaces to capture an external image that is relayed to a single or multiple offset imaging sensors. With this approach, the optical elements for focusing light (for example, the leading ends of optical fibers or fiber optic bundles) may be placed on the external surface of the outer sphere, or any desired shape for area capture. These shapes may include planar, conical, cylindrical, and/or any geometric or irregular shape/surface for desired applications.

The trailing ends of the optical fibers or bundles may be attached to the silicon and/or imaging surface, and may accurately map to a specified angle in space depending on the lenses used. The lenses may be mechanically aligned though a calibration process to ensure that angles of light are captured with accuracy. Additionally or alternatively, such a system may be calibrated though the use of a software imaging process. With flexible optical elements, it may also be possible to change the size and/or shape of the mechanical apparatus dynamically to provide multiple capture options depending on the desired area coverage. For example, the leading ends of the optical fibers may be secured to a flexible sheet, which may be movable between different shapes to provide different fields-of-view.

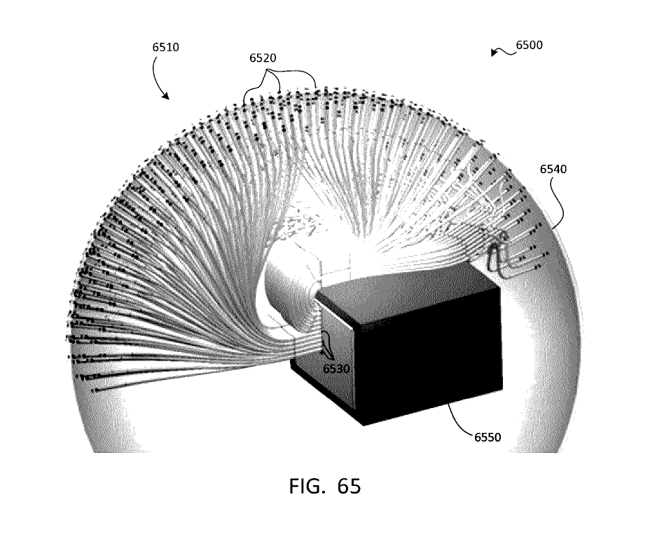

Referring to FIG. 65, a system 6500 may have a coherent fiber array 6510 comprising many optical fibers, each of which has a leading end 6520 and a trailing end 6530. The leading ends 6520 may be secured to a spherical shape 6540, and the trailing ends 6530 may be secured to an image sensor 6550. The system 6500 may provide a wide field-of-view, which may be semispherical in shape.

### LiDAR

Scanning devices can be used to measure the depth profile of nearby objects. Their use can add to the accuracy of the depth measurement derived from a light field camera. This is especially true for imaging regions that are monochromatic and featureless. The scanning device can help add detail to the depth map generated by the light-field camera alone. One example of a scanning device is a LiDAR (light radar) scanning device, which uses a beam of light to measure the distance to objects.

Many commercially available scanning devices make measurements over a field-of-view (FOV) that is much larger than a typical field-of-view for a light field camera. For example, the Velodyne VLP-16 device scans with sixteen lasers in a circular 360° field-of-view in the plane of rotation (the “azimuthal coordinate”) of the device, and +/−15° in the plane perpendicular to the plane of rotation (the “polar coordinate”). The field-of-view for the fiber taper sensor used in a light-field camera with a 560 mm by 316 mm sensor and a 1210 mm focal length lens may only be about 26° in the horizontal direction, and 15° in the vertical direction.

To measure depth of objects from a camera, it is advantageous to reflect the beams of light from a scanning device so that they are projected into a smaller angular region that more closely matches the field-of-view of the camera. This technique may be used to avoid projecting the beams of light into places the camera cannot image, and instead redirect them to be more concentrated. In this manner, the spatial sampling of the scanning device within the field-of-view of the camera is increased.

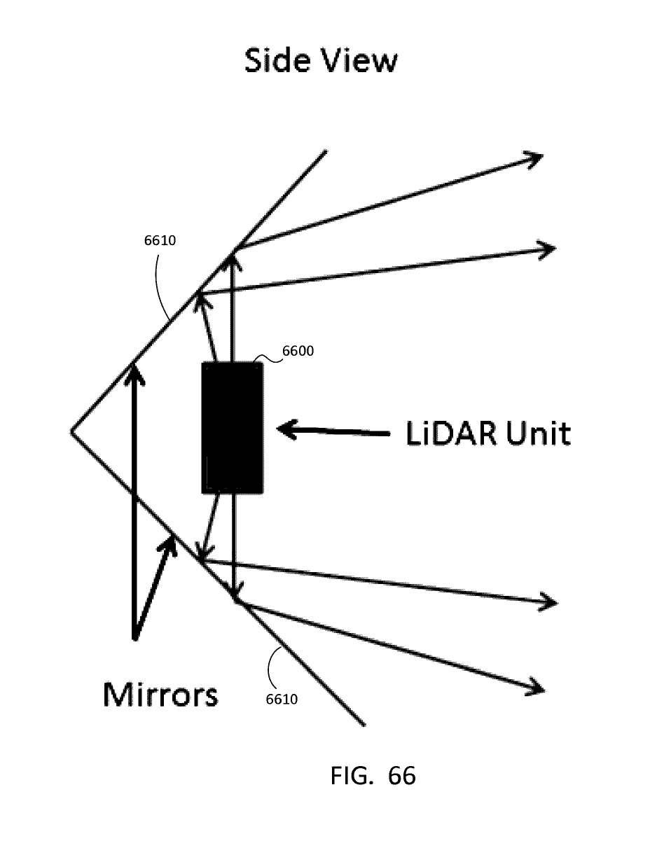

FIG. 66 shows a side view of a scanning device 6600 placed between two mirrors 6610. The two mirrors 6610 may be placed at a 90° angle relative to one another, with the scanning device 6600 centered between them, projecting light beams 6620 radially. In at least one embodiment, the scanning device 6600 may be a Velodyne VLP-16 LiDAR disk that projects 16 lasers radially with various angles (for example, −15°, −13°, 41°, −9°, −7°, −5°, −3°, −1°, 1°, 3°, 5°, 7°, 9°, 11°, 13°, and 15°) relative to the plane of rotation. In this configuration, all the light beams projected from the LiDAR may be reflected by the mirrors into the opening defined by these mirrors. The light beams may be projected with an angular spread that can overlap with the camera's field-of-view.

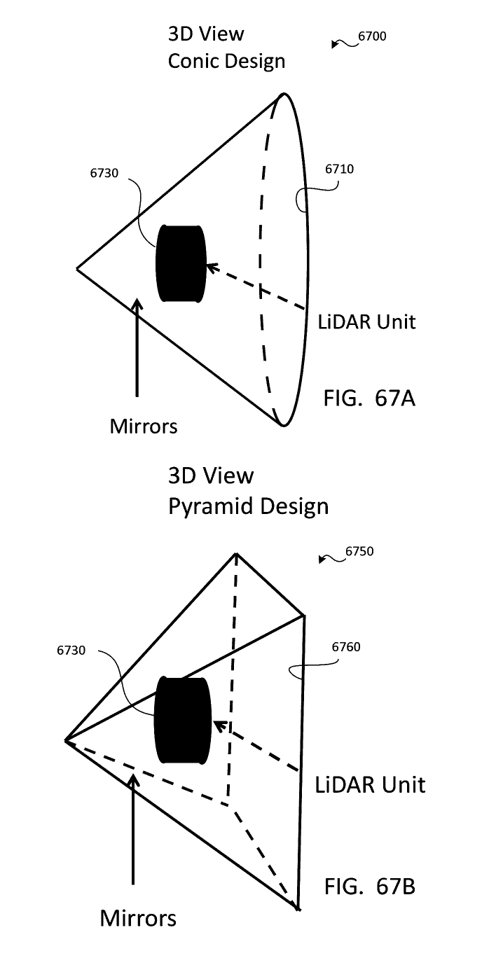

In three dimensions, it may be advantageous for the mirrored surfaces of the reflector to be arranged so they surround the scanning device in such a way as to reflect all the beams from the scanning device toward the opening in those mirrors. As shown in FIGS. 67A and 67B, two basic designs for a reflector for a scanning device may include conical and pyramidal reflectors. In FIG. 67A, a cone-shaped reflector 6700 has a surface that is cone-shaped on the inside, with a circular opening 6710. In FIG. 67B, a pyramidal reflector 6750 may have four mirrors placed in a pyramid formation with a square opening 6760.

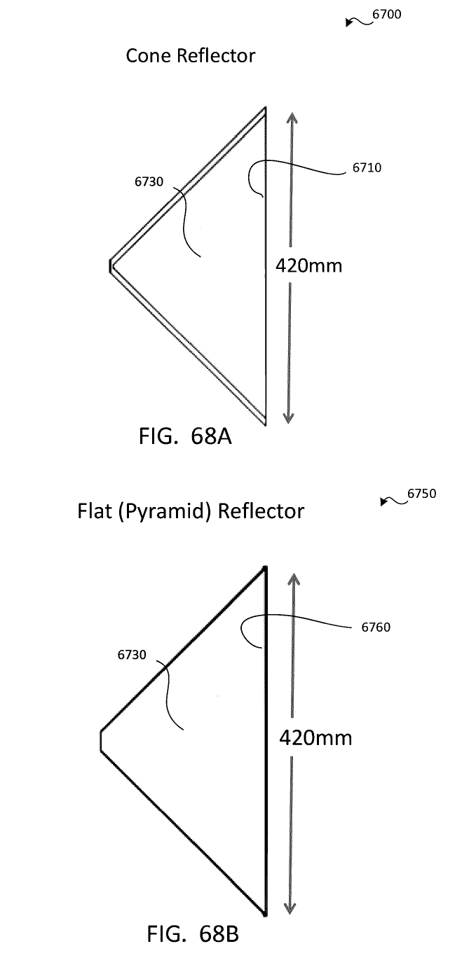

In at least one embodiment, the non-mirrored opening 6710 in the cone-shaped reflector 6700 has a diameter of 420 mm, as shown in FIG. 68A. Further, in at least one embodiment, the non-mirrored opening 6760 in the pyramidal reflector 6750 is a square with a side 420 mm in length, as shown in FIG. 68B. One skilled in the art will recognize that other dimensions are possible.

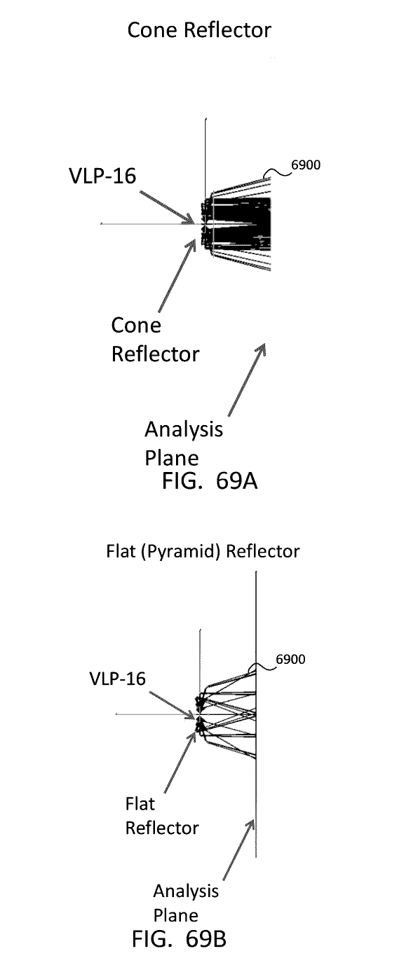

Centered between the mirrors in either the pyramid or conical configuration, the scanning device 6730 may project rays 6900 that are reflected by the walls of the mirror cavity and focused onto a plane perpendicular to the axis of rotation of the scanning device 6730, as shown in FIGS. 69A and 69B, for the cone-shaped reflector 6700 and the pyramidal reflector 6750, respectively. This plane perpendicular to axis of rotation of the scanning device 6730 may advantageously correspond to the field-of-view of the light-field camera with which the scanning device 6730 is to be used.

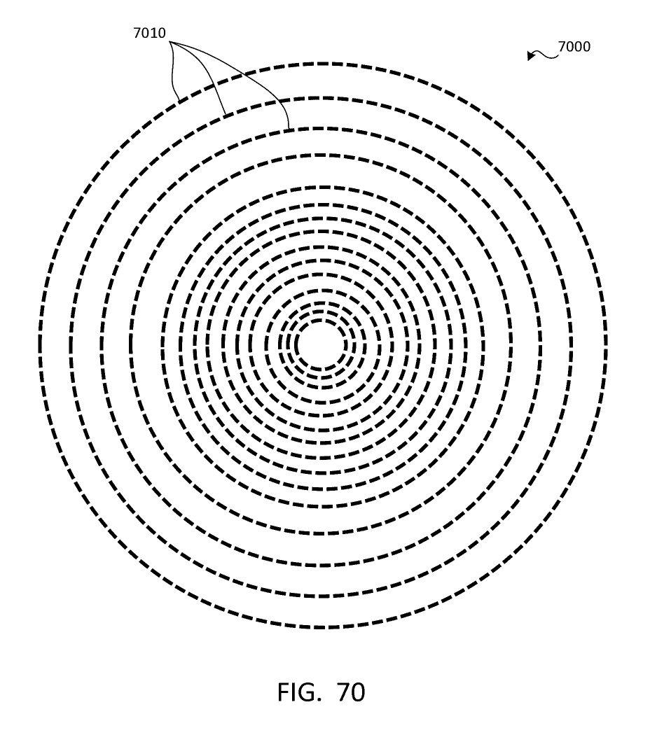

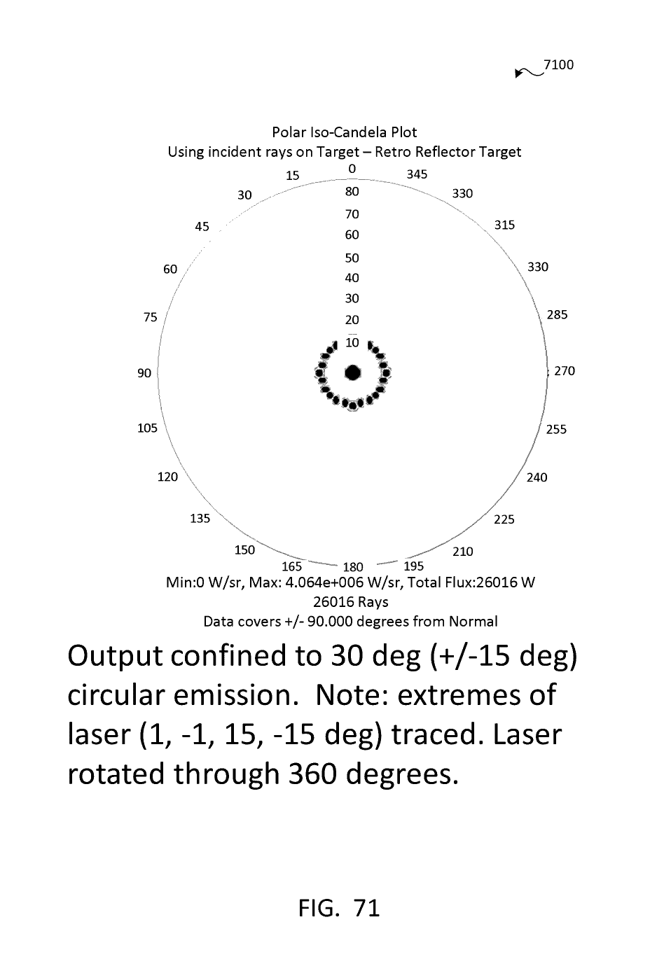

The pattern of sampling points gathered by the scanning device 6730 may be dependent on the mirror configuration. In at least one embodiment, corresponding to a conical mirror reflector design, and using the Velodyne VLP-16 LiDAR device, the sampling points in an imaging plane perpendicular to the axis of rotation of the LiDAR form a group 7000 of sixteen concentric circles 7010, as shown in FIG. 70. The LiDAR laser beams may be projected into a field-of-view of 30°. A polar plot 7100 showing the resulting projected energy vs. angle distribution, in units of watts/steradians (W/sr), is shown in FIG. 71.

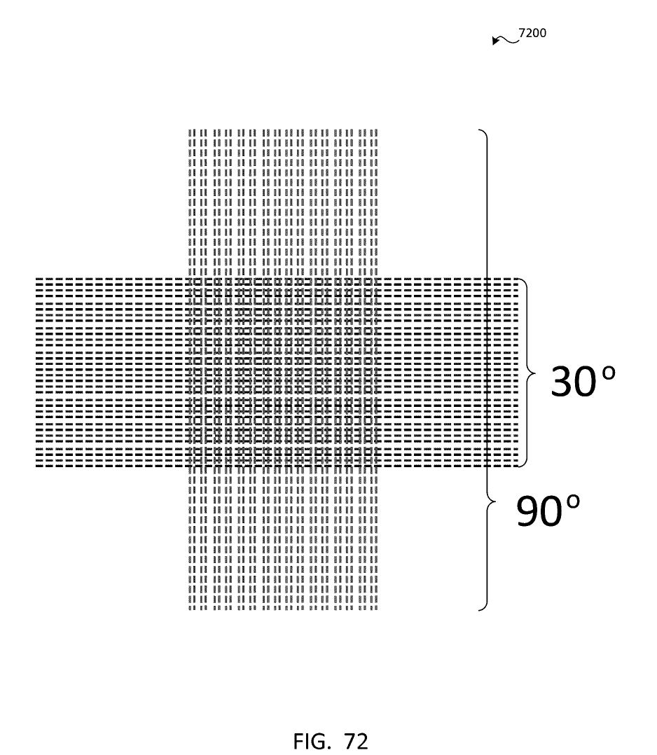

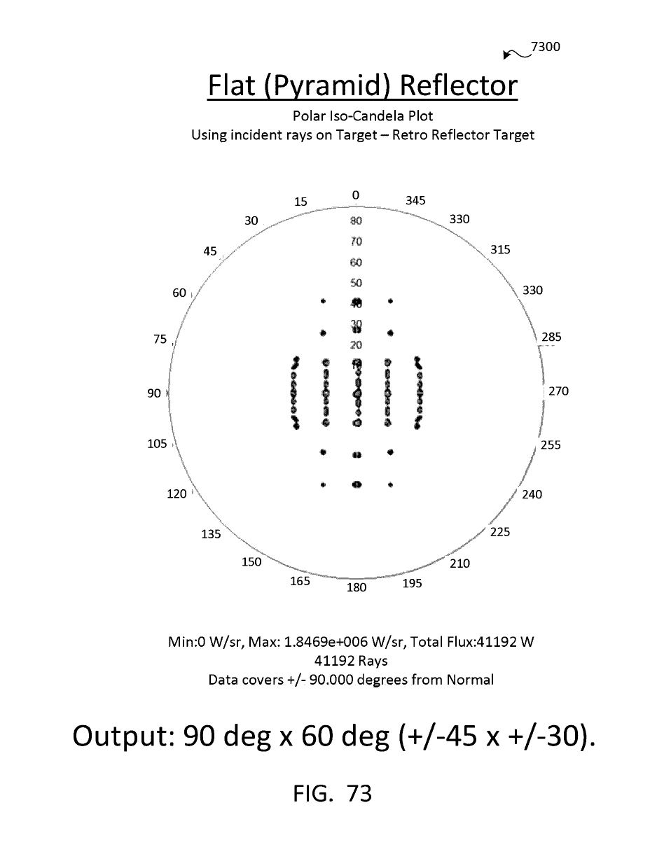

In at least one other embodiment, corresponding to a pyramidal mirror reflector design, and using the Velodyne VLP-16 LiDAR device, the sampling points in an imaging plane perpendicular to the axis of rotation of the LiDAR may form a grid 7200 with a field-of-view of 90° in one direction and 30° in the orthogonal direction, as shown in FIG. 72. A polar plot 7300 showing the resulting projected energy vs. angle distribution, in units of watts/steradians (W/sr), is shown in FIG. 73.

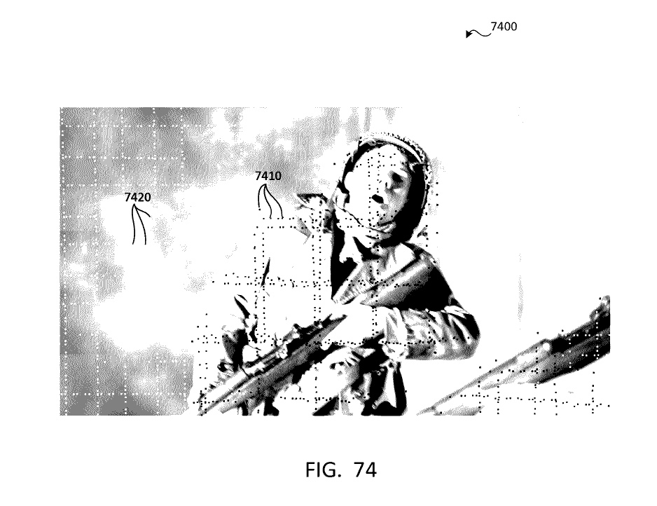

An example of the LiDAR measurement points for objects in an imaging plane is shown in an image 7400 in FIG. 74, in which the spots 7410 and the spots 7420 on the image 7400 of the soldier represent LiDAR sampling measurement points. Each of the black spots 7410 may designate an intersection of the scanning beam with the foreground object (the soldier), while each of the white spots 7420 may designate the intersection of the scanning beam with the plane in the background.

The above description and referenced drawings set forth particular details with respect to possible embodiments. Those of skill in the art will appreciate that the techniques described herein may be practiced in other embodiments. First, the particular naming of the components, capitalization of terms, the attributes, data structures, or any other programming or structural aspect is not mandatory or significant, and the mechanisms that implement the techniques described herein may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment

Some embodiments may include a system or a method for performing the above-described techniques, either singly or in any combination. Other embodiments may include a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions of described herein can be embodied in software, firmware and/or hardware, and when embodied in software, can be downloaded to reside on and be operated from different platforms used by a variety of operating systems.

Some embodiments relate to an apparatus for performing the operations described herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), and/or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the techniques set forth herein are not described with reference to any particular programming language. It will be appreciated that a variety of programming languages may be used to implement the techniques described herein, and any references above to specific languages are provided for illustrative purposes only.

Accordingly, in various embodiments, the techniques described herein can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the techniques described herein include: a mobile phone, personal digital assistant, smartphone, kiosk, server computer, enterprise computing device, desktop computer, laptop computer, tablet computer, consumer electronic device, television, set-top box, or the like. An electronic device for implementing the techniques described herein may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

In various embodiments, the techniques described herein can be implemented in a distributed processing environment, networked computing environment, or web-based computing environment. Elements can be implemented on client computing devices, servers, routers, and/or other network or non-network components. In some embodiments, the techniques described herein are implemented using a client/server architecture, wherein some components are implemented on one or more client computing devices and other components are implemented on one or more servers. In one embodiment, in the course of implementing the techniques of the present disclosure, client(s) request content from server(s), and server(s) return content in response to the requests. A browser may be installed at the client computing device for enabling such requests and responses, and for providing a user interface by which the user can initiate and control such interactions and view the presented content.

Any or all of the network components for implementing the described technology may, in some embodiments, be communicatively coupled with one another using any suitable electronic network, whether wired or wireless or any combination thereof, and using any suitable protocols for enabling such communication. One example of such a network is the Internet, although the techniques described herein can be implemented using other networks as well.

While a limited number of embodiments has been described herein, those skilled in the art, having benefit of the above description, will appreciate that other embodiments may be devised which do not depart from the scope of the claims. In addition, it should be noted that the language used in the specification has been principally selected for readability and instructional purposes, and may not have been selected to delineate or circumscribe the inventive subject matter. Accordingly, the disclosure is intended to be illustrative, but not limiting.

What is claimed is:

1. An image capture device comprising:
a first image sensor configured to capture first image data; and
a fiber array having a plurality of optical fiber bundles, each optical fiber bundle comprising a leading end positioned within an optical path and secured to a surface, and a trailing end positioned proximate the first image sensor.

2. The image capture device of claim 1, wherein the surface comprises a part of a mechanical sensor enclosure.

3. The image capture device of claim 1, wherein the surface has a spherical shape.

4. The image capture device of claim 1, wherein the surface has a shape forming at least a portion of a sphere.

5. The image capture device of claim 1, wherein the plurality of optical fiber bundles is configured so that a focused image from the leading end of each optical fiber bundle is relayed to the trailing end of the optical fiber bundle and captured by the first image sensor.

6. The image capture device of claim 1, wherein the trailing end of each optical fiber bundle is secured to the first image sensor.

7. The image capture device of claim 1, further comprising an optical element configured to direct incoming light along the optical path.

8. The image capture device of claim 7, further comprising a microlens array positioned within the optical path.

9. The image capture device of claim 7, wherein the optical element has a focus point at a plane corresponding to the leading ends of the optical fiber bundles.

10. The image capture device of claim 1, further comprising a second image sensor configured to capture second image data, wherein:
the trailing end of at least one optical fiber bundle is positioned proximate the first image sensor;
the trailing end of at least one other optical fiber bundle is positioned proximate the second image sensor;
the trailing ends of the optical fiber bundles are displaced from one another such that a gap exists between the trailing ends; and
the leading ends of the optical fiber bundles are positioned adjacent to one another, such that the first image data and the second image data are combinable to create a single image that is substantially unaffected by the gap.

11. The image capture device of claim 1, wherein the plurality of optical fiber bundles form a loose glass optical fiber element.

12. The image capture device of claim 1, wherein the leading ends of the optical fiber bundles are fused to one another.

13. The image capture device of claim 12, wherein the fused leading ends are positioned in an array of non-contiguous surfaces configured to achieve arbitrary spacing and form.

14. The image capture device of claim 1, wherein the optical fiber bundles are fused to one another on each end to maintain coherence with a length commensurate with the distance between the surface and the first image sensor.

15. The image capture device of claim 1, wherein each optical fiber bundle comprises a plurality of fused loose coherent optical fibers.

16. The image capture device of claim 15, wherein at least a subset of the fused loose coherent optical fibers are bonded to the first image sensor and are stacked in a regular configuration.

17. The image capture device of claim 15, further comprising at least one additional image sensor, and wherein:
at least a subset of the fused loose coherent optical fibers are bonded to each of the image sensors; and
the leading ends of the optical fibers are configured to receive an image from an optical imaging element according to a predetermined mechanical configuration.

18. The image capture device of claim 17, wherein the leading ends of the optical fibers are configured to receive the image from the optical imaging element in a manner that captures an array of perspectives suitable for a computational imaging application.

19. The image capture device of claim 1, wherein the surface is flexible so as to provide multiple capture options.

20. A method for configuring an image capture device comprising a first image sensor configured to capture first image data and a fiber array having a plurality of optical fiber bundles, each optical fiber bundle comprising a leading end and a trailing end, the method comprising:
positioning the leading end of each optical fiber bundle within an optical path;
securing the leading end of each optical fiber bundle to a surface; and
positioning the trailing end of each optical fiber bundle so that it is proximate the first image sensor.

21. The method of claim 20, wherein the surface comprises a part of a mechanical sensor enclosure.

22. The method of claim 20, wherein the surface has a spherical shape.

23. The method of claim 20, wherein the surface has a shape forming at least a portion of a sphere.

24. The method of claim 20, further comprising configuring the plurality of optical fiber bundles so that a focused image from the leading end of each optical fiber bundle is relayed to the trailing end of the optical fiber bundle and captured by the first image sensor.

25. The method of claim 20, further comprising securing the trailing end of each optical fiber bundle to the first image sensor.

26. The method of claim 20, wherein the image capture device comprises an optical element configured to direct incoming light along the optical path.

27. The method of claim 26, wherein the image capture device comprises a microlens array positioned within the optical path.

28. The method of claim 26, wherein the optical element has a focus point at a plane corresponding to the leading ends of the optical fiber bundles.

29. The method of claim 20, wherein the image capture device comprises a second image sensor configured to capture second image data, and wherein the method further comprises:
positioning the trailing end of at least one optical fiber bundle so that it is proximate the first image sensor;
positioning the trailing end of at least one other optical fiber bundle so that it is proximate the second image sensor;
positioning the trailing ends of the optical fiber bundles to be displaced from one another such that a gap exists between the trailing ends; and
positioning the leading ends of the optical fiber bundles adjacent to one another, such that the first image data and the second image data are combinable to create a single image that is substantially unaffected by the gap.

30. The method of claim 20, wherein the plurality of optical fiber bundles form a loose glass optical fiber element.

31. The method of claim 20, further comprising fusing the leading ends of the optical fiber bundles to one another.

32. The method of claim 31, further comprising positioning the fused leading ends in an array of non-contiguous surfaces configured to achieve arbitrary spacing and form.

33. The method of claim 20, further comprising fusing the optical fiber bundles on each end to maintain coherence with a length commensurate with the distance between the surface and the first image sensor.

34. The method of claim 20, wherein each optical fiber bundle comprises a plurality of fused loose coherent optical fibers.

35. The method of claim 34, further comprising:
bonding at least a subset of the fused loose coherent optical fibers to the first image sensor; and
stacking the bonded subset of the fused loose coherent optical fibers in a regular configuration.

36. The method of claim 34, wherein the image capture device further comprises at least one additional image sensor, the method further comprising:
bonding at least a subset of the fused loose coherent optical fibers to each of the image sensors; and
configuring the leading ends of the optical fibers to receive an image from an optical imaging element according to a predetermined mechanical configuration.

37. The method of claim 36, further comprising configuring the leading ends of the optical fibers to receive the image from the optical imaging element in a manner that captures an array of perspectives suitable for a computational imaging application.

38. The method of claim 20, wherein the surface is flexible so as to provide multiple capture options.
